(19) United States
(12) Patent Application Publication
(10) Pub. No.: US 2014/0091987 A1
(43) Pub. Date: Apr. 3, 2014

(54) WIRELESS DATA COMMUNICATION APPARATUS AND WIRELESS DATA COMMUNICATION METHOD

(71) Applicants: Byungjoo Lee, Seocho-gu (KR); Wongyu Song, Seocho-gu (KR); Inhwan Choi, Seocho-gu (KR); Hongseok Oh, Seocho-gu (KR); Jeehyung Song, Seocho-gu (KR)

(72) Inventors: Byungjoo Lee, Seocho-gu (KR); Wongyu Song, Seocho-gu (KR); Inhwan Choi, Seocho-gu (KR); Hongseok Oh, Seocho-gu (KR); Jeehyung Song, Seocho-gu (KR)

(21) Appl. No.: 14/113,716

(22) PCT Filed: Jun. 15, 2012
(86) PCT No.: PCT/KR2012/004727

§ 371 Date: Nov. 20, 2013

Related U.S. Application Data
(60) Provisional application No. 61/497,508, filed on Jun. 15, 2011.
(60) Provisional application No. 61/515,317, filed on Aug. 4, 2011.

(51) Int. Cl. G06F 3/147; H04B 7/26

(52) U.S. Cl. CPC G06F 3/147; H04B 7/2603
USPC 345/2.3

(57) ABSTRACT

The present invention relates to a wireless data communication apparatus and to a wireless data communication method. According to the present invention, a wireless data communication method comprises the steps of: receiving metadata for first content from a wireless data communication apparatus using a near field communication (NFC) scheme; displaying the received metadata; and connecting, if information contained in the metadata is selected, to the wireless data communication apparatus using a wireless fidelity peer-to-peer (Wi-Fi P2P) connection scheme and receiving, from the wireless data communication apparatus, the first content according to the content or the selected information.

### TECHNICAL FIELD

The present invention relates to wireless data communications, and more particularly, to an apparatus for wireless data communications and method thereof. Although the present invention is suitable for a wide scope of applications, it is particularly suitable for enabling communications by at least two communication protocols and including a display function.

### BACKGROUND ART

Recently, as wireless short range communication technologies including Wi-Fi and the like are widely applied to markets, the demand for display solutions for streaming audio and video using Wi-Fi is rising.

However, due to the Wi-Fi property of requiring a considerable time in setting up a device-to-device connection, it takes a considerable time for the connection to cause one problem of inconvenience.

Moreover, when devices share a content with each other, if the devices are not aware of information on the content in advance, it wastes a considerable time for the Wi-Fi connection to cause another problem of inconvenience.

### DISCLOSURE OF THE INVENTION

### Technical Tasks

One object of the present invention is to provide an apparatus for wireless data communications and method thereof, by which a Wi-Fi display device of streaming media can use a different wireless communication such as NFC (near field communication) to set up a mutual connection.

Another object of the present invention is to provide an apparatus for wireless data communications and method thereof, by which a fixed (or stationary) media device and a handheld media device can share a content and screen retained by the respective devices with each other through Wi-Fi connection.

Another object of the present invention is to provide an apparatus for wireless data communications and method thereof, by which devices configured to share a content and screen with each other through Wi-Fi connection can transceive metadata for the content with each other through NFC connection in advance.

Another object of the present invention is to provide an apparatus for wireless data communications and method thereof, by which Wi-Fi Direct connection setup can be performed by a device capable of using both Wi-Fi Direct (P2P) and NFC through the NFC.

A further object of the present invention is to provide an apparatus for wireless data communications and method thereof, by which a time taken for a connection setup of devices configured to perform Wi-Fi P2P connection can be shortened through NFC and the devices can communication with each other efficiently.

### Technical Solutions

To achieve these and other advantages and in accordance with the purpose of the present invention, as embodied and broadly described, a method for wireless data communication according to one embodiment of the present invention includes the steps of receiving metadata on a 1^{st} content from a wireless data communication device using NFC (near field communication) system, displaying the received metadata, and if information included in the metadata is selected, connecting the wireless data communication device using Wi-Fi peer-to-peer (wireless fidelity P2P) connection system and receiving a content or the 1^{st} content in accordance with the selected information from the wireless data communication device.

To further achieve these and other advantages and in accordance with the purpose of the present invention, an apparatus for wireless data communication according to another embodiment of the present invention includes a 1^{st} communication module receiving metadata on a 1^{st} content from a wireless data communication device using NFC (near field communication) system, a display unit displaying the received metadata, and a 2^{nd} communication module, if information included in the metadata is selected, connecting the wireless data communication device using Wi-Fi peer-to-peer (wireless fidelity P2P) connection system, the 2^{nd} communication module receiving a content or the 1^{st} content in accordance with the selected information from the wireless data communication device.

To further achieve these and other advantages and in accordance with the purpose of the present invention, a method for wireless data communication according to another embodiment of the present invention includes the steps of receiving a request for metadata on a 1^{st} content from a wireless data communication device using NFC (near field communication) system, transmitting the metadata using the NFC (near field communication) system, and transmitting the 1^{st} content or a 2^{nd} content related to the metadata to the wireless data communication device using Wi-Fi peer-to-peer (wireless fidelity P2P) connection system.

To further achieve these and other advantages and in accordance with the purpose of the present invention, an apparatus for wireless data communication according to another embodiment of the present invention includes a 1^{st} communication module receiving a request for metadata on a 1^{st} content from a wireless data communication device using NFC (near field communication) system, the 1^{st} communication module transmitting the metadata using the NFC (near field communication) system and a 2^{nd} communication module transmitting the 1^{st} content or a 2^{nd} content related to the metadata to the wireless data communication device using Wi-Fi peer-to-peer (wireless fidelity P2P) connection system.

To further achieve these and other advantages and in accordance with the purpose of the present invention, an apparatus for wireless data communication according to another embodiment of the present invention includes a 1^{st} communication module requesting a request message including information required for Wi-Fi peer-to-peer (wireless fidelity P2P) connection from a 1^{st} wireless data communication device in accordance with NFC (near field communication) system, the 1^{st} communication module receiving a select message according to the NFC (near field communication) system from the 1^{st} wireless data communication device in response to the request message and a 2^{nd} communication module transceiving the information for the Wi-Fi P2P connection with the 1^{st} wireless data communication device in accordance with Wi-Fi P2P connection attribute information included in the select message.

To further achieve these and other advantages and in accordance with the purpose of the present invention, a method for wireless data communication according to another embodiment of the present invention includes the steps of requesting a request message including information required for Wi-Fi peer-to-peer (wireless fidelity P2P) connection from a 1^{st} wireless data communication device in accordance with NFC (near field communication) system, receiving a select message according to the NFC (near field communication) system from the 1^{st} wireless data communication device in response to the request message, and transceiving information for the Wi-Fi P2P connection with the 1^{st} wireless data communication device in accordance with the Wi-Fi P2P connection attribute information included in the select message.

To further achieve these and other advantages and in accordance with the purpose of the present invention, a method for wireless data communication according to a further embodiment of the present invention includes the steps of receiving a request message including information for Wi-Fi peer-to-peer (wireless fidelity P2P) connection from a 1^{st} wireless data communication device in accordance with NFC (near field communication) system, sending a select message including Wi-Fi P2P connection attribute information according to the NFC (near field communication) system to the 1^{st} wireless data communication device in response to the request message, and transceiving the information for the Wi-Fi P2P connection with the 1^{st} wireless data communication device in accordance with the Wi-Fi P2P connection attribute information.

To further achieve these and other advantages and in accordance with the purpose of the present invention, an apparatus for wireless data communication according to another further embodiment of the present invention includes a 1^{st} communication module receiving a request message including information for Wi-Fi peer-to-peer (wireless fidelity P2P) connection from a 1^{st} wireless data communication device in accordance with NFC (near field communication) system, the 1^{st} communication module sending a select message including Wi-Fi P2P connection attribute information according to the NFC (near field communication) system to the 1^{st} wireless data communication device in response to the request message and a 2^{nd} communication module transceiving the information for the Wi-Fi P2P connection with the 1^{st} wireless data communication device in accordance with the Wi-Fi P2P connection attribute information.

### Advantageous Effects

According to an embodiment of the present invention, a Wi-Fi display device configured to stream media can use NFC (near field communication), which is a different short range communication, to set up a mutual connection.

According to an embodiment of the present invention, a fixed media device (e.g., a TV, a personal computer (PC), etc.) and a handheld media device (e.g., a smart phone, etc.) can share their contents and screens with each other through Wi-Fi connection.

According to an embodiment of the present invention, devices capable of sharing contents and screens with each other through Wi-Fi connection can transceive metadata for a corresponding content with each other through NFC connection in advance. And, each of the devices accesses a content server, a web server and/or the like and is then able to search for or collect similar contents and contents related information using the metadata obtained through the NFC connection.

According to an embodiment of the present invention, a device capable of both Wi-Fi Direct (P2P) and NFC can perform Wi-Fi Direct connection setup through the NFC.

According to an embodiment of the present invention, a connection setup of devices configured to perform contents and screen sharing through Wi-Fi P2P connection is performed by NFC, thereby shortening a time taken for the connection setup and enabling the devices to communicate with each other efficiently.

### DESCRIPTION OF DRAWINGS

FIG. 1 is a diagram of a wireless data communication apparatus according to one embodiment of the present invention.

FIG. 2 is a diagram for one example of displaying metadata in a wireless data communication apparatus according to one embodiment of the present invention.

FIG. 3 is a diagram for one example of performing a screen mirroring in the course of an active media sharing according to an embodiment of the present invention.

FIG. 4 is a diagram for another example of performing a screen mirroring in the course of an active media sharing according to an embodiment of the present invention.

FIG. 5 is a diagram for one example of performing a content reviewing function in the course of an active media sharing according to another embodiment of the present invention.

FIG. 6 is a diagram for one example of performing a search for information related to a content in the course of an active media sharing according to another embodiment of the present invention.

FIG. 7 is a diagram for one example of saving or playing media in the course of an active media sharing according to another embodiment of the present invention.

FIG. 8 is a diagram for a handover of a connection through NFC for example of a 2^{nd} wireless communication connection.

FIG. 9 is a diagram of a state machine indicating a phase shift for Wi-Fi Direct P2P connection.

FIG. 10 is a diagram for one example of a case depending on situations of devices included in a connection in case of setting up Wi-Fi P2P connection according to an embodiment of the present invention.

FIG. 11 and FIG. 12 are diagrams for one example of a process for setting up a connection between Wi-Fi P2P devices using NFC connection in Case 1.

FIG. 13 and FIG. 14 are diagrams for one example of a process for setting up a connection between Wi-Fi P2P devices using NFC connection in Case 2.

FIG. 15 and FIG. 16 are diagrams for one example of a process for setting up a connection between Wi-Fi P2P devices using NFC connection in Case 3.

FIG. 17 and FIG. 18 are diagrams for one example of a process for setting up a connection between Wi-Fi P2P devices using NFC connection in Case 4.

FIG. 19 and FIG. 20 are diagrams for one example of a process for setting up a connection between Wi-Fi P2P devices using NFC connection in Case 5.

FIG. 21 is a diagram for one example of transceiving messages initiated using NFC.

FIG. 22 is a diagram for one example of a P2P connection case field value included in a P2P connection case attribute field of a P2P Group Request/Response message exchanged over NFC and a description of the corresponding field value.

FIG. 23 and FIG. 24 are diagrams for one example of information included in a P2P Group Formation Request/Response message if a value of a P2P connection case field is set to 0x00.

FIG. 25 and FIG. 26 are diagrams for one example of information included in a P2P Group Formation Request/Response message if a value of a P2P connection case field is set to 0x01.

FIG. 27 and FIG. 28 are diagrams for one example of information included in a P2P Group Formation Request/Response message if a value of a P2P connection case field is set to 0x02.

FIG. 29 and FIG. 30 are diagrams for one example of information included in a P2P Group Formation Request/Response message if a value of a P2P connection case field is set to 0x03.

FIG. 31 and FIG. 32 are diagrams for one example of information included in a P2P Group Formation Request/Response message if a value of a P2P connection case field is set to 0x04.

FIG. 33 and FIG. 34 are diagrams for one example of information included in a P2P Group Formation Request/Response message if a value of a P2P connection case field is set to 0x05.

FIG. 35 and FIG. 36 are diagrams for one example of information included in a P2P Group Formation Request/Response message if a value of a P2P connection case field is set to 0x06.

FIG. 37 and FIG. 38 are diagrams for one example of information included in a P2P Group Formation Request/Response message if a value of a P2P connection case field is set to 0x07.

FIG. 39 and FIG. 40 are diagrams for one example of information included in a P2P Group Formation Request/Response message if a value of a P2P connection case field is set to 0x08.

FIG. 41 and FIG. 42 are diagrams for one example of information included in a P2P Group Formation Request/Response message if a value of a P2P connection case field is set to 0x09.

FIG. 43 and FIG. 44 are diagrams for one example of information included in a P2P Group Formation Request/Response message if a value of a P2P connection case field is set to 0x0A.

FIG. 45 and FIG. 46 are diagrams for one example of information included in a P2P Group Formation Request/Response message if a value of a P2P connection case field is set to 0x0B.

FIG. 47 and FIG. 48 are diagrams for one example of information included in a P2P Group Formation Request/Response message if a value of a P2P connection case field is set to 0x10.

FIG. 49 and FIG. 50 are diagrams for one example of information included in a P2P Group Formation Request/Response message if a value of a P2P connection case field is set to 0x11.

FIG. 51 and FIG. 52 are diagrams for one example of information included in a P2P Group Formation Request/Response message if a value of a P2P connection case field is set to 0x12.

FIG. 53 and FIG. 54 are diagrams for one example of information included in a P2P Group Formation Request/Response message if a value of a P2P connection case field is set to 0x13.

FIG. 55 and FIG. 56 are diagrams for one example of information included in a P2P Group Formation Request/Response message if a value of a P2P connection case field is set to 0x14.

FIG. 57 and FIG. 58 are diagrams for one example of information included in a P2P Group Formation Request/Response message if a value of a P2P connection case field is set to 0x15.

FIG. 59 and FIG. 60 are diagrams for one example of information included in a P2P Group Formation Request/Response message if a value of a P2P connection case field is set to 0x16.

FIG. 61 and FIG. 62 are diagrams for one example of information included in a P2P Group Formation Request/Response message if a value of a P2P connection case field is set to 0x17.

FIG. 63 and FIG. 64 are diagrams for one example of information included in a P2P Group Formation Request/Response message if a value of a P2P connection case field is set to 0x18.

FIG. 65 and FIG. 66 are diagrams for one example of information included in a P2P Group Formation Request/Response message if a value of a P2P connection case field is set to 0x19.

FIG. 67 and FIG. 68 are diagrams for one example of information included in a P2P Group Formation Request/Response message if a value of a P2P connection case field is set to 0x1A.

FIG. 69 and FIG. 70 are diagrams for one example of information included in a P2P Group Formation Request/Response message if a value of a P2P connection case field is set to 0x1B.

### BEST MODE FOR INVENTION

Reference will now be made in detail to the preferred embodiments of the present invention, examples of which are illustrated in the accompanying drawings.

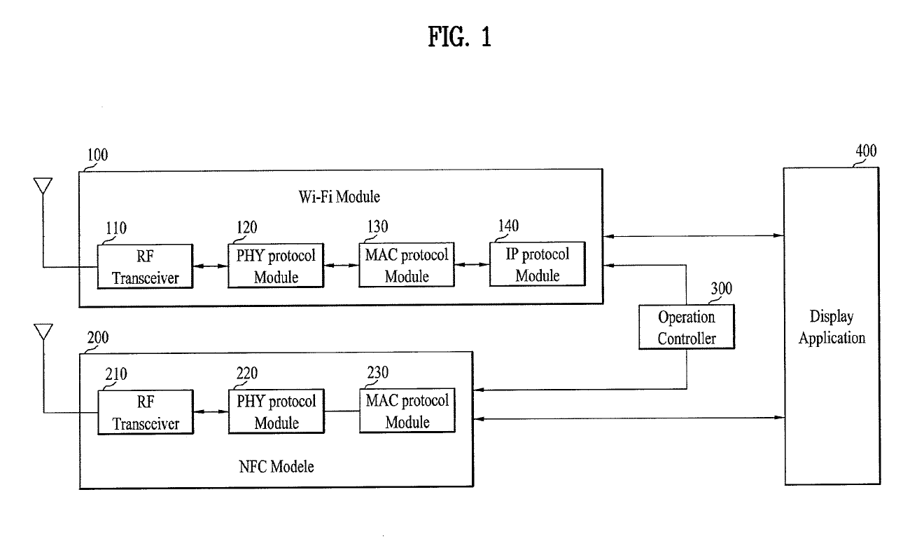

FIG. 1 is a diagram of a wireless data communication apparatus according to one embodiment of the present invention. A wireless data communication apparatus according to one embodiment of the present invention includes a 1^{st} communication module 100, a 2^{nd} communication module 200, a controller 300 and a display application 400. In this drawing, the 1^{st} communication module 100 includes a module configured to communication by Wi-Fi (wireless fidelity) system and the 2^{nd} communication module 200 includes a module configured to communicate by NFC (near field communication) system.

The 1^{st} communication module 100 may include an RF transceiver 110, a physical layer processing unit (PHY protocol module) 120, a MAC layer processing unit (MAC protocol module) 130 and an IP layer processing unit (IP protocol module) 140. In particular, each of these functional blocks is used to transceive wireless data by Wi-Fi system.

The 2^{nd} communication module 200 may include an RF transceiver 210, a physical layer processing unit (PHY protocol module) 220 and a MAC layer processing unit (MAC protocol module) 330. In particular, each of the elements included in the 2^{nd} communication module 200 may be used to transceive wireless data by NFC system.

The RF transceiver 110 of the 1^{st} communication module 100 converts data outputted by the physical layer processing unit (PHY protocol module) 120 of the 1^{st} communication module 100 to a corresponding RF band signal, performs filtering, amplification and the like thereon, and then transmits the corresponding signal to an antenna of the 1^{st} communication module 100. The RF transceiver 210 of the 2^{nd} communication module 200 converts data outputted by the physical layer processing unit (PHY protocol module) 220 of the 2^{nd} communication module 200 to a corresponding RF band signal, performs filtering, amplification and the like thereon, and then transmits the corresponding signal to an antenna of the 2^{nd} communication module 200. The RF transceiver 110 of the 1^{st} communication module 100 converts an RF band signal received via the antenna of the 1^{st} communication module 100 into a signal band that can be processed by the physical layer processing unit (PHY protocol module) 120 of the 1^{st} communication module 100. To this end, the RF transceiver 110 of the 1^{st} communication module 100 performs filtering and the like on the received RF band signal. The RF transceiver 210 of the 2^{nd} communication module 200 converts an RF band signal received via the antenna of the 2^{nd} communication module 200 into a signal band that can be processed by the physical layer processing unit (PHY protocol module) 220 of the 2^{nd} communication module 200. To this end, the RF transceiver 210 of the 2^{nd} communication module 200 performs filtering and the like on the received RF band signal. And, the RF transceiver 110/210 of the 1^{st}/2^{nd} communication module 100/200 may include a switch function for switching a transceiving function.

The physical layer processing unit (PHY protocol module) 120/220 of the 1^{st}/2^{nd} communication module 100/200 can perform FEC encoding, modulation and the like on the transmitted data of the communication module 100/200. The physical layer processing unit (PHY protocol module) 120/220 of the 1^{st}/2^{nd} communication module 100/200 inserts a preamble, a pilot signal or the like as an additional signal and then outputs it to the RF transceiver 110/210 of the communication module 100/200. In order to perform the above-mentioned functions, the physical layer processing unit (PHY protocol module) 120/220 of the 1^{st}/2^{nd} communication module 100/200 may include a modulator, a demodulator, an equalizer, an FEC encoder, an FEC decoder and the like.

The physical layer processing unit (PHY protocol module) 120/220 of the 1^{st}/2^{nd} communication module 100/200 performs demodulation, equalization, error correction decoding (FEC decoding) and the like on the received signal outputted from the RF transceiver 110/210 of the 1^{st}/2^{nd} communication module 100/200, removes the additional signal added by the physical layer and the like, and then outputs the corresponding signal to the MAC layer processing unit 130/230.

The MAC layer processing unit 130/230 of the 1^{st}/2^{nd} communication module 100/200 performs a data processing to deliver data of an upper layer to a physical layer. To this end, the MAC layer processing unit 130/230 performs a function of processing the transmitted data of the communication module 100/200 and then sending the processed data to the physical layer processing unit (PHY protocol module) 110/220 and a function of delivering the received data processed by the physical layer processing unit (PHY protocol module) 110/220 to the upper layer. In order to perform these functions, the MAC layer processing unit 130/230 performs a signal processing according to an additional communication protocol.

The IP layer processing unit (IP protocol module) 140 of the 1^{st} communication module 100 processes data to be transmitted according to an IP protocol and then output the processed data to the MAC layer processing unit 130. The IP layer processing unit (IP protocol module) 140 of the 1^{st} communication module 100 processes data received from the MAC layer processing unit 130 and then outputs the processed data in accordance with the IP protocol.

The controller (e.g., operation controller) 300 can control operations of the 1^{st} communication module 100 and the 2^{nd} communication module 200 in response to an operation desired by a user.

The display application unit 400 includes a block for performing an application for display. The display application unit 400 enables a user-desired display function to be selected by interacting with a user and performs the corresponding function by initializing the corresponding function.

According to one embodiment of the present invention mentioned in the following description, each of at least two wireless data communication devices uses at least two communication modules. The at least two wireless data communication devices share a content with each other using a 1^{st} communication module. Before the content is displayed, the at least two wireless data communication devices transceive metadata of the content using the 2^{nd} communication module. Therefore, the at least two wireless data communication devices are facilitated to control the sharing and display of the content. According to another embodiment of the present invention, in case that two wireless data communication devices are directly connected to each other using a 1^{st} communication module, a connection attribute between the two devices can be transceived through a 2^{nd} communication module depending on connected cases.

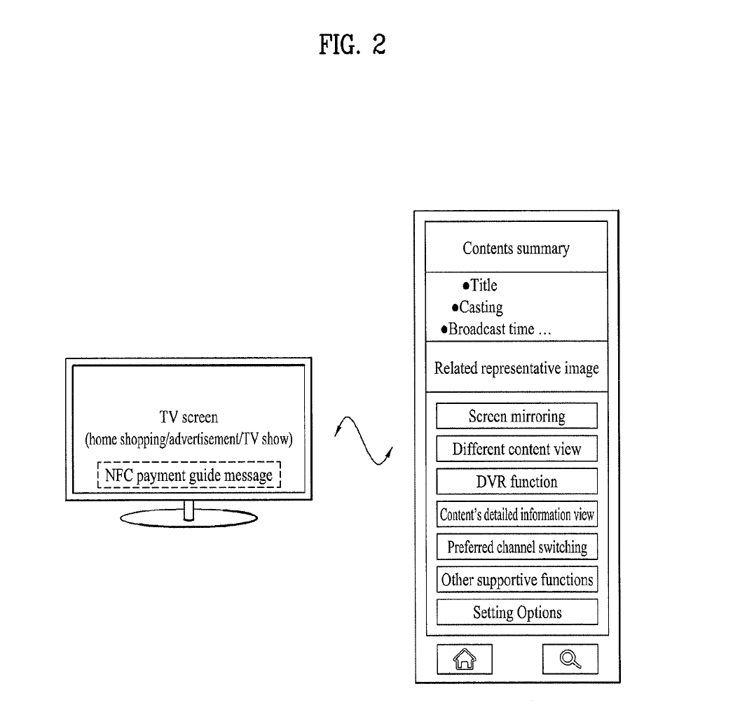

FIG. 2 is a diagram for one example of displaying metadata in a wireless data communication apparatus according to one embodiment of the present invention. This drawing shows one example of screens of a media device and a mobile terminal.

Information on a content outputted to a screen of a media device can be externally displayed on a screen of a mobile terminal. The media device and the mobile terminal can be connected to each other by Wi-Fi communication system and can share a content saved in the corresponding device or terminal or a content externally displayed on the corresponding screen with each other by Wi-Fi communication system. Meanwhile, the media device and the mobile terminal can communicate with each other by NFC system. In doing so, the mobile terminal can obtain information on a content, which can be outputted from the media device, through NFC system in advance.

For instance, in case that the media device externally displays a specific content such as home shopping, advertisement, TV show and the like on a screen, the mobile terminal can obtain metadata including information on a summary, title, casting information, broadcast time, representative image and the like of the content externally displayed by the media device from the media device by the NFC system. The mobile terminal receives the metadata on a screen mirroring, a different content view, a DVR function, a content's detailed information view, a preferred channel switching, other supportive functions, setting options and the like from the media device and is then able to externally display the metadata related to the external display of the corresponding content on the screen of the mobile terminal. Therefore, the media device and the mobile terminal can transceive the metadata related to the external display of the corresponding content before transceiving the related content by streaming or the like according to the Wi-Fi communication system.

In the following description, embodiments of the present invention using at least two wireless data communication devices, each of which is equipped with a display function, are explained in detail. A device for transmitting displayable media shall be named a display source device. And, a device for receiving the displayable media shall be named a display sink device.

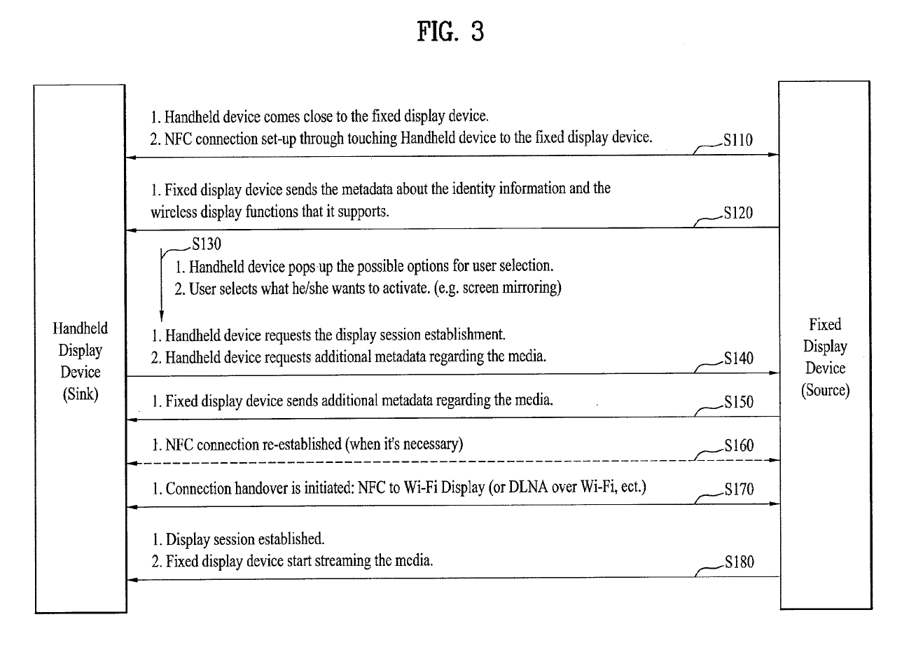

FIG. 3 is a diagram for one example of performing a screen mirroring in the course of an active media sharing according to an embodiment of the present invention. In this case, a fixed media display device includes a display source device and a handheld display device includes a display sink device, for example.

First of all, a handheld device is brought close to a fixed media display device and the handheld display device is then connected to the media display device using NFC system [S110].

The media display device transmits identification information of the media display device and metadata including a wireless display function supported by the media display device to the handheld display device using the NFC system [S120].

The handheld display device externally displays available option information related to the connection of the media display device to a user based on the received metadata, thereby enabling the user to select a desired function through the option information and the like [S130]. The handheld display device can provide a user with the metadata exemplarily shown in FIG. 2 through its display. If the user selects a corresponding function, the handheld display device can externally display information for performing a screen mirroring function with the media display device.

The handheld display device can make a request for a display session to the media display device in order to externally display media of the media display device based on the user-requested information in the metadata. If necessary, the handheld display device can request additional metadata on the media [S140].

The media display device can transmit the additional metadata requested by the handheld display device to the handheld display device through the NFC system [S150].

In some cases, if the communication connection by the NFC system is disconnected, the NFC connection can be reestablished [S160].

In order to perform the screen mirroring by Wi-Fi communication system, a handover can be initialized into the Wi-Fi communication system from the NFC system [S170]. Alternatively, initialization of a handover can be performed for a connection setup by a communication system according to DLNA (digital living network alliance) based on the Wi-Fi communication system.

If the handover is completed, the media display device and the handheld display device display that the screen mirroring has been set up and can perform an active media sharing [S180]. Therefore, a display session is established between the media display device and the handheld display device. Subsequently, the handheld display device receives a streaming of media from the media display device and is then able to externally display the received media.

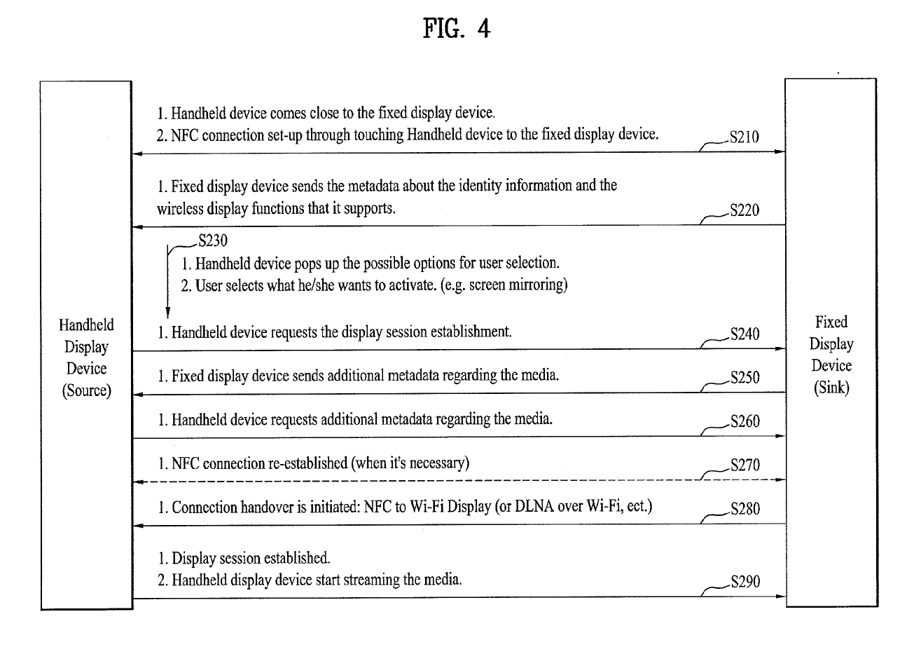

FIG. 4 is a diagram for another example of performing a screen mirroring in the course of an active media sharing according to an embodiment of the present invention. In this case, a fixed media display device and a handheld display device include a display sink device and a display device, respectively, which is opposite to the former example.

First of all, a handheld device is brought close to a fixed media display device and the handheld display device is then connected to the media display device using NFC system [S210].

The media display device transmits identification information of the media display device and metadata for a wireless connection display function (e.g., Wi-Fi display) supported by the media display device to the handheld display device using the NFC system [S220].

The handheld display device externally displays available option information related to the connection of the media display device to a user based on the received metadata, thereby enabling the user to select a desired function through the option information and the like [S230]. If the user selects a corresponding function, the handheld display device can externally display information for performing a screen mirroring function with the media display device from this step.

The handheld display device can make a request for a display session to the media display device in order to externally display the media displayed by the media display device [S240].

The media display device can transmit additional metadata requested by the handheld display device to the handheld display device through the NFC system [S250].

In some cases, if the communication connection by the NFC system is disconnected, the NFC connection can be re-established [S260].

In order to perform the screen mirroring by Wi-Fi communication system, a handover can be initialized into the Wi-Fi communication system from the NFC system [S270]. Alternatively, initialization of a handover can be performed for a connection setup by a communication system according to DLNA (digital living network alliance) based on the Wi-Fi communication system [S280].

If the handover is completed, the media display device and the handheld display device display that the screen mirroring has been set up and can perform an active media sharing [S290]. Therefore, a display session is established between the media display device and the handheld display device. Subsequently, the handheld display device receives a streaming of media from the media display device and is then able to externally display the received media.

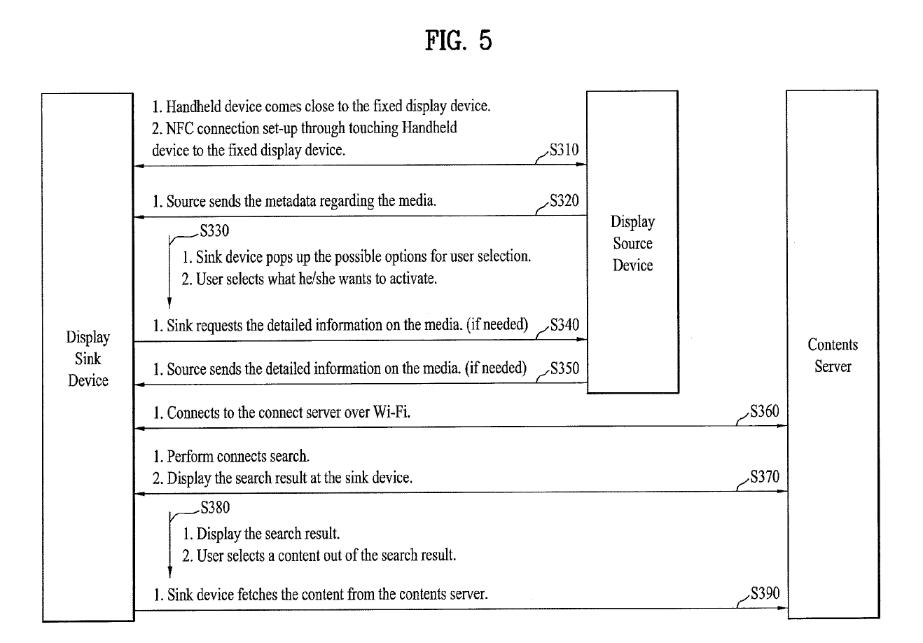

FIG. 5 is a diagram for one example of performing a content reviewing function in the course of an active media sharing according to another embodiment of the present invention. In this case, each of a handheld display device and a media display device may become a display sink device or a display source device for example.

The display sink device or the display source device can be wireless connected by NFC system. For instance, the handheld display device is brought close to the media display device and then connected to the media display device using the NFC system, thereby establishing a communication connection between the display sink device and the display source device [S310].

The display source device transmits metadata related to specific media to the display sink device using the connected NFC communication system [S320].

The display sink device displays a user-selected option information based on the received metadata, thereby enabling a user to select a desired function [S330].

If necessary, the display sink device may additionally make a request for detailed information on media to the display source device using the NFC system [S340].

If necessary, on the other hand, the display source device may additionally make a request for detailed information on media to the display sink device using the NFC system [S350].

In the step S340 or the step S350, the display sink device activates a user-selectable application based on the received metadata, thereby enabling a user-desired function to be displayed and selected.

In case that a user selects a review of a previously broadcasted or played content, the display sink device may make a request for detailed metadata on the user-selected media to the display source device. If so, the display source device can transmit the metadata on the user-selected media to the display sink device.

Based on the received metadata, the display sink device can access a content server through a wireless communication function such as Wi-Fi and the like [S360].

If the display sink device accesses the content server, the display sink device performs a search function and then displays a result of the search externally [S370].

Based on the search result externally displayed by the display sink device, a search result related to the content from a user can be displayed [S380]. If the user selects a media to play based on the search result, the selected media can be received from the content server by Wi-Fi communication system or the like [S390].

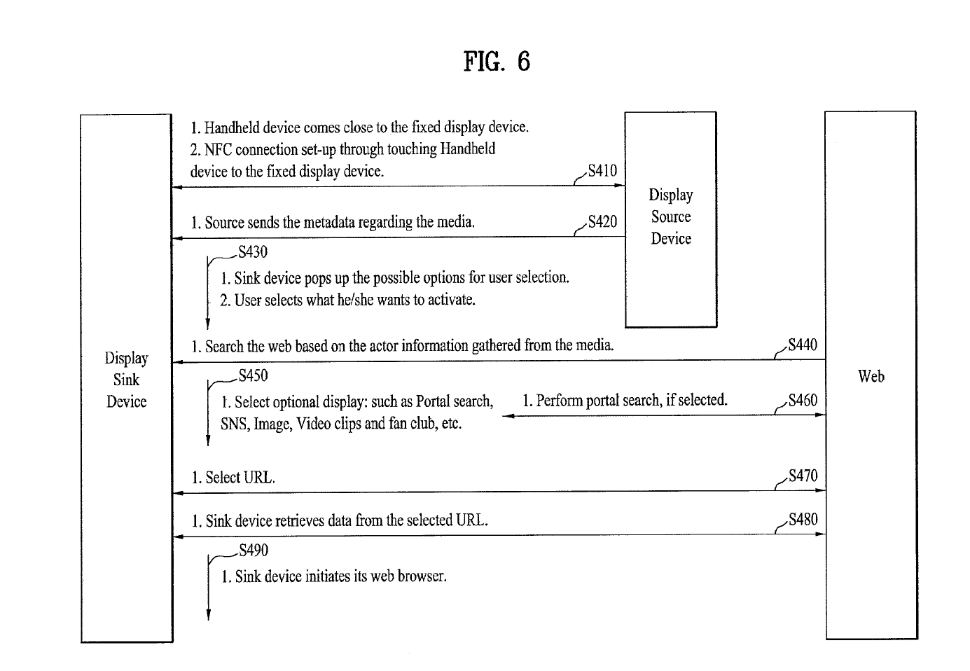

FIG. 6 is a diagram for one example of performing a search for information related to a content in the course of an active media sharing according to another embodiment of the present invention. In this case, each of a handheld display device and a media display device may become a display sink device or a display source device for example.

The display sink device or the display source device can be wireless connected by NFC system. For instance, the handheld display device is brought close to the media display device and then connected to the media display device using the NFC system, thereby establishing a communication connection between the display sink device and the display source device [S410].

The display source device transmits metadata related to specific media to the display sink device using the connected NFC communication system and the display sink device receives the corresponding metadata from the display source device using the NFC system [S420].

The display sink device executes an application, which can be selected by a user, based on the metadata received using the NFC system, thereby enabling a user-desired function to be displayed and selected. In particular, the display sink device displays a user-selected option information and then enables the user to select a desired function [S430]. For instance, if character information and the like are included in the metadata, the display sink device can display a list of corresponding character information and the like.

Based on the metadata, the display sink device accesses a web server using a communication system such as Wi-Fi and the like [S440].

The display sink device searches a web server, which is connected using the communication system such as Wi-Fi and the like, for the character information using such a search engine as a web portal and the like [S450] and then displays a corresponding search result to select a specific information from the related informations including a portal search result for the character information, SNS (social network service), image, video clip, fan club and the like [S460].

If the user selects such a location information as a URL and the like of a webpage containing a desired information from the above-mentioned search result through the display sink device [S470], the display sink device accesses the corresponding server using the corresponding location information and then receives data [S480].

The display sink device initializes a web browser and is then able to externally display the received information [S490].

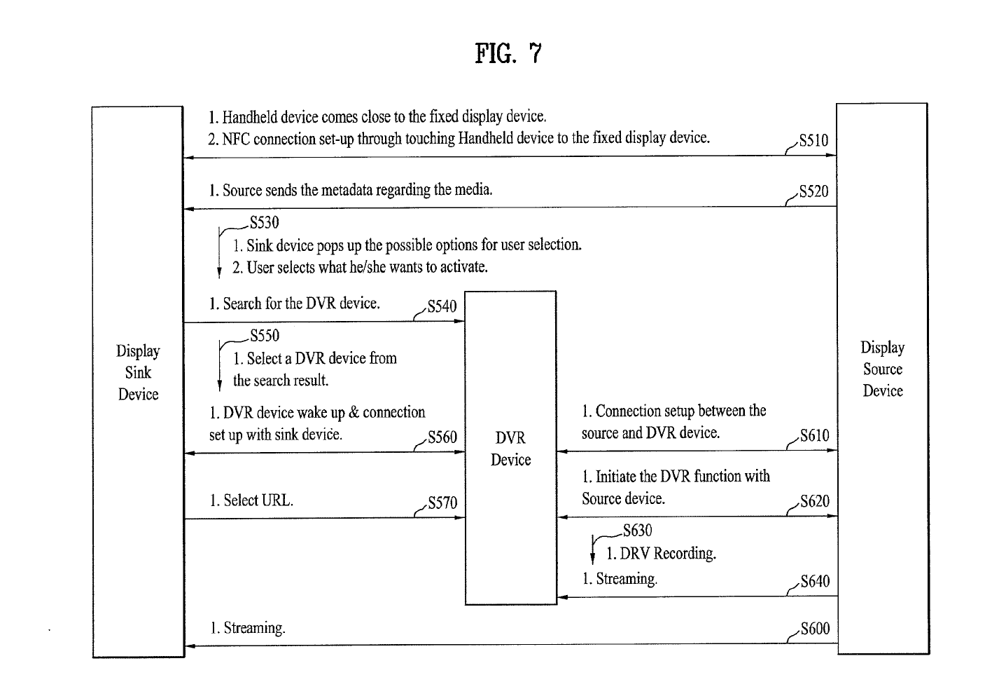

FIG. 7 is a diagram for one example of saving or playing media in the course of an active media sharing according to another embodiment of the present invention. In this case, each of a handheld display device and a media display device may become a display sink device or a display source device for example.

The display sink device or the display source device can be wireless connected by NFC system. For instance, the handheld display device is brought close to the media display device and then connected to the media display device using the NFC system, thereby establishing a communication connection between the display sink device and the display source device [S510].

The display source device transmits metadata related to specific media to the display sink device using the connected NFC communication system and the display sink device receives the corresponding metadata from the display source device using the NFC system [S520].

The display sink device displays an option information selected by a user based on the received metadata using the NFC system, thereby enabling the user to select a desired function [S530]. The display sink device executes an application, which can be selected by the user, based on the received metadata. For instance, the display sink device can externally display list information of DVR devices configured to store a content currently played by the display source device to the user.

If the user selects a specific DVR device, the display sink device can find a storage device such as the DVR device through a communication system such as Wi-Fi and the like [S540].

If a specific DVR device is selected from a result of searching the communication connection by the display sink device [S550], the display sink device turns on a power of the DVR device for connection of the corresponding DVR device and then connects the corresponding DVR device through such a communication system as Wi-Fi and the like [S560].

A DVR function of the connected DVR device is initialized [S570] and a stream of media related to the metadata received using the NFC system is received through such a communication system as Wi-Fi and the like [S600].

Meanwhile, if the display sink device is unable to directly connect a DVR device, it is able to connect the corresponding DVR device via the display source device.

The display source device can be connected to the DVR device by a communication system such as Wi-Fi and the like [S610].

The display source device initializes the DVR device and the DVR function [S620] and is then able to perform the DVR function of saving media and the like [S630].

The display source device can transmit the media to the display sink device by streaming and is also able to save the same media in the DVR device by transmitting the media by streaming [S640]. Hence, the display source device can control the DVR device to perform the DVR function using the display sink device as a medium.

According to the above-described embodiments, a 1^{st} wireless data communication device receives metadata on a 1^{st} content from a 2^{nd} wireless data communication device using NFC (near field communication) system and then displays the received metadata.

If information included in the metadata is selected, the 1^{st} wireless data communication device is connected to the 2^{nd} wireless data communication device using Wi-Fi (wireless fidelity) peer-to-peer (P2P) connection system and is then able to receive the corresponding content or another content in accordance with the selected information from the 2^{nd} wireless data communication device.

The 2^{nd} wireless data communication device receives a request for the metadata on the 1^{st} content from the 1^{st} wireless data communication device using the NFC (near field communication) system.

The 2^{nd} wireless data communication device transmits the metadata to the 1^{st} wireless data communication device using the NFC (near field communication) system and is also able to transmit the corresponding content or another content related to the metadata to the 1^{st} wireless data communication device using the Wi-Fi (wireless fidelity) peer-to-peer (P2P) connection system.

Each of the 1^{st} and 2^{nd} wireless data communication devices may include an NFC communication module configured to transceive metadata and a Wi-Fi communication module configured to receive a content in accordance with the metadata by the Wi-Fi (wireless fidelity) peer-to-peer (P2P) connection system. And, details of the metadata can refer to the former description with reference to FIG. 2. According to the former example shown in FIG. 1, each of the 1^{st} and 2^{nd} wireless data communication devices may include a display unit configured to display metadata or contents.

If a user selects a specific information from metadata displayed by a wireless data communication device, the wireless data communication device receives a content related to the metadata from a 2^{nd} wireless data communication device, a content server, a web server or a DVR device using Wi-Fi communication system or obtain other informations related to the selected information. In this case, details of other informations related to the selected information can refer to the former description.

According to the above-described embodiment, in order to set up a mutual connection, Wi-Fi display device, which streams media including audio or video using a wireless short range network, can use a different short range communication network, e.g., NFC (near field communication).

Moreover, According to the above-described embodiment, a fixed media device (e.g., a television, a personal computer, etc.) and a handheld media device (e.g., a smart phone) can share contents and screens of the devices with each other through Wi-Fi connection.

According to an embodiment of the present invention, devices, which share contents and screens with each other through Wi-Fi connection, can be configured to set up Wi-Fi connection through their NFC systems. To this end, the devices sharing contents and screens with each other can transceive metadata on the contents with each other through NFC connection in advance. And, the devices can search for or collect a similar content or content related information by accessing a content server, a web server or the like using the metadata obtained through the NFC connection.

According to another embodiment of the present invention disclosed in the following description, a wireless data communication device capable of at least two types of wireless communication connections can obtain information for a 1^{st} wireless communication connection through a 2^{nd} wireless communication connection. A detailed embodiment can be described based on the accompanying drawing FIG. 1.

In this case, as mentioned in the description of the above example, the 1^{st} wireless communication connection can be performed through Wi-Fi Peer-to-Peer (hereinafter abbreviated P2P) (such connection shall be named Wi-Fi P2P connection) and the 2^{nd} wireless communication connection can be performed through NFC (near field communication). Yet, in this case, information for setting up the 1^{st} wireless communication connection may be transceived in form of a message in accordance with the 2^{nd} wireless communication connection. This embodiment is described with reference to the accompanying drawings as follows.

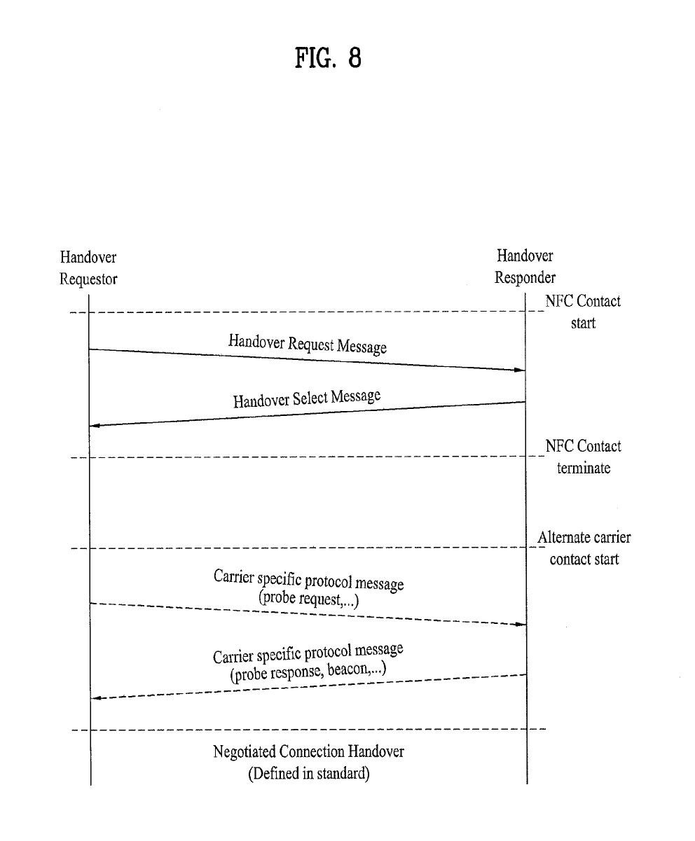

FIG. 8 is a diagram for a handover of a connection through NFC for example of a 2^{nd} wireless communication connection.

Using Negotiated Connection Handover of NFC, a handover can be performed while a requestor device and a selector device are communicating with each other.

In case that a handover requestor and a handover responder are connected to each other by NFC, the handover requestor sends a handover request message to the handover responder. In response to the handover request message, the handover responder sends a handover select message to the handover requestor. Information required for a connection handover is exchanged on different carriers through such two-way message transaction, the corresponding NFC connection is terminated, and a connection can be then set up using a changed carrier.

If the handover requestor and the handover responder are connected through the changed carrier, they can transceive a carrier specific protocol message with each other. Using this connection handover mechanism, information required for Wi-Fi direct P2P connection can be transceived as well.

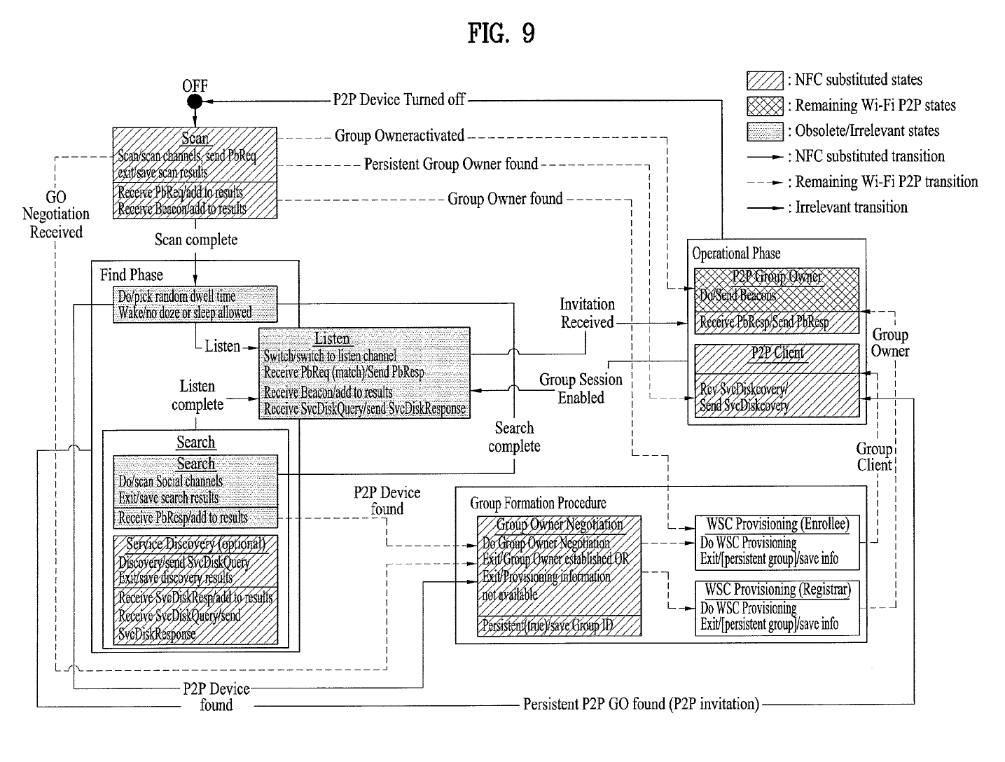

FIG. 9 shows a state machine indicating a phase shift for Wi-Fi Direct P2P connection. In case of using NFC connection according to an embodiment of the present invention, a changed phase and a substituted transmission are described with reference to the corresponding drawing as follows.

A state in Wi-Fi direct P2P connection mainly includes a scan phase, a find phase, an operation phase and a Group Formation Procedure phase.

First of all, the scan phase is described as follows.

Actions of the scan phase include a scan action including a passive scanning including a scanning of a specific band of 5 GHz and an active scanning and an exit action of terminating a scan state.

An internal behavior of the scan phase may include Receive Probe Response of receiving a probe rezones message and Receive Beacon of receiving a beacon.

Transitions of the scan phase may include P2P device found transition, P2P Group owner found, P2P Group Owner of a previously connected persistent group found, Group Owner Functionality Activated, and Scan completed.

The find phase is described as follows.

First of all, a listen state of the find phase is described as follows.

Actions of the listen state include Pick Random Dwell Time action and Listen on Social Channel action.

Internal behaviors of the listen state may include Receive Probe Request with matching parameters, Receiver Beacon, Receive Service Discovery Query, and the like.

Transitions of the listen state may include Group Owner Negotiation Received, Listen State Completed, Invitation Received and the like.

Actions of a search state as a sub-state of the composite state may include Scans Social Channels, Exit and the like and an internal behaviors may include Receive Probe Response and the like.

Actions of a service discovery state as an optional sub-state includes discovery and Exit and an internal behavior includes Receive Service Discovery Response.

Transitions of the composite state may include Persistent P2P Group Owner Found, Search State Completed, P2P Device Found, P2P Group Owner Found and the like.

Meanwhile, states of Group Formation Procedure phase may include Group Owner Negotiation, WSC Provisioning Enrollee and WSC Provisioning Register.

Actions of Group Owner Negotiation State include Group Owner Negotiation and Exit, an internal behavior may include Persistent, and transitions may include P2P Device becomes Group Owner, P2P Group becomes Client and Group owner Negotiation fails.

Actions of WSC Provisioning Enrollee State include WSC Provisioning action and Exit action and a transition includes WSC Provisioning Completed.

Actions of WSC Provisioning Register State include SC Provisioning action and Exit action and a transition may include WSC Provisioning Completed.

As a state of Operation phase, P2P Group Owner state has an action of Send Beacons, an internal behavior of Receive Probe Request, and transitions of P2P Device Turned off and P2P Group Session Ended.

As a state of Operation phase, P2P Client state has an internal behavior of Receive Service Discovery Request and transitions of P2P Device Turned off and P2P Group Dissolved.

If NFC connection is used in the state of the Wi-Fi P2P connection, Service Discovery sub-states of Scan phase and Find phase, Group owner Negotiation state of Group Formation Procedure phase, P2P Client state of Operation phase and the internal behavior Receive Probe Request of P2P Group Owner state of Operation phase can be substituted with the state for the NFC connection.

Send Beacons action of the P2P Group Owner state is maintained equal to the Wi-Fi P2P state.

Meanwhile, the listen state of the find phase and the search sub-state and its internal action become states unrelated to the NFC substitution.

For the transitions of the respective phases, states and action, Group Owner activated, Persistent Group Owner Found, Group Owner Found, P2P Device Found and P2P Device becomes Group Owner make transitions using the NFC connection. Yet, the rest are maintained equal to Wi-Fi P2P transition or become transitions unrelated thereto.

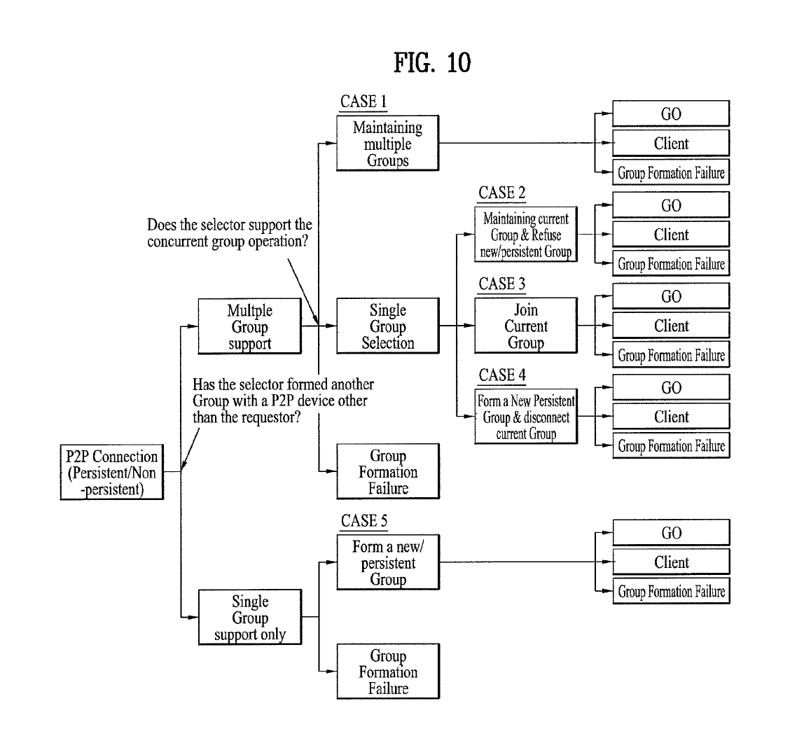

FIG. 10 shows a case tree for one example of a case depending on a connected situation in case of setting up Wi-Fi P2P connection according to an embodiment of the present invention. According to an embodiment of the present invention, information required for connection setup can be transceived depending on a situation of Wi-Fi P2P connection.

When wireless data communication devices perform Wi-Fi P2P Connection (Persistent/Non-persistent), there is a case of supporting connections to multiple groups [Multiple Group support] or a case of supporting a single group only [Single Group support only] depending on whether a corresponding selector can form a group available for Wi-Fi P2P connection to a device different from a requestor.

Depending on whether a selector can perform simultaneous group operations, the case of supporting connections to multiple groups [Multiple Group support] can be divided into a case of maintaining multiple groups [Multiple Group support, hereinafter named Case 1], a case of selecting a single group [Single Group Selection], and a case of failing in forming a group [Group Formation Failure].

The case of selecting a single group [Single Group Selection] can include a case that a requestor refuses a new/persistent group while maintaining a current group [Maintaining current Group & Refuse new/persistent Group, hereinafter named Case 2], a case that a requestor joins a current group [join current Group, hereinafter named Case 3], and a case that a requestor forms a new persistent Group and disconnects a current group [Form a New persistent Group & disconnect current Group, hereinafter named Case 4].

Meanwhile, the case that a selector is unable to form a group with Wi-Fi P2P connection device different from a current requestor [Single Group support only] can be divided into a case that a selector forms a new or persistent Group [Form a new/persistent Group, hereinafter named Case 5] and a case of failing in forming a group [Group Formation Failure].

The above-mentioned Cases 1 to 5 can be divided into a case that a requestor is Group Owner [GO], a case that a requestor is Client [Client], and a case of failing in forming a group [Group Formation Failure]. In particular, Requestor can become P2P Group Owner or P2P Client depending on a connection case or may fail in Group Formation.

In the following description, how to apply and process NFC connection depending on each of the cases mentioned in the above description according to an embodiment is explained.

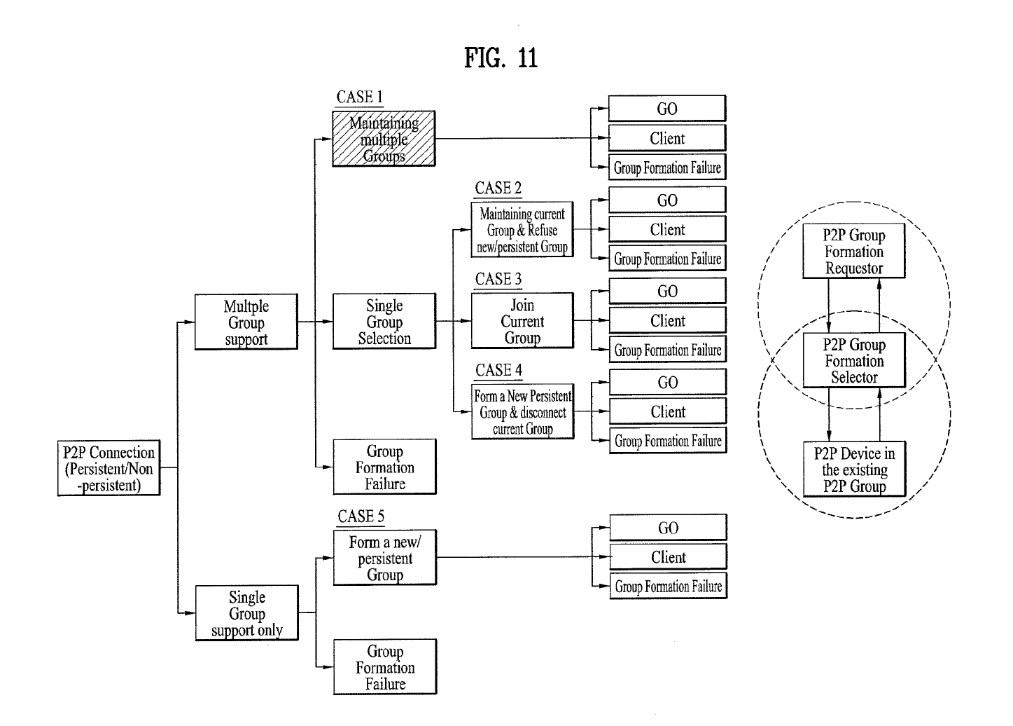

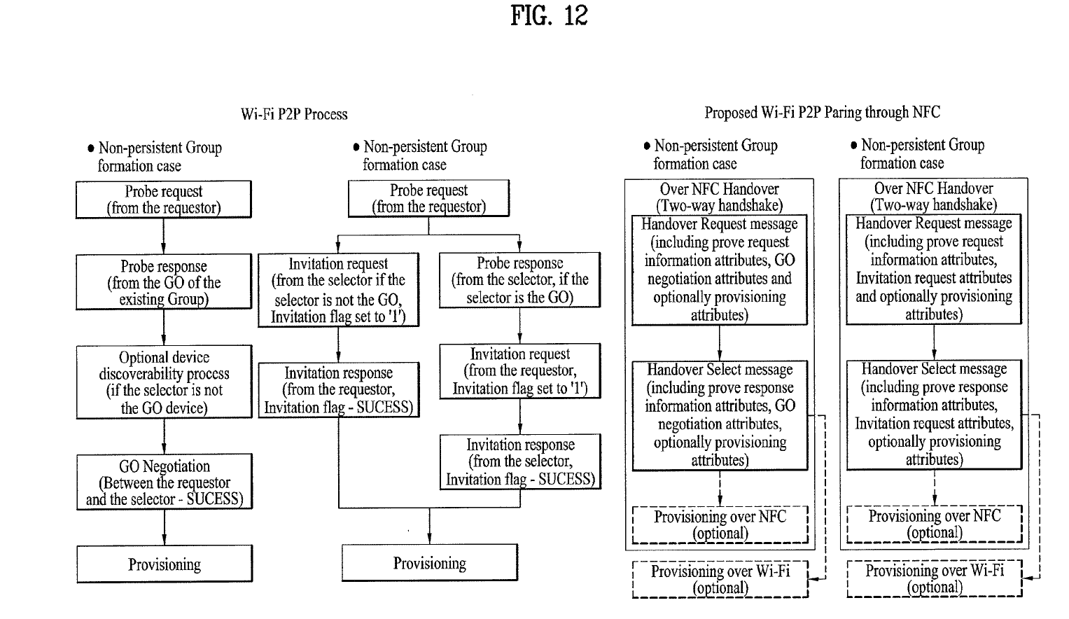

FIG. 11 and FIG. 12 are diagrams for one example of a process for setting up a connection between Wi-Fi P2P devices using NFC connection in Case 1.

According to Case 1, a peer device of Requestor is Group Owner of a previously formed group and an existing P2P Group is maintained. Hence, as mentioned in the description with reference to in FIG. 11, P2P Group formation Selector can be connected to a different P2P Group Formation Requestor while maintaining a connection to a P2P device of the existing P2P group.

In Case 1, a Group Owner device, which already has an existing Group to set up Wi-Fi P2P device connection using NFC, can retain an interface supportive of a plurality of Wi-Fi P2P Groups.

FIG. 12 is a diagram of comparing the existing Wi-Fi P2P connection process (left part) in Case 1 shown in FIG. 11 to a Wi-Fi P2P connection process (right part) using NFC according to an embodiment of the present invention.

In each of the connection processes, a connection setup between Wi-Fi P2P Devices can be sorted into Invoke process (denoted as Persistent Group formation case) for Persistent Group (Persistent P2P Group) and Group formation (denoted as Non-Persistent Group formation case) for Non-Persistent Group.

In Persistent Group formation case, an existing Wi-Fi P2P connection process is described as follows.

First of all, Requestor outputs a probe request.

If Selector is not Group Owner and Invitation Flag is set to 1, Selector outputs Invitation Request.

If so, Requestor outputs Invitation Response having Invitation Flag set to SUCCESS.

If Selector is Group Owner, it outputs a probe response.

If so, Requestor outputs Invitation Response having Invitation Flag set to 1.

Selector outputs Invitation Response having Invitation Flag set to SUCCESS.

If Requestor or Selector outputs Invitation Response having Invitation Flag set to SUCCESS, Provisioning phase is entered.

Meanwhile, in Persistent Group formation case, Wi-Fi P2P connection process using NFC is described as follows.

First of all, two-way handshake for NFC handover is performed.

Requestor outputs a handover request message. This handover request message may include probe request information attributes and Invitation Request attributes and may further include Provisioning attributes optionally.

Selector outputs a handover select message. This handover select message may include probe response information attributes and Invitation Request attributes and may further include Provisioning attributes optionally.

After Selector has outputted the handover select message, Provisioning phase on NFC or Provisioning phase on Wi-Fi is entered.

In Non-Persistent Group formation case, the existing Wi-Fi P2P connection process is described as follows.

First of all, Requestor outputs a probe request, while Group Owner of an existing group outputs a probe response.

If Selector is not Group owner device, the device can optionally perform Discoverability process.

If a group owner negotiation process between Requestor and new Selector is SUCCESS, Provisioning phase is entered.

Thus, before the Provisioning phase is entered for the P2P connection setup, exchange of maximum 4 Wi-Fi Management frames is necessary between Requestor and Selector.

On the other hand, in Non-Persistent Group formation case, Wi-Fi P2P connection process using NFC is described as follows.

First of all, two-way handshake for NFC handover is performed.

Requestor outputs a handover request message. The handover request message may include probe request information attributes and Go negotiation attributes and may further include Provisioning attributes optionally.

Selector outputs a handover select message. The handover select message may include probe response information attributes and Go negotiation attributes and may further include Provisioning attributes optionally.

After Selector has outputted the handover select message, Provisioning on NFC or Provisioning on Wi-Fi is entered.

Therefore, for the existing Wi-Fi P2P connection, the exchange of maximum 4 Wi-Fi Management frames is necessary between Requestor and Selector. Yet, according to an embodiment of the present invention, the exchange can be substituted with Two-way Connection Handover Message transaction defined by NFC, whereby the connection process can be simplified.

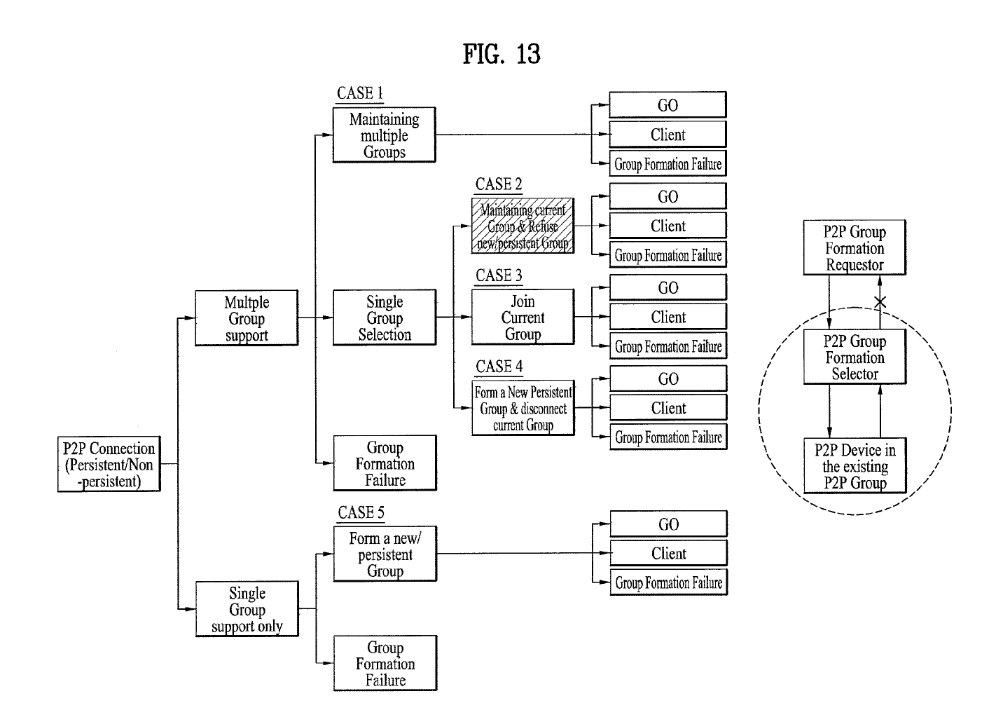

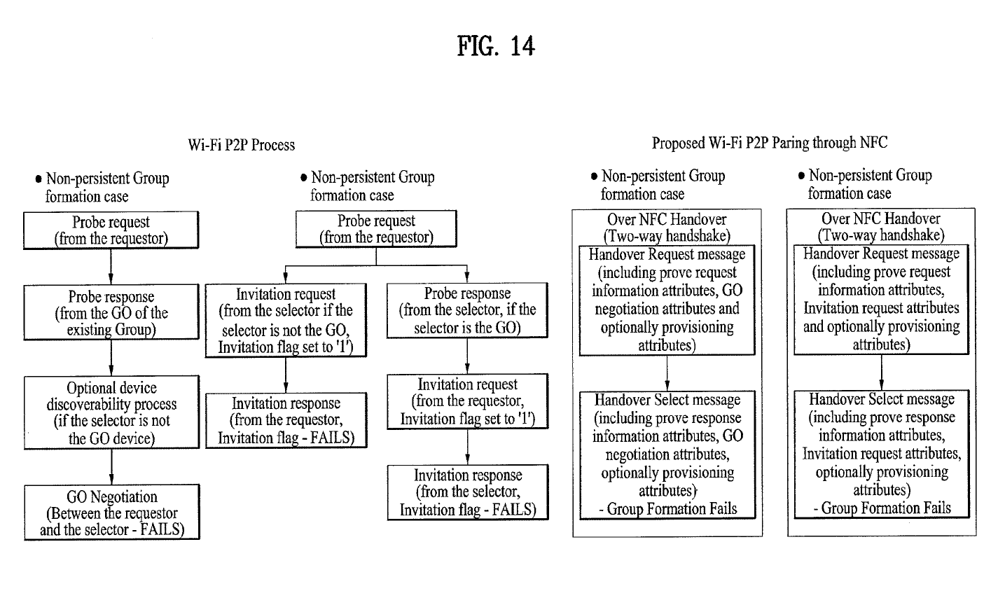

FIG. 13 and FIG. 14 are diagrams for one example of a process for setting up a connection between Wi-Fi P2P devices using NFC connection in Case 2.

Referring to FIG. 13, Case 2 shows that, while a connection between W0Fi P2P devices is set up using NFC, Group Owner refuses Group formation for a potential client. Hence, although P2P Group formation Selector maintains a connection to a P2P device of an existing P2P group, it refuses a connection to a different P2P Group Formation Requestor.

FIG. 14 is a diagram of comparing the existing Wi-Fi P2P connection process (left part) in Case 2 shown in FIG. 13 to a Wi-Fi P2P connection process (right part) using NFC according to an embodiment of the present invention.

In each of the connection processes, a connection setup between Wi-Fi P2P Devices can be sorted into Invoke process (denoted as Persistent Group formation case) for Persistent Group and Group formation (denoted as Non-Persistent Group formation case) for Non-Persistent Group.

1) First of all, Wi-Fi P2P connection process in Persistent Group formation case is described as follows.

Requestor outputs a probe request.

If Selector is not Group Owner and Invitation Flag is set to 1, Selector outputs Invitation Request.

If so, Requestor outputs Invitation Response having Invitation Flag set to FAILS.

If Selector is Group Owner, it outputs a probe response.

If so, Requestor outputs an invitation request having Invitation Flag set to 1.

And, Selector outputs Invitation Response having Invitation Flag set to FAILS.

2) In Persistent Group formation case, Wi-Fi P2P connection process using NFC is described as follows.

Meanwhile, in Persistent Group formation case, Wi-Fi P2P connection process using NFC is described as follows.

Requestor and Responder perform two-way handshake for NFC handover. Requestor outputs a handover request message. This handover request message may include probe request information attributes and Invitation Request attributes and may further include Provisioning attributes optionally.

Selector outputs a handover select message. This handover select message may include probe response information attributes and Invitation Request attributes and may further include Provisioning attributes optionally.

In this case, Group Formation fails.

3) In Non-Persistent Group formation case, Wi-Fi P2P connection process is described as follows.

Requestor outputs a probe request.

Group Owner of an existing group outputs a probe response.

If Selector is not Group owner device, the device can selectively perform Discoverability process.

A group owner negotiation process between Requestor and Selector fails.

4) Yet, in Non-Persistent Group formation case, Wi-Fi P2P connection process through NFC is described as follows.

First of all, for NFC handover, two-way handshake is performed.

Requestor outputs a handover request message. The handover request message may include probe request information attributes and Go negotiation attributes and may further include Provisioning attributes optionally.

Selector outputs a handover select message. The handover select message may include probe response information attributes and Go negotiation attributes and may further include Provisioning attributes optionally.

And, Group Formation fails.

According to Wi-Fi P2P connection process, until a P2P connection setup and a determination of failure of the corresponding setup in each case, maximum 4 Wi-Fi Management frames should be exchanged between Requestor and Selector. Yet, if NFC connection is used according to an embodiment of the present invention, the process can be substituted with Two-way Connection Handover Message transaction, whereby the connection process can proceed efficiently.

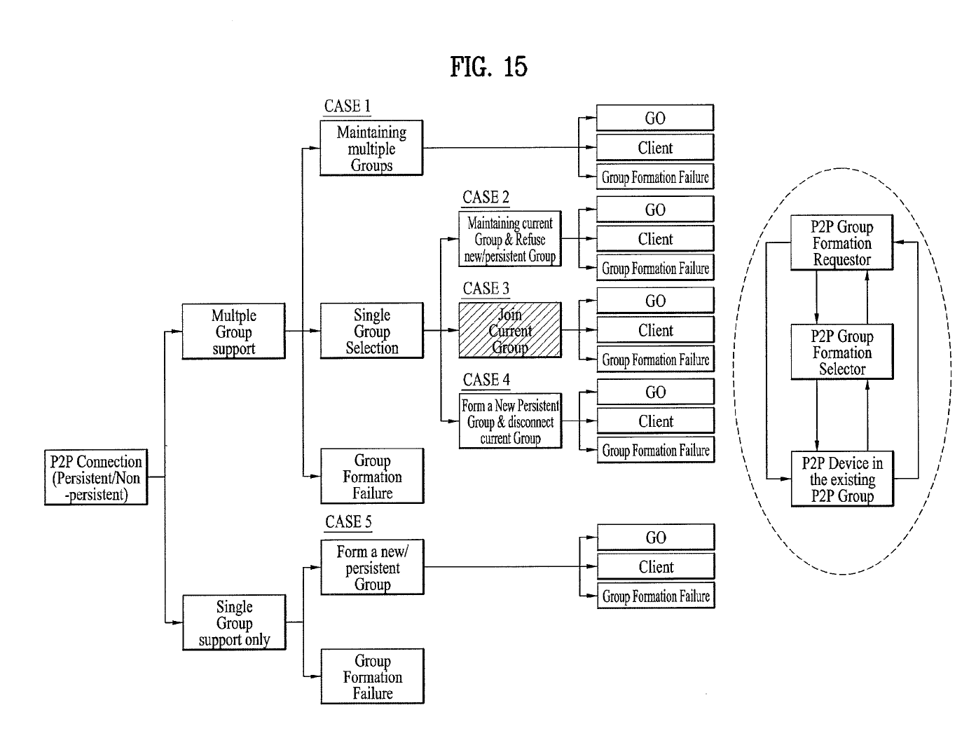

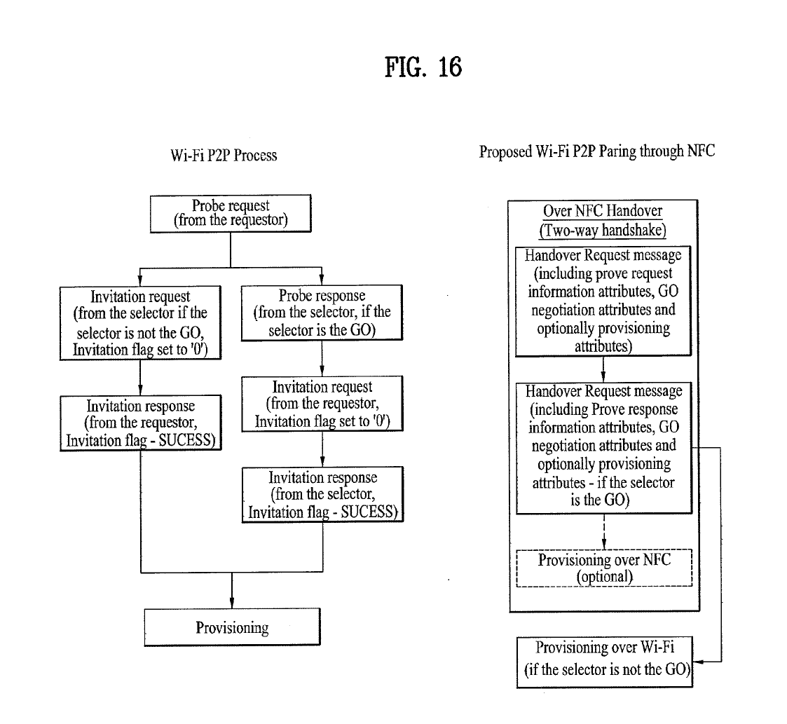

FIG. 15 and FIG. 16 are diagrams for one example of a process for setting up a connection between Wi-Fi P2P devices using NFC connection in Case 3.

FIG. 15 shows a case that, in case that a connection between Wi-Fi P2P devices is set up using NFC, a new requestor joins a group to which a peer device has belonged already. Hence, as shown in FIG. 15, while a selector of P2P Group formation maintains a connection to a P2P device of an existing P2P group, a requestor of different P2P group formation can join the existing P2P group in which a peer device is included.

FIG. 16 is a diagram of comparing the existing Wi-Fi P2P connection process (left part) in Case 2 shown in FIG. 15 to a Wi-Fi P2P connection process (right part) using NFC according to an embodiment of the present invention.

1) Wi-Fi P2P connection process in this case is described as follows.

Requestor outputs a probe request.

If Selector is not Group Owner and Invitation Flag is set to 0, Selector outputs Invitation Request.

If so, Requestor outputs Invitation Response having Invitation Flag set to SUCCESS.

If Selector is Group Owner, Selector output a probe response.

If so, Requestor outputs Invitation Request having Invitation Flag set to 1.

Selector outputs Invitation Request having Invitation Flag set to SUCCESS.

If so, Provisioning corresponding to P2P Group Formation phase is entered.

2) Meanwhile, Wi-Fi P2P connection process using NFC in Case 3 is described as follows.

Two-way handshake for NFC handover is performed.

Requestor outputs a handover request message. This handover request message may include probe request information attributes and Invitation Request attributes and may further include Provisioning attributes optionally.

If Selector is Group Owner, it outputs a handover select message. This handover select message may include probe response information attributes and Invitation Request attributes and may further include Provisioning attributes optionally.

Provisioning phase of NFC is entered. If Selector is not Group Owner, Provisioning phase of Wi-Fi is entered.

Likewise, according to Wi-Fi P2P connection process, for P2P connection setup in Case 3, maximum 4 Wi-Fi Management frames can be exchanged between Requestor and Selector before performing Provisioning. Yet, according to an embodiment of the present invention, if Two-way Connection Handover Message transaction through NFC is used, the connection process can efficiently proceed.

Moreover, Provisioning after P2P Group formation can proceed more schematically in case of Provisioning of NFC. In doing so, if Provisioning is performed through NFC, a per device of Requestor for initializing a connection setup corresponds to Group Owner of a previously configured Group. Otherwise, in order for a new client device to join Group, Provisioning through Wi-Fi Link is performed with Group Owner of the corresponding Group using PIN, PBC or the like.

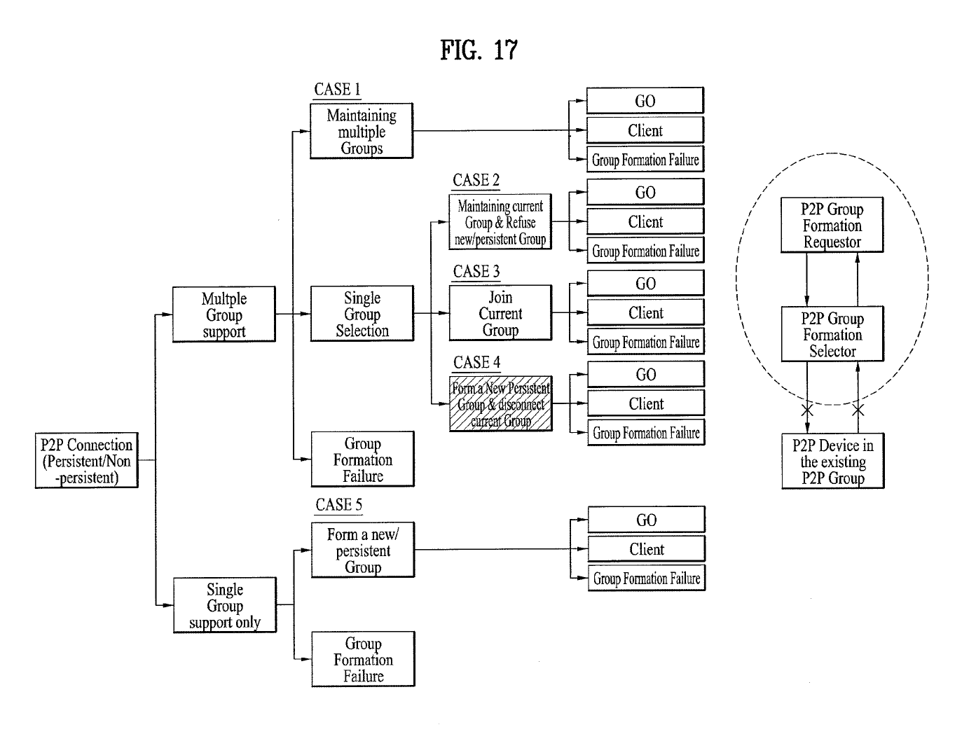

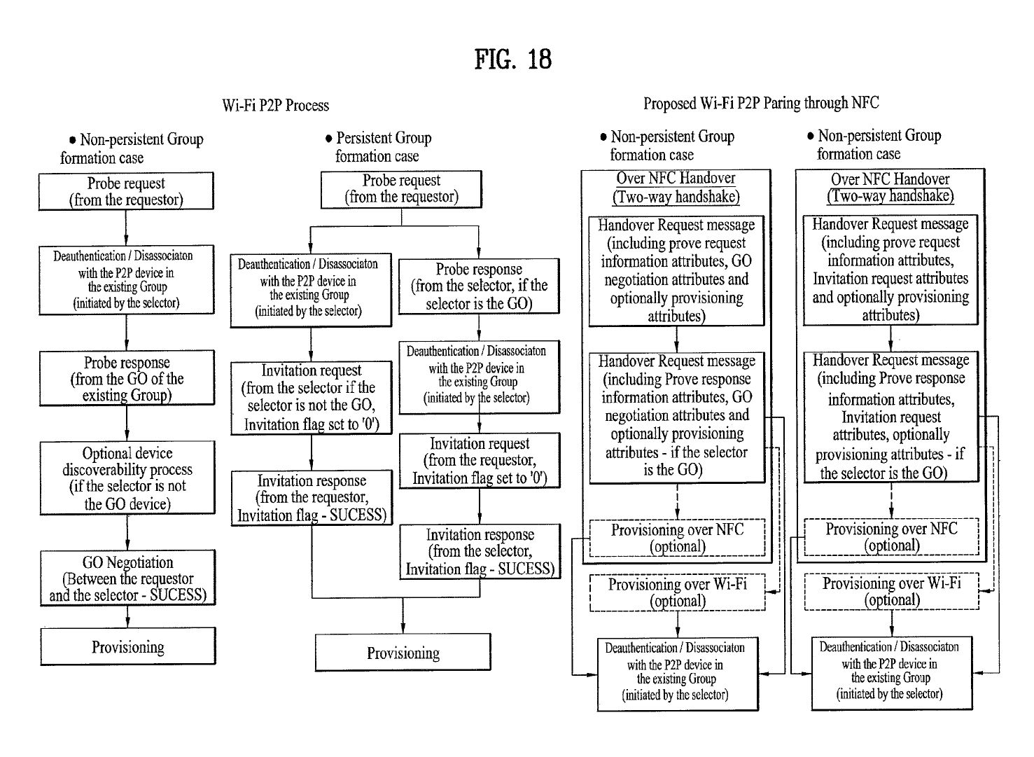

FIG. 17 and FIG. 18 are diagrams for one example of a process for setting up a connection between Wi-Fi P2P devices using NFC connection in Case 4.

Case 4 indicates a case that Peer Device of Requestor releases a connection from an existing P2P Group and forms a new Group with the Requestor. Hence, in the example shown in FIG. 17, P2P Group formation Selector terminates a connection to P2P device of an existing P2P Group and forms a new group by being connected to a different P2P Group Formation Requestor.

FIG. 18 is a diagram of comparing the existing Wi-Fi P2P connection process (left part) in Case 4 shown in FIG. 17 to a Wi-Fi P2P connection process (right part) using NFC according to an embodiment of the present invention.

In each connection process, a connection setup between Wi-Fi P2P Devices can be sorted into Invoke process for Persistent Group [denoted as Persistent Group formation case] and Group formation for Non-Persistent Group [denoted as Non-Persistent Group formation case].

1) In Persistent Group formation case, Wi-Fi P2P connection process is described as follows.

Requestor outputs a probe request.

If Selector is not Group Owner, Deauthentication or Diassociate frame for releasing a connection from P2P device forming an existing group is outputted.

If Selector is not Group Owner and Invitation Flag is set to 0, Selector outputs Invitation Request.

If so, Requestor outputs Invitation Response having Invitation Flag set to SUCCESS.

If Selector is Group Owner, it outputs a probe response.

If Selector is Group Owner, Deauthentication or Diassociate frame for releasing a connection from a P2P device forming an existing group is outputted.

If so, Requestor outputs Invitation Request having Invitation Flag set to 0.

Selector outputs Invitation Response having Invitation Flag set to SUCCESS.

If Requestor or Selector outputs Invitation Response having Invitation Flag set to SUCCESS, Provisioning is entered.

2) Meanwhile, in Persistent Group formation case, Wi-Fi P2P connection process using NFC is described as follows.

Two-way handshake for NFC handover is performed.

Requestor outputs a handover request message (This handover request message may include probe request information attributes and Invitation Request attributes and may further include Provisioning attributes optionally.).

Selector outputs a handover select message (This handover select message may include probe response information attributes and Invitation Request attributes and may further include Provisioning attributes optionally (if Selector is not Group Owner).).

After Selector has outputted the handover select message, Provisioning on NFC is entered. Alternatively, if Selector is not Group Owner, Provisioning on Wi-Fi is entered.

Selector outputs Deauthentication or Diassociate frame for releasing a connection from a P2P device forming an existing group.

3) In Non-Persistent Group formation case, an existing Wi-Fi P2P connection process is described as follows.

Requestor outputs a probe request.

Selector outputs Deauthentication or Diassociate frame for releasing a connection from a P2P device forming an existing group.

Group Owner of the existing group outputs a probe response.

If Selector is not Group owner device, the device can optionally perform Discoverability process.

If a group owner negotiation process between Requestor and new Selector is set to SUCCESS, Provisioning is entered.

4) On the other hand, in Non-Persistent Group formation case, Wi-Fi P2P connection process using NFC is described as follows.

Two-way handshake for NFC handover is performed.

Requestor outputs a handover request message (This handover request message may include probe request information attributes and Go negotiation attributes and may further include Provisioning attributes optionally.).

Selector outputs a handover select message (This handover select message may include probe response information attributes and Go negotiation attributes and may further include Provisioning attributes optionally (if Selector is Group Owner).).

After Selector has outputted the handover select message, Provisioning on NFC is entered. Alternatively, Provisioning on Wi-Fi is entered.

Selector outputs a handover select message, becomes Provisioning on NFC, or becomes Provisioning on Wi-Fi. And, Selector outputs Deauthentication or Diassociate frame for releasing a connection from a P2P device forming an existing group.

Likewise, according to Wi-Fi P2P connection process, for P2P connection setup in Case 4, maximum 4 Wi-Fi Management frames can be exchanged between Requestor and Selector before Provisioning. Yet, according to an embodiment of the present invention, if Two-way Connection Handover Message transaction through NFC is used, the connection process can efficiently proceed. Moreover, since Provisioning after Group formation can use Provisioning through NFC, a device connection setup process can be efficiently performed.

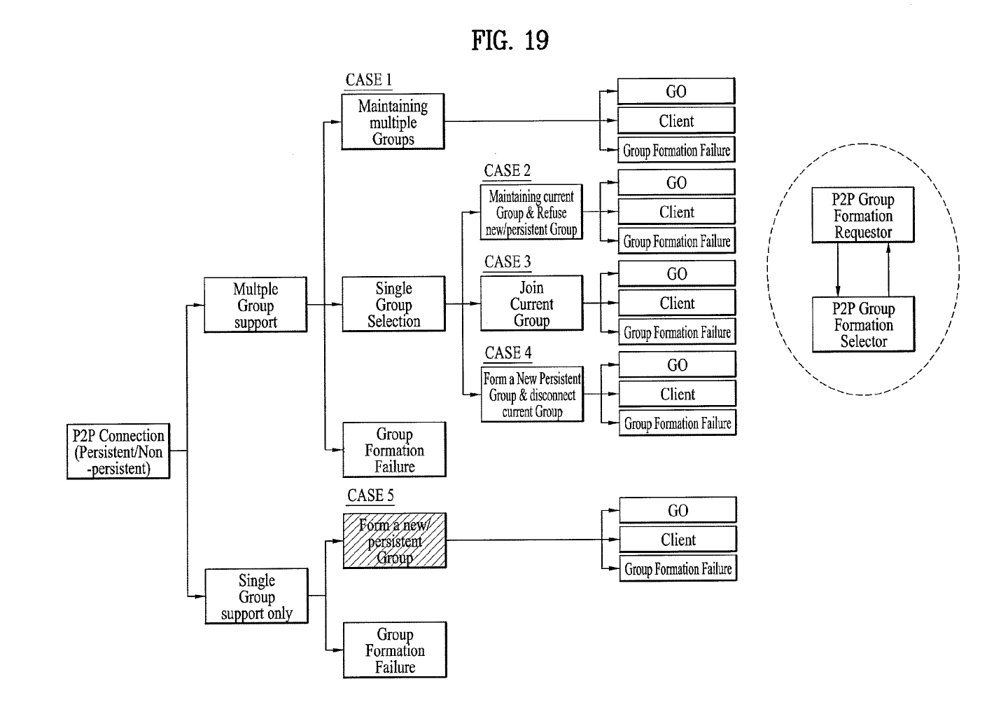

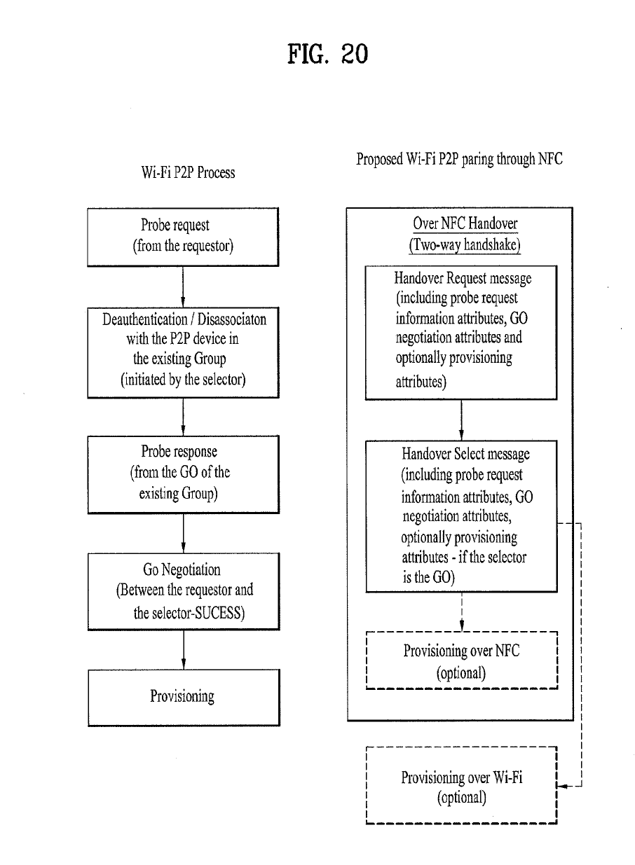

FIG. 19 and FIG. 20 are diagrams for one example of a process for setting up a connection between Wi-Fi P2P devices using NFC connection in Case 5.

Case 5 indicates a case that two devices not belonging to any Group in case of a setup of connection process between Wi-Fi P2P devices using NFC for a new Group.

FIG. 20 is a diagram of comparing the existing Wi-Fi P2P connection process (left part) in Case 5 shown in FIG. 19 to a Wi-Fi P2P connection process (right part) using NFC according to an embodiment of the present invention.

1) Wi-Fi P2P connection process is described as follows.

Requestor outputs a probe request.

A group owner of a previous group outputs a probe response.

Group Owner negotiation between Requestor and Selector is performed. If a corresponding result is SUCCESS, Provisioning is entered.

2) On the other hand, Wi-Fi P2P connection process using NFC is described as follows.

Two-way handshake for NFC handover is performed.

Requestor outputs a handover request message. This handover request message may include probe request information attributes and Invitation Request attributes and may further include Provisioning attributes optionally.

Selector outputs a handover select message. This handover select message may include probe response information attributes and GO negotiation attributes and may further include Provisioning attributes optionally (if Selector is Group Owner).

After Selector has outputted the handover select message, Provisioning on NFC or Provisioning on Wi-Fi is entered.

Therefore, according to Wi-Fi P2P connection process, for P2P connection setup in Case 5, maximum 4 Wi-Fi Management frames can be exchanged between Requestor and Selector before Provisioning. Yet, according to an embodiment of the present invention, using Two-way Connection Handover Message transaction through NFC, the connection process can efficiently performed. Moreover, since Provisioning process accompanied after Group formation can use Provisioning through NFC, it is efficient. In Case 5, according to the Wi-Fi P2P connection process, each device needs to spend a waiting time in listen/search state on social channel. Yet, according to an embodiment of the present invention. Since Connection Handover using NFC is used, whereby the unnecessary waiting time can be removed as well.

In the following description, a structure of P2P group request or response(select) message and a process exchanging the message between devices according to an embodiment of the present invention are explained.

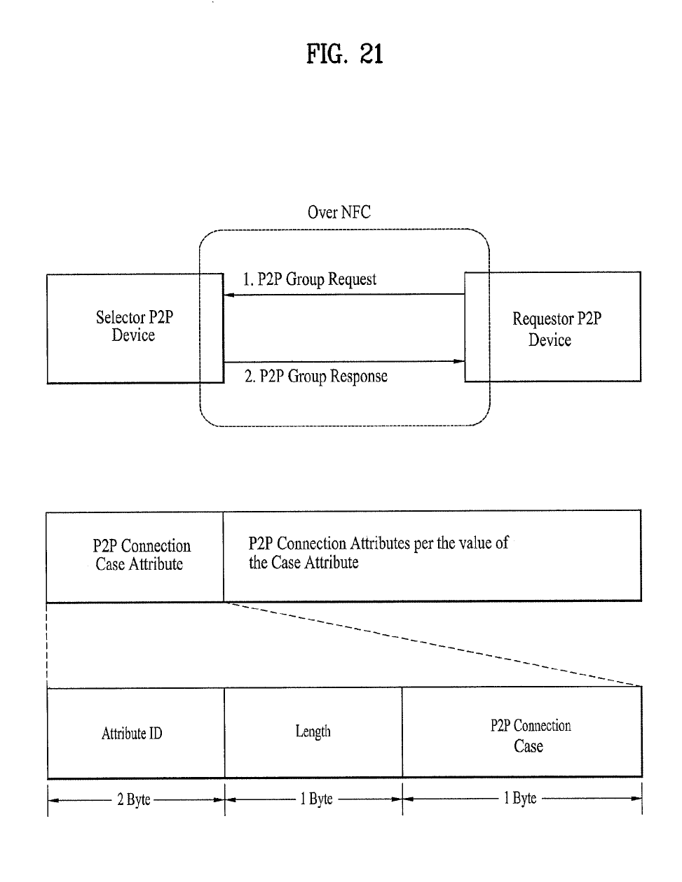

FIG. 21 is a diagram for one example of transceiving messages initiated using NFC.

Requestor P2P device can send P2P group request message to Selector P2P device.

Selector P2P device can send P2P group response message to Requestor P2P device.

Like Connection Handover message defined by NFC, P2P Group Request/Response message can be exchanged in form of two-way handshake.

Each of P2P group request message and P2P group response message can include P2P connection case attribute field and P2P connection attribute field in accordance with a value of each P2P connection case attribute.

P2P connection case attribute field includes attribute ID field for identifying a corresponding attribute, length field indicating a field length thereafter, and P2P connection case field indicating whether P2P Group Request/Response message corresponds to which one of P2P device connection setup cases.

The attribute ID field may become a message type for defining a request message or a response message.

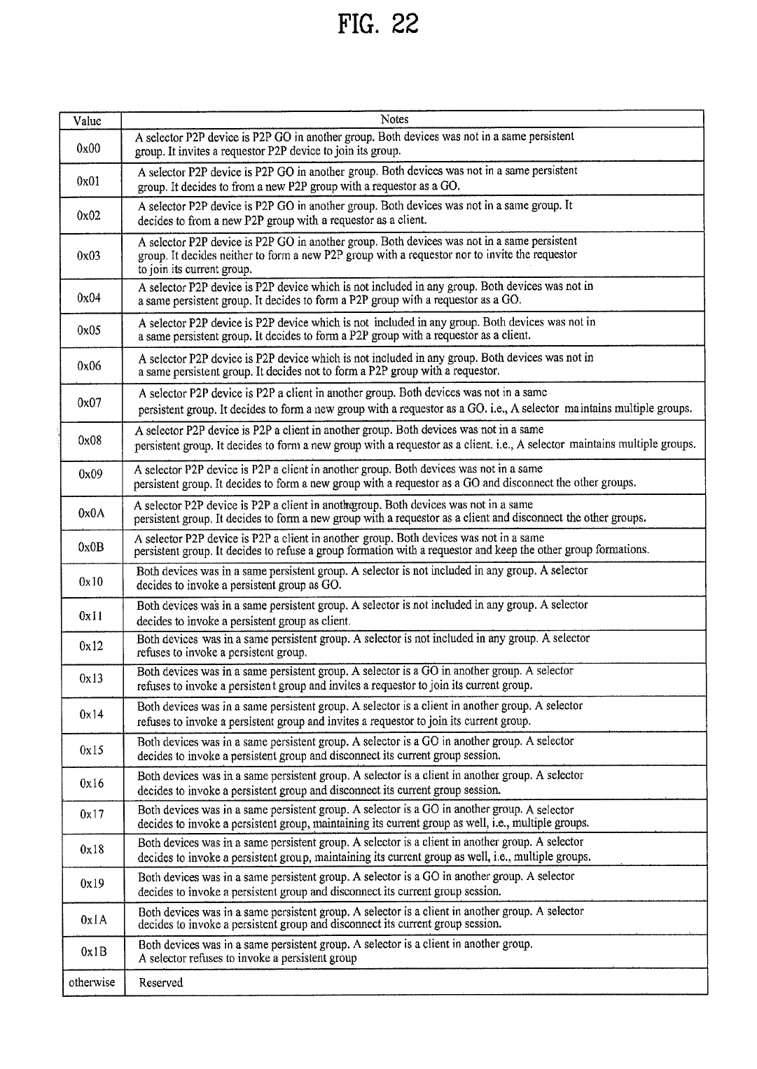

FIG. 22 is a diagram for one example of a P2P connection case field value included in a P2P connection case attribute field of a P2P Group Request/Response message exchanged over NFC and a description of the corresponding field value. The P2P connection case field can indicate that each P2P connection proceeds in which case.

If a P2P connection case field value is set to 0x00, it indicates a case that a Selector P2P device is a P2P Group Owner (GO) in another group, that both devices are not in a same persistent group, and that the Selector P2P device invites a Requestor P2P device to join its group. (A Selector P2P device is P2P GO in another group. Both devices was not in a same persistent group. It invites a Requestor P2P device to join its group.)

If a P2P connection case field value is set to 0x01, it indicates a case that a Selector P2P device is a P2P Group Owner in another group, that both devices are not in a same persistent group, and that the selector P2P device decides to form a new P2P group with a Requestor as a Group Owner. (A Selector P2P device is P2P GO in another group. Both devices was not in a same persistent group. It decides to from a new P2P group with a Requestor as a GO.)

If a P2P connection case field value is set to 0x02, it indicates a case that a Selector P2P device is P2P Group Owner in another group, that both devices are not in a same group, and that the Selector P2P device decides to from a new P2P group with a Requestor as a client. (A Selector P2P device is P2P GO in another group. Both devices was not in a same group. It decides to from a new P2P group with a Requestor as a client.)

If a P2P connection case field value is set to 0x03, it indicates a case that a Selector P2P device is P2P Group Owner in another group, that both devices are not in a same persistent group, and that the Selector P2P device decides neither to form a new P2P group with a Requestor nor to invite the Requestor to join its current group. (A Selector P2P device is P2P GO in another group. Both devices was not in a same persistent group. It decides neither to form a new P2P group with a Requestor nor to invite the Requestor to join its current group.)

If a P2P connection case field value is set to 0x04, it indicates a case that a Selector P2P device is P2P device which is not included in any group, that both devices are not in a same persistent group, and that the Selector P2P device decides to form a P2P group with a Requestor as a Group Owner. (A Selector P2P device is P2P device which is not included in any group. Both devices was not in a same persistent group. It decides to form a P2P group with a Requestor as a GO.)

If a P2P connection case field value is set to 0x05, it indicates a case that a Selector P2P device is P2P device which is not included in any group, that both devices are not in a same persistent group, and that the Selector P2P device decides to form a new P2P group with a Requestor as a client. (A Selector P2P device is P2P device which is not included in any group. Both devices was not in a same persistent group. It decides to form a P2P group with a Requestor as a client.)

If a P2P connection case field value is set to 0x06, it indicates a case that a Selector P2P device is P2P device which is not included in any group, that both devices are not in a same persistent group, and that the Selector P2P device decides not to form a P2P group with a Requestor. (A Selector P2P device is P2P device which is not included in any group. Both devices was not in a same persistent group. It decides not to form a P2P group with a Requestor.)

If a P2P connection case field value is set to 0x07, it indicates a case that a Selector P2P device is P2P a client in another group, that both devices are not in a same persistent group, and that the Selector P2P device decides to form a new group with a Requestor as a Group Owner. In particular, this case describes a case that the Selector maintains multiple groups. (A Selector P2P device is P2P a client in another group. Both devices was not in a same persistent group. It decides to form a new group with a Requestor as a GO. i.e., A Selector maintains multiple groups.)

If a P2P connection case field value is set to 0x08, it indicates a case that a Selector P2P device is P2P a client in another group, that both devices are not in a same persistent group, and that the Selector P2P device decides to form a new group with a Requestor as a client. In particular, this case describes a case that the Selector maintains multiple groups. (A Selector P2P device is P2P a client in another group. Both devices was not in a same persistent group. It decides to form a new group with a Requestor as a client. i.e., A Selector maintains multiple groups.)

If a P2P connection case field value is set to 0x09, it indicates a case that a Selector P2P device is P2P a client in another group, that both devices are not in a same persistent group, and that the Selector P2P device decides to form a new group with a Requestor as a Group Owner and disconnects other groups. (A Selector P2P device is P2P a client in another group. Both devices was not in a same persistent group. It decides to form a new group with a Requestor as a GO and disconnect the other groups.)

If a P2P connection case field value is set to 0x0A, it indicates a case that a Selector P2P device is P2P a client in another group, that both devices are not in a same persistent group, and that the Selector P2P device decides to form a new group with a Requestor as a client and disconnects other groups. (A Selector P2P device is P2P a client in another group. Both devices was not in a same persistent group. It decides to form a new group with a Requestor as a client and disconnect the other groups.)

If a P2P connection case field value is set to 0x0B, it indicates a case that a Selector P2P device is P2P a client in another group, that both devices are not in a same persistent group, and that the Selector P2P device decides to refuse a group formation with a Requestor and keeps other group formations. (A Selector P2P device is P2P a client in another group. Both devices was not in a same persistent group. It decides to refuse a group formation with a Requestor and keep the other group formations.)

If a P2P connection case field value is set to 0x10, it indicates a case that both devices are in a same persistent group, that a Selector is not included in any group, and that the Selector decides to invoke a persistent group as a Group Owner. (Both devices was in a same persistent group. A Selector is not included in any group. A Selector decides to invoke a persistent group as GO.)

If a P2P connection case field value is set to 0x11, it indicates a case that both devices are in a same persistent group, that a Selector is not included in any group, and that the Selector decides to invoke a persistent group as a client. (Both devices was in a same persistent group. A Selector is not included in any group. A Selector decides to invoke a persistent group as client.)

If a P2P connection case field value is set to 0x12, it indicates a case that both devices are in a same persistent group, that a Selector is not included in any group, and that the Selector refuses to invoke a persistent group. (Both devices was in a same persistent group. A Selector is not included in any group. A Selector refuses to invoke a persistent group.)

If a P2P connection case field value is set to 0x13, it indicates a case that both devices are in a same persistent group, that a Selector is a Group Owner in another group, and that the Selector refuses to invoke a persistent group and invites a Requestor to join its current group. (Both devices was in a same persistent group. A Selector is a GO in another group. A Selector refuses to invoke a persistent group and invites a Requestor to join its current group.)

If a P2P connection case field value is set to 0x14, it indicates a case that both devices are in a same persistent group, that a Selector is a client in another group, and that the Selector refuses to invoke a persistent group and invites a Requestor to join its current group. (Both devices was in a same persistent group. A Selector is a client in another group. A Selector refuses to invoke a persistent group and invites a Requestor to join its current group.)

If a P2P connection case field value is set to 0x15, it indicates a case that both devices are in a same persistent group, that a Selector is a Group Owner in another group, and that the Selector decides to invoke a persistent group and disconnect its current group session. (Both devices was in a same persistent group. A Selector is a GO in another group. A Selector decides to invoke a persistent group and disconnect its current group session.)

If a P2P connection case field value is set to 0x16, it indicates a case that both devices are in a same persistent group, that a Selector is a client in another group, and that the Selector decides to invoke a persistent group and disconnects its current group session. (Both devices was in a same persistent group. A Selector is a client in another group. A Selector decides to invoke a persistent group and disconnects its current group session.)

If a P2P connection case field value is set to 0x17, it indicates a case that both devices are in a same persistent group, that a Selector is a Group Owner in another group, and that the Selector decides to invoke a persistent group while maintaining its current group as well. (Both devices was in a same persistent group. A Selector is a GO in another group. A Selector decides to invoke a persistent group, maintaining its current group as well, i.e., multiple groups.)

If a P2P connection case field value is set to 0x18, it indicates a case that both devices are in a same persistent group, that a Selector is a client in another group, and that the Selector decides to invoke a persistent group while maintaining its current group as well. (Both devices was in a same persistent group. A Selector is a client in another group. A Selector decides to invoke a persistent group, maintaining its current group as well, i.e., multiple groups.)

If a P2P connection case field value is set to 0x19, it indicates a case that both devices are in a same persistent group, that a Selector is a Group Owner in another group, and that the Selector decides to invoke a persistent group and disconnects its current group session. (Both devices was in a same persistent group. A Selector is a GO in another group. A Selector decides to invoke a persistent group and disconnect its current group session.)

If a P2P connection case field value is set to 0x1A, it indicates a case that both devices are in a same persistent group, that a Selector is a client in another group, and that the Selector decides to invoke a persistent group and disconnects its current group session. (Both devices was in a same persistent group. A Selector is a client in another group. A Selector decides to invoke a persistent group and disconnect its current group session.)

If a P2P connection case field value is set to 0x1B, it indicates a case that both devices are in a same persistent group, that a Selector is a client in another group, and that the Selector refuses to invoke a persistent group. (Both devices was in a same persistent group. A Selector is a client in another group. A Selector refuses to invoke a persistent group.)

Otherwise, the rest of P2P connection case field values are set as reserved regions.

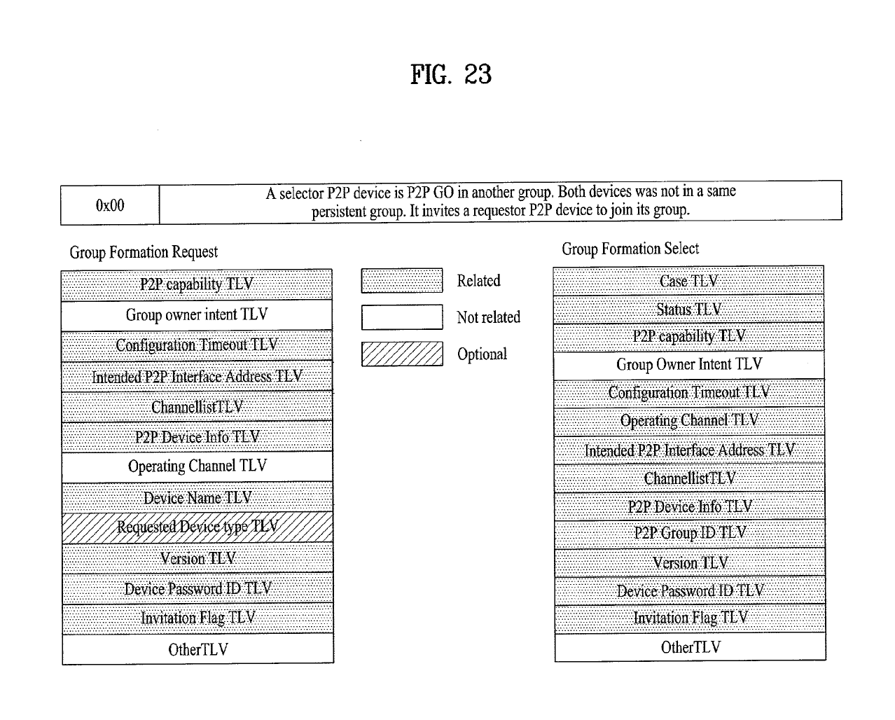

FIGS. 23 to 60 show examples of P2P connection attributes contained in P2P Group Request/Response (Select) message changing in accordance with a value of a P2P connection case field in P2P Group Case Attribute contained in P2P Group Request/Response message. In this case, if an MSB value of the P2P connection case field corresponds to 0x00˜0x0B or 0x1A˜0x1B, it may indicate whether devices intending to form a P2P Group belong to the same Persistent Group.

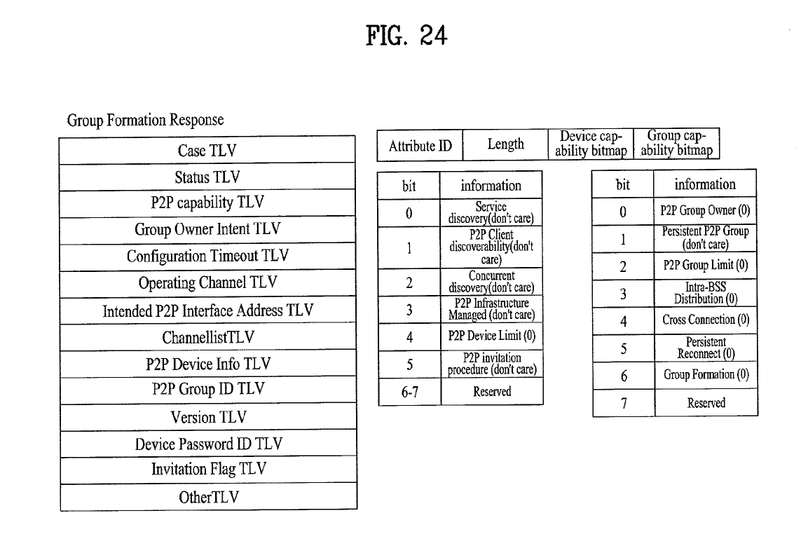

FIG. 23 and FIG. 24 are diagrams for one example of information included in a P2P Group Formation Request/Response message if a value of a P2P connection case field is set to 0x00 and one example of indicating whether the corresponding information is related to a case that the value of the P2P connection case field is set to 0x00.

As mentioned in the foregoing description, if a value of a P2P connection case field is 0x00, it indicates a case that a Selector P2P device is a P2P Group Owner in another group, that both devices are not in the same persistent group, and that the Selector P2P device invites a Requestor P2P device to join its group.

Referring to FIG. 23, a P2P Group Formation Request message may contain type length values (TLV) including P2P Capability TLV, Group Owner Intent TLV, Configuration Timeout TLV, Intended P2P Interface Address TLV, Channel List TLV, P2P Device Info TLV, Operating Channel TLV, Device Name TLV, Requested Device type TLV, Version TLV, Device Password ID TLV, Invitation Flags TLV and the like.

The P2P Capability TLV indicates a set of parameters used to establish a P2P connection.

The Group Owner Intent TLV includes an intent value for intending to become a P2P group owner of a P2P device.

The Configuration Timeout TLV is a value that indicates a time taken for a P2P device to change a current mode of operation into a P2P Group Owner mode or a P2P Client mode.

The Intended P2P Interface Address TLV is a value that indicates information on a P2P interface device intended to use by a P2P device in a P2P group.

The Channel List TLV is a value that includes a list and channel pair information of an Operating Class.

The P2P Device Info TLV is a value that indicates information on a P2P device.

The Operating Channel TLV is a value that indicates operating channel and operating class information.

The Device Name TLV is a value that indicates a device name.

The Requested Device type TLV is a value that indicates a value for a requested device defined in a probe request frame transmitted by a P2P device.

The Version TLV indicates a version value. And, the Device Password ID TLV is a value for a password identifier of a device.

The Invitation Flags TLV indicates flags used in a P2P invitation process.

Meanwhile, the P2P Group Formation Select (Response) message shown in the example may include type length values (TLV) including Case TLV, Status TLV, P2P Capability TLV, Group Owner Intent TLV, Configuration Timeout TLV, Operating Channel TLV, Intended P2P Interface Address TLV, Channel List TLV, P2P Device Info TLV, P2P Group ID TLV, Version TLV, Device Password ID TLV, Invitation Flags TLV and the like.

The Case TLV may indicate a value of the P2P connection case field shown in the above example.

The Status TLV indicates status information of a message in a request-response transaction of the P2P Group Formation Request/Select (Response) message.

P2P Capability TLV, Group Owner Intent TLV, Configuration Timeout TLV, Operating Channel TLV, Intended P2P Interface Address TLV, Channel List TLV, P2P Device Info TLV, Version TLV, Device Password ID TLV, and Invitation Flags TLV can refer to the same of the former description.

The P2P Group ID TLV is a value used to indicate an identifier of a specific P2P group.

In FIG. 23, whether each TLV contained in the P2P Group Formation Request/Select (Response) message is related to a value of the P2P connection case field, not related thereto, or optional is illustrated.

For instance, if a value of the P2P connection case field is set to 0x00, P2P Capability TLV, Configuration Timeout TLV, Intended P2P Interface Address TLV, Channel List TLV, P2P Device Info TLV, Device Name TLV, Version TLV, Device Password ID TLV, and Invitation Flags TLV can have related values in the P2P Group Formation Request message, respectively.

If a value of the P2P connection case field is set to 0x00, the Group Owner Intent TLV and the Operating Channel may include information unrelated to the value of the P2P connection case field in the P2P Group Formation Request message.

If a value of the P2P connection case field is set to 0x00, the Requested Device type TLV is the value optionally related to the value of the P2P connection case field in the P2P Group Formation Request message.

Meanwhile, if a value of the P2P connection case field is set to 0x00, the TLV shown in the above example may have information related to the value of the P2P connection case field in the P2P Group Formation Select message.

FIG. 24 is a diagram for one example of P2P Capability TLV among TLVs related to a P2P Group Formation Request/Select (Response) message if a value of a P2P connection case field is set to 0x00.

The P2P Capability TLV may include an attribute ID field for identifying a type of P2P attribute, a length field indicating a following field, a Device Capability Bitmap field and a Group Capability Bitmap field.

The Device Capability Bitmap field includes a parameter indicating Capability of a P2P Device. According to the example, Service Discovery information indicates whether the P2P device supports Service Discovery. And, P2P Client Discoverability information indicates whether the P2P device is capable of performing P2P Client Discoverability.

Concurrent Operation information indicates whether a P2P device supports Concurrent Operation. P2P Infrastructure Managed information indicates whether a P2P interface of a P2P device can be handled by WLAN (Wireless Local Area Network). P2P Device Limit information indicates whether a P2P device can additionally join a P2P group. P2P Invitation Procedure information indicates whether P2P invitation procedure signaling can be processes.

The Group Capability Bitmap field may include a parameter indicating a current status of a P2P Group. The Group Capability Bitmap field may include a P2P Group Owner information indicating whether a P2P device can operate as a Group Owner and a Persistent P2P Group information indicating whether a P2P device hosts or intends to host a Persistent P2P Group.

The Group Capability Bitmap field may additionally include a P2P Group Limit information indicating whether a P2P Group Owner can add an additional client to its P2P group, an Intra-BSS Distribution information indicating whether a P2P device provides a data distribution service between clients within its group, and a Cross Connection information indicating whether a P2P device intends to host a P2P group that provides a cross connection between P2P group and WLAN.

The Group Capability Bitmap field may additionally include a Persistent Reconnect information indicating whether a P2P device hosts a Persistent P2P group capable of reconnection with user intervention and a Group Formation information indicating whether a P2P device operates as a Group Owner in a Provisioning phase of group formation.

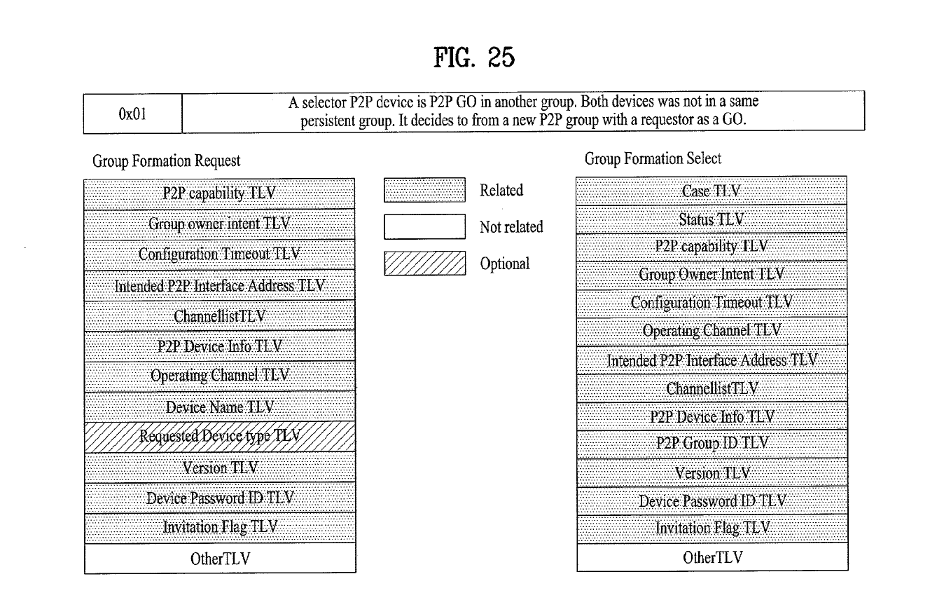

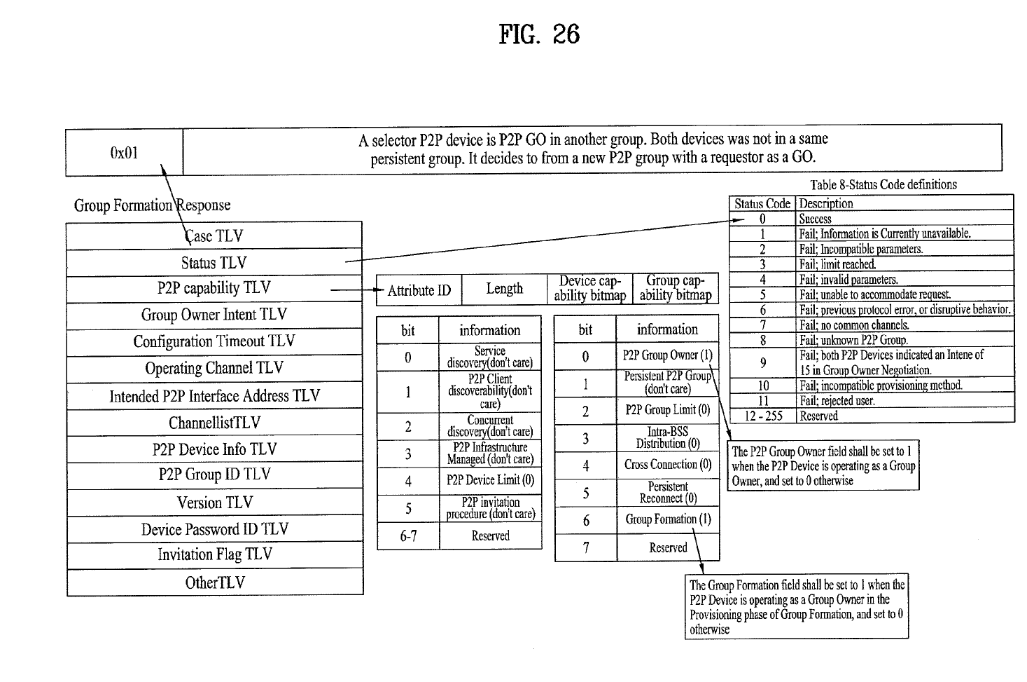

FIG. 25 and FIG. 26 are diagrams for one example of information included in a P2P Group Formation Request/Response message if a value of a P2P connection case field is set to 0x00 and one example of indicating whether the corresponding information is related to a case that the value of the P2P connection case field is set to 0x01.

As mentioned in the foregoing description, if a value of a P2P connection case field is 0x01, it indicates a case that a Selector P2P device is a P2P Group Owner in another group, that both devices are not in a same persistent group, and that the selector P2P device decides to form a new P2P group with a Requestor as a Group Owner.

Referring to FIG. 25, for example, if a value of the P2P connection case field is set to 0x01, P2P Capability TLV, Configuration Timeout TLV, Intended P2P Interface Address TLV, Channel List TLV, P2P Device Info TLV, Device Name TLV, Version TLV, Device Password ID TLV, and Invitation Flags TLV in the P2P Group Formation Request message may have information related to the value of the P2P connection case field.

If the value of the P2P connection case field is 0x01, Requested Device type TLV may or may not have a related information, optionally.

FIG. 25 is a diagram for one example of a P2P Group Formation Response message if a value of a P2P connection case field is set to 0x01.

For instance, Case TLV may include a value corresponding to the above-mentioned 0x01

Status TLV may include a status information of a response message. And, P2P Capability TLV may include the above-described information.

According to the example shown in this drawing, a P2P Group Owner information of the Group Capability Bitmap field is set to 1 if a P2P device is able to operate as a Group Owner. Otherwise, the P2P Group Owner information of the Group Capability Bitmap field is set to 0.

For example, a Group Formation information of the Group Capability Bitmap field is set to 1 if a P2P device operates as a Group Owner in a Provisioning phase of group formation. Otherwise, the Group Formation information of the Group Capability Bitmap field is set to 0.

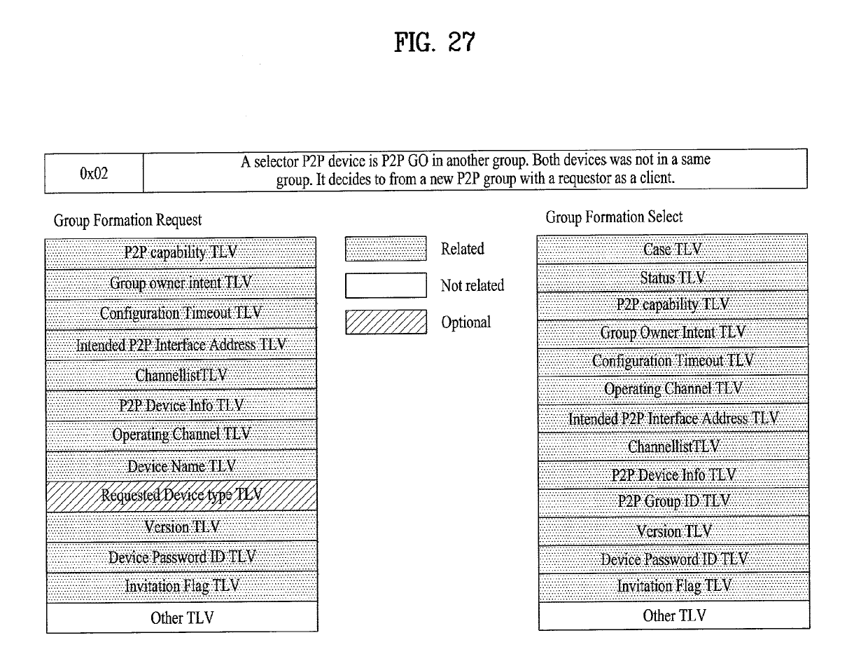

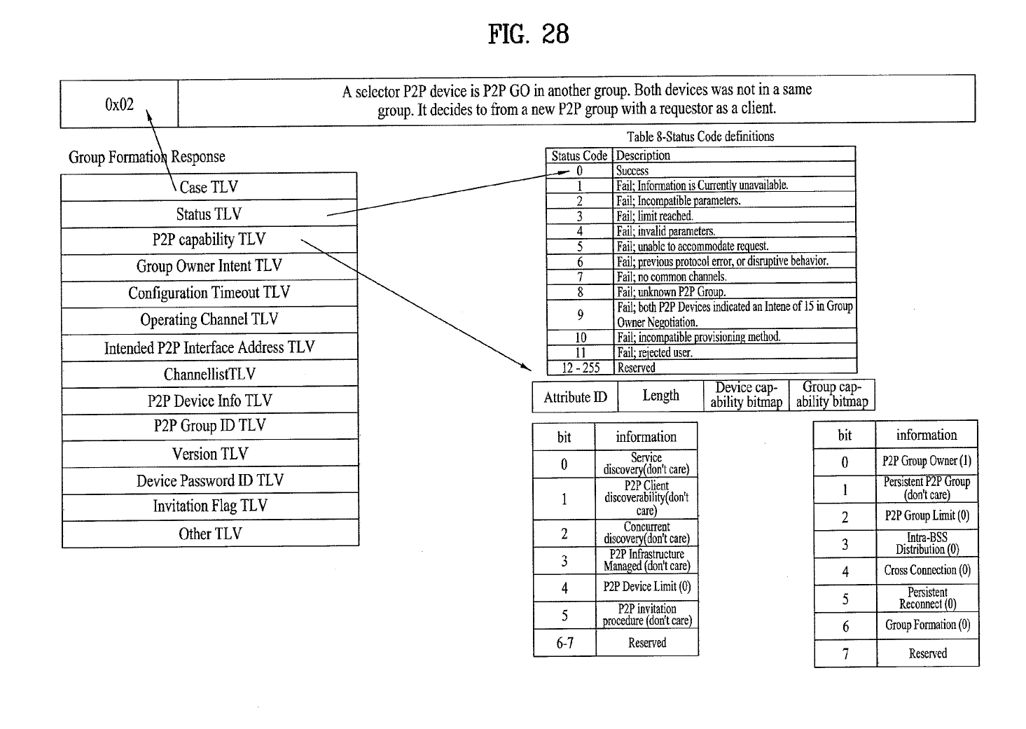

FIG. 27 and FIG. 28 are diagrams for one example of information included in a P2P Group Formation Request/Response message if a value of a P2P connection case field is set to 0x02 and one example of indicating whether the corresponding information is related to a case that the value of the P2P connection case field is set to 0x02. If the value of the P2P connection case field is set to 0x02, it indicates a case that a Selector P2P device is P2P Group Owner in another group, that both devices are not in a same group, and that the Selector P2P device decides to from a new P2P group with a Requestor as a client.

In FIG. 27, whether each TLV included in the P2P Group Formation Request/Select (Response) message is related to, unrelated (not related) to, optional for the value of the P2P connection case field is illustrated.

For instance, if a value of the P2P connection case field is set to 0x02, P2P Capability TLV, Group Owner Intent TLV, Configuration Timeout TLV, Intended P2P Interface Address TLV, Channel List TLV, P2P Device Info TLV, Operating Channel TLV, Device Name TLV, Version TLV, Device Password ID TLV, and Invitation Flags TLV in the P2P Group Formation Request message can have related informations.

If a value of the P2P connection case field is set to 0x02, the Requested Device type TL in the P2P Group Formation Request message may or may not have the information related to the value of the P2P connection case field optionally.

Meanwhile, if a value of the P2P connection case field is set to 0x02, the above-mentioned TLV in the P2P Group Formation Select message may have the information related to the value of the P2P connection case field.

FIG. 28 is a diagram for one example of a P2P Group Formation Response message if a value of a P2P connection case field is set to 0x02.

For instance, the Case TLV may have the value corresponding to the above 0x02.

The Status TLV may include a status information of a response message.

And, as mentioned in the foregoing description, the P2P Capability TLV may be set to P2P Capability information if the value of the P2P connection case field is 0x02.

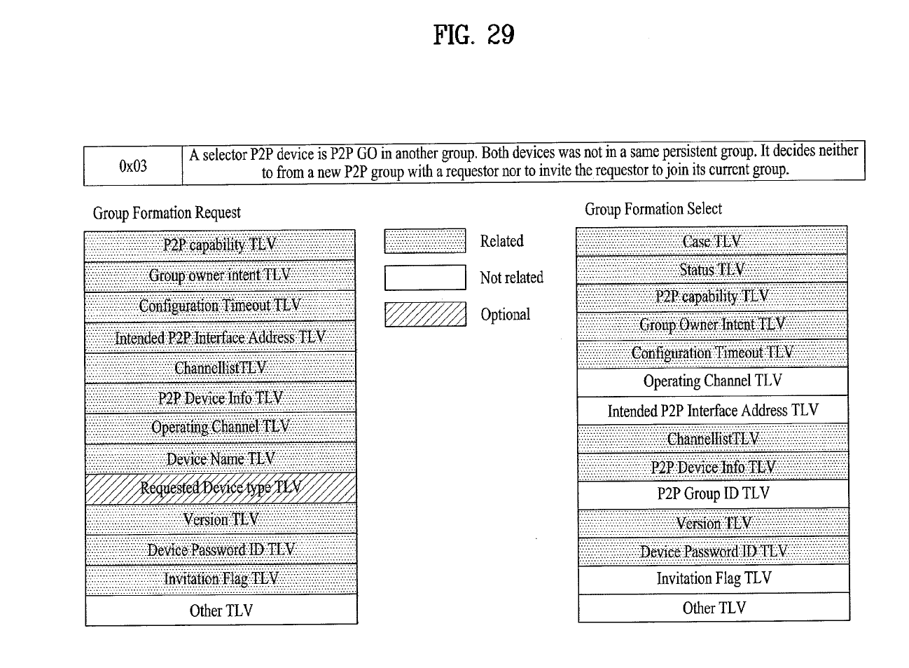

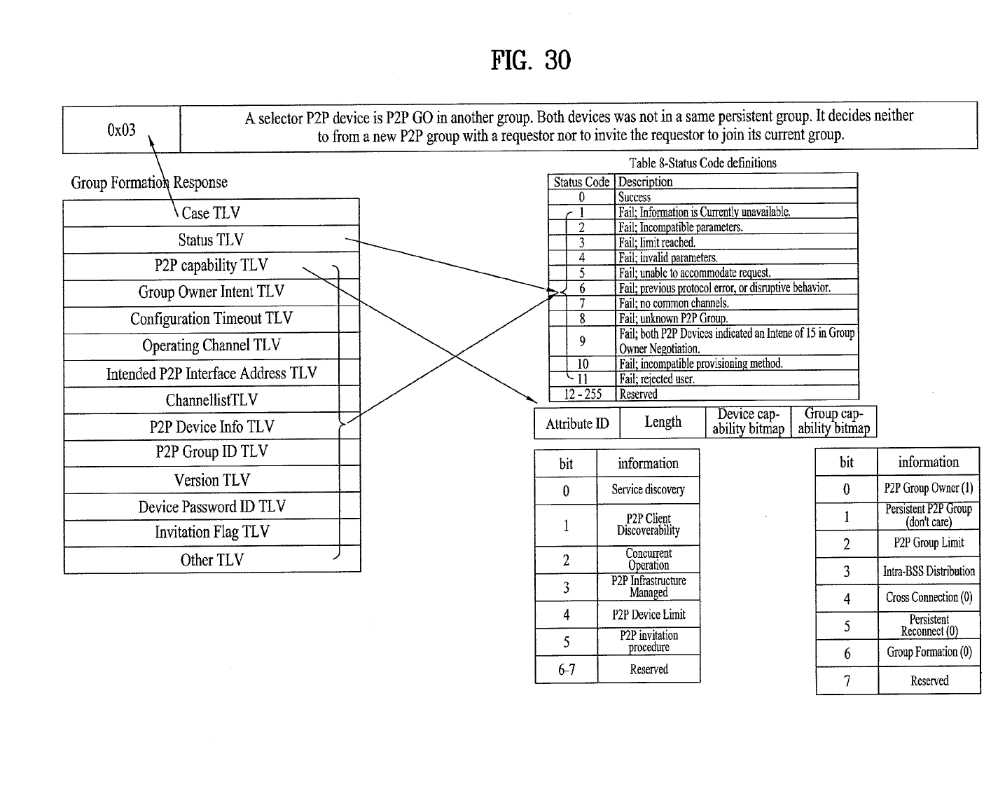

FIG. 29 and FIG. 30 are diagrams for one example of information included in a P2P Group Formation Request/Response message if a value of a P2P connection case field is set to 0x03 and one example of indicating whether the corresponding information is related to a case that the value of the P2P connection case field is set to 0x03. If the value of the P2P connection case field is set to 0x03, it indicates a case that a Selector P2P device is P2P Group Owner in another group, that both devices are not in a same persistent group, and that the Selector P2P device decides neither to form a new P2P group with a Requestor nor to invite the Requestor to join its current group.

As mentioned in the foregoing description of the former example, the P2P Group Formation Request message may contain such a type length value (TLV) as P2P Capability TLV, Group Owner Intent TLV, Configuration Timeout TLV, Intended P2P Interface Address TLV, Channel List TLV, P2P Device Info TLV, Operating Channel TLV, Device Name TLV, Requested Device type TLV, Version TLV, Device Password ID TLV, Invitation Flags TLV, and the like.

And, the P2P Group Formation Select (Response) message may include such a type length value (TLV) as Case TLV, Status TLV, P2P Capability TLV, Group Owner Intent TLV, Configuration Timeout TLV, Operating Channel TLV, Intended P2P Interface Address TLV, Channel List TLV, P2P Device Info TLV, P2P Group ID TLV, Version TLV, Device Password ID TLV, Invitation Flags TLV and the like.

In this case, relationship between each TLV and a case that a value of the P2P connection case field is 0x03 is described as follows.

For instance, if a value of the P2P connection case field is set to 0x03, P2P Capability TLV, Group Owner Intent TLV, Configuration Timeout TLV, Intended P2P Interface Address TLV, Channel List TLV, P2P Device Info TLV, Operating Channel TLV, Device Name TLV, Version TLV, Device Password ID TLV and Invitation Flags TLV in the P2P Group Formation Request message may have related values.

If a value of the P2P connection case field is set to 0x03, Requested Device type TLV in the P2P Group Formation Request message may or may not have information related to the value of the P2P connection case field optionally.

Meanwhile, if a value of the P2P connection case field is set to 0x03, Case TLV, Status TLV, P2P Capability TLV, Group Owner Intent TLV, Configuration Timeout TLV, Channel List TLV, P2P Device Info TLV, Version TLV and Device Password ID TLV in the P2P Group Formation Select message may have informations related to the value (0x03) of the P2P connection case field.

And, in this embodiment, the rest of the TLVs (Operating Channel TLV, Intended P2P Interface Address TLV, P2P Group ID TLV, Invitation Flags TLV, etc.) do not have information related to the value)0x03) of the P2P connection case field.

FIG. 30 is a diagram for one example of a P2P Group Formation Response message if a value of a P2P connection case field is set to 0x03.

For instance, Case TLV may include a value corresponding to the above-mentioned 0x03.

Status TLV may include a status information of a response message.

If a value of the P2P connection case field is set to 0x03, since it indicates a case that the Selector P2P device decides neither to form a new P2P group with a Requestor nor to invite the Requestor to join its current group, a status value of the Status TLV may include one of statuses indicating ‘Fail’. And, information or value of the rest TLV included in the P2P Group Formation Response message may be determined depending on a corresponding status value of the Status TLV.

Meanwhile, since P2P Capability TLV can be described in a manner similar to that of the former description, its details shall be omitted from the following description.

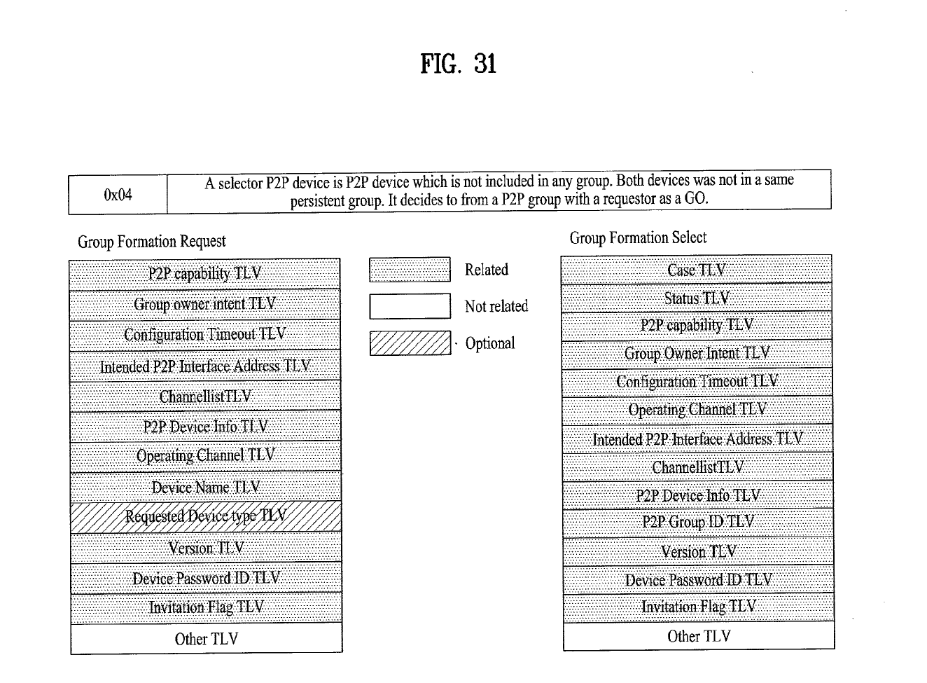

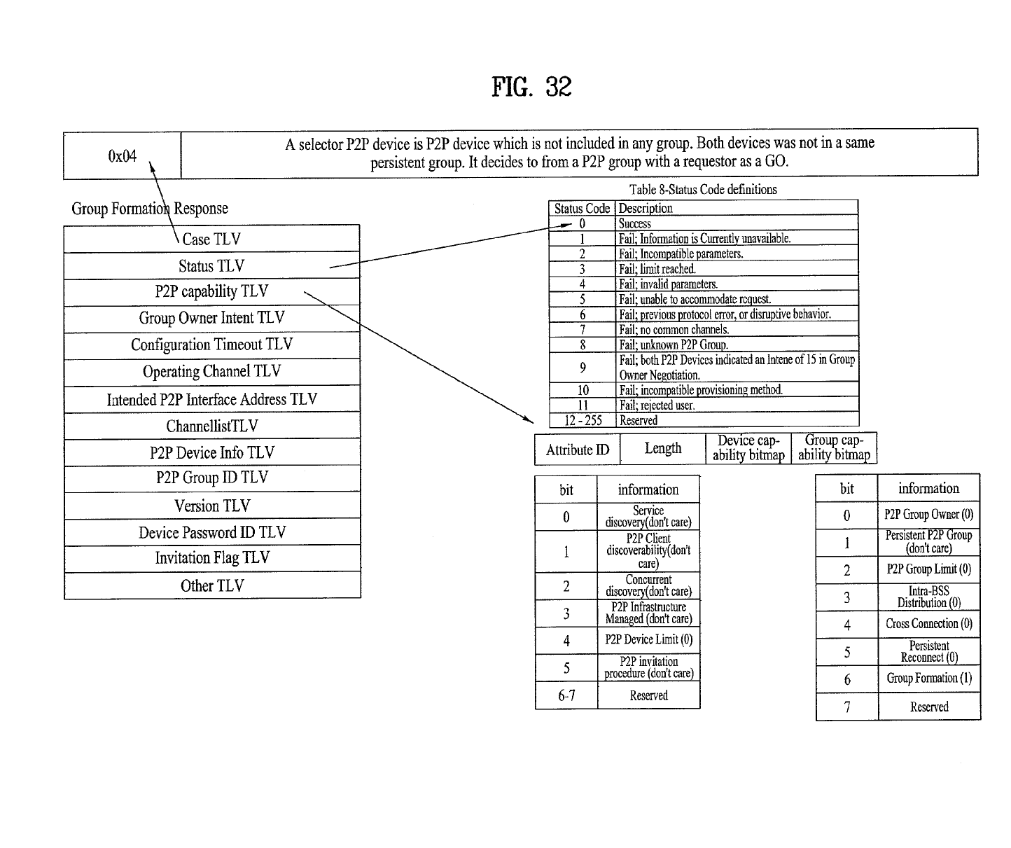

FIG. 31 and FIG. 32 are diagrams for one example of information included in a P2P Group Formation Request/Response message if a value of a P2P connection case field is set to 0x04 and one example of indicating whether the corresponding information is related to a case that the value of the P2P connection case field is set to 0x04. If the value of the P2P connection case field is set to 0x04, it indicates a case that a Selector P2P device is P2P device which is not included in any group, that both devices are not in a same persistent group, and that the Selector P2P device decides to form a P2P group with a Requestor as a Group Owner.

Relationship between TLV included in a P2P Group Formation Request/Response message and a case that a value of a P2P connection case field is set to 0x04 is described as follows.

If a value of the P2P connection case field is set to 0x04, Capability TLV, Group Owner Intent TLV, Configuration Timeout TLV, Intended P2P Interface Address TLV, Channel List TLV, P2P Device Info TLV, Operating Channel TLV, Device Name TLV, Version TLV, Device Password ID TLV and Invitation Flags TLV in a P2P Group Formation Request message may include informations related to the case that the value of the P2P connection case field is set to 0x04.

Meanwhile, Requested Device type TLV may optionally include information related to the case that the value of the P2P connection case field is set to 0x04.

If the value of the P2P connection case field is set to 0x04, Case TLV, Status TLV, P2P Capability TLV, Group Owner Intent TLV, Configuration Timeout TLV, Operating Channel TLV, Intended P2P Interface Address TLV, Channel List TLV, P2P Device Info TLV, P2P Group ID TLV, Version TLV, Device Password ID TLV and Invitation Flags TLV included in a P2P Group Formation Select message may have values related to the case that the value of the P2P connection case field is set to 0x04.

FIG. 32 is a diagram for one example of a P2P Group Formation Response message if a value of the P2P connection case field is set to 0x04.

For instance, Case TLV may include a value corresponding to the above-mentioned 0x04.

Status TLV may include a status information of a response message.

And, P2P Capability TLV may include information mentioned in the foregoing description.

Device capability bitmap field and Group Capability Bitmap field may have values each of which reflects the case that the value of the P2P connection case field is set to 0x04.

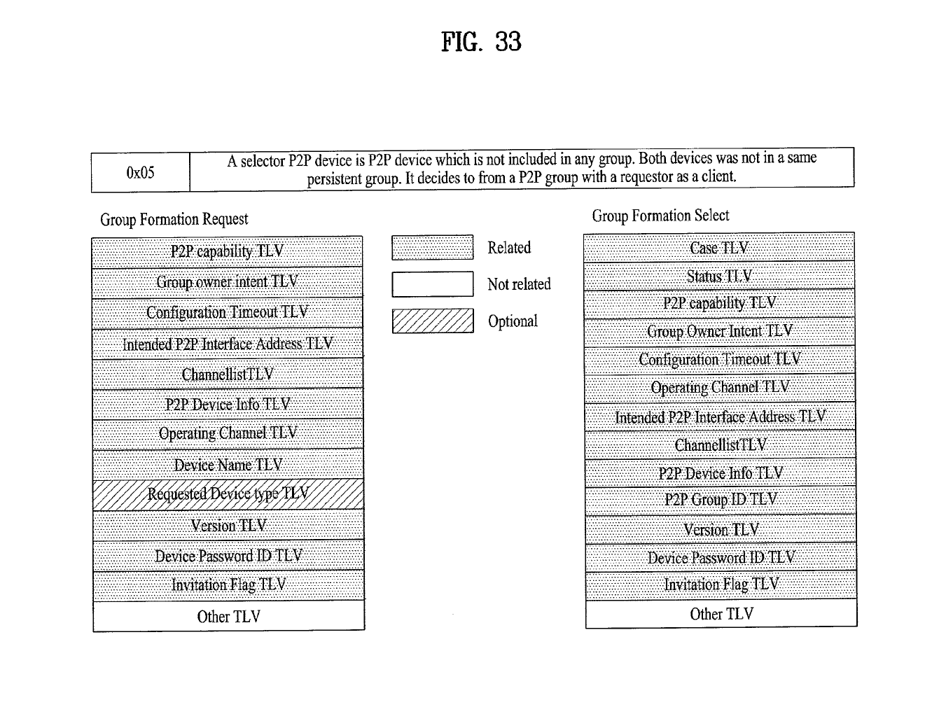

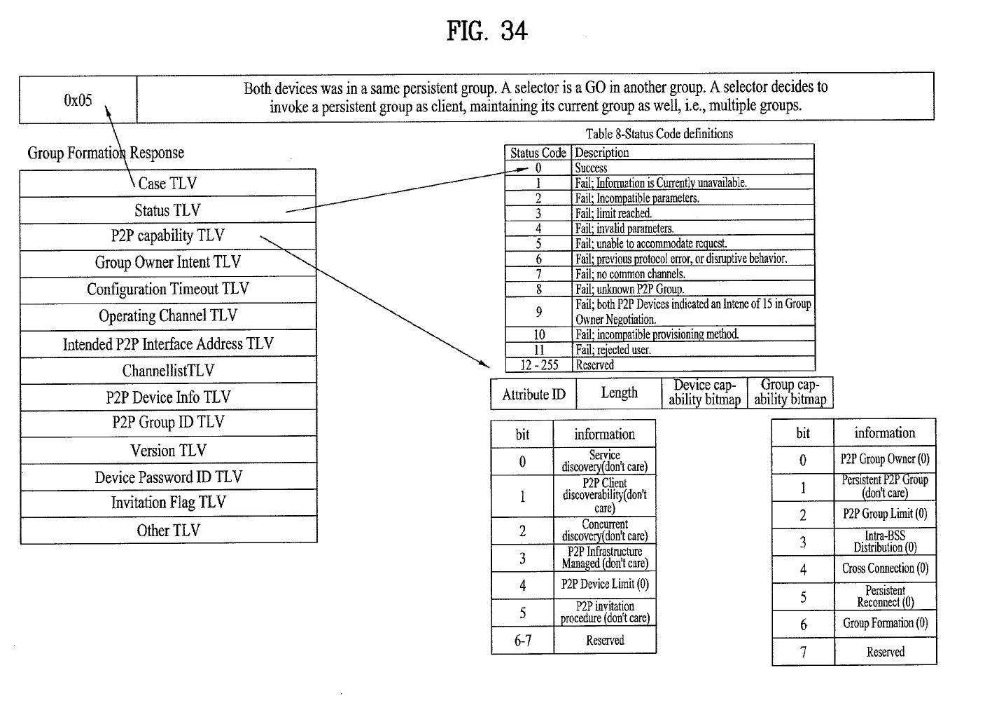

FIG. 33 and FIG. 34 are diagrams for one example of information included in a P2P Group Formation Request/Response message if a value of a P2P connection case field is set to 0x05 and one example of indicating whether the corresponding information is related to a case that the value of the P2P connection case field is set to 0x05. If the value of the P2P connection case field is set to 0x05, it indicates a case that a Selector P2P device is P2P device which is not included in any group, that both devices are not in a same persistent group, and that the Selector P2P device decides to form a new P2P group with a Requestor as a client.

If a value of the P2P connection case field is set to 0x05, P2P Capability TLV, Group Owner Intent TLV, Configuration Timeout TLV, Intended P2P Interface Address TLV, Channel List TLV, P2P Device Info TLV, Operating Channel TLV, Device Name TLV, Version TLV, Device Password ID TLV and Invitation Flags TLV in a P2P Group Formation Request message may include related informations.

If a value of the P2P connection case field is set to 0x05, Requested Device type TLV in a P2P Group Formation Request message may or may not have information related to the value of the P2P connection case field optionally.

If a value of the P2P connection case field is set to 0x05, TLV included in a P2P Group Formation Select message may have information related to the value of the P2P connection case field optionally.

FIG. 34 is a diagram for one example of a P2P Group Formation Response message if a value of the P2P connection case field is set to 0x05.

For instance, Case TLV may include a value corresponding to the above-mentioned 0x05.

Status TLV may include a status information of a Group Formation response message. And, as mentioned in the foregoing description, P2P Capability TLV may include information in accordance with the case that the value of the P2P connection case field is set to 0x05.

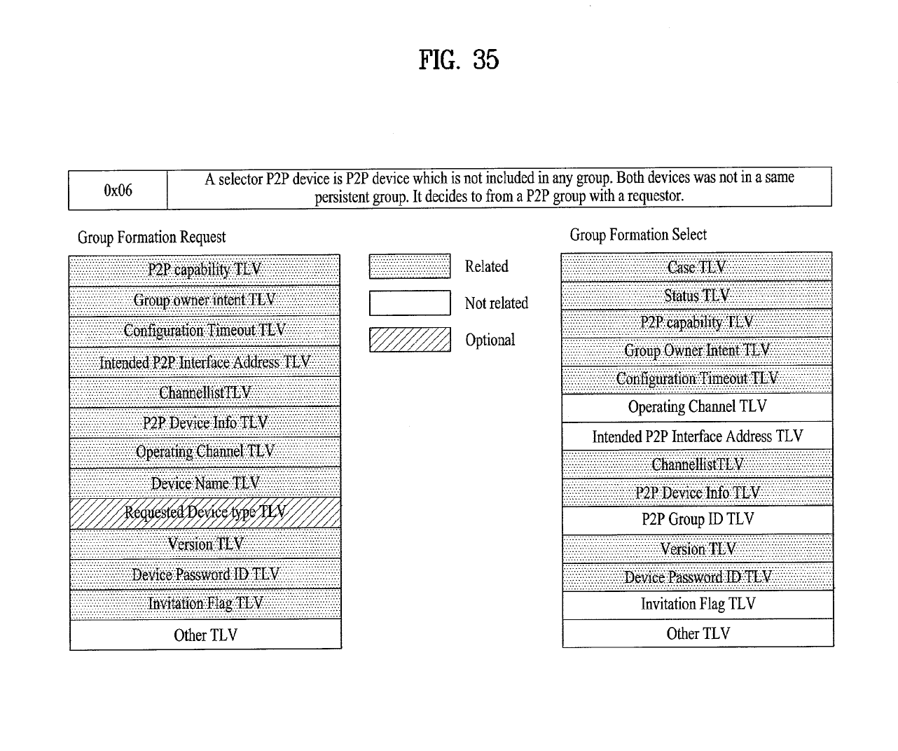

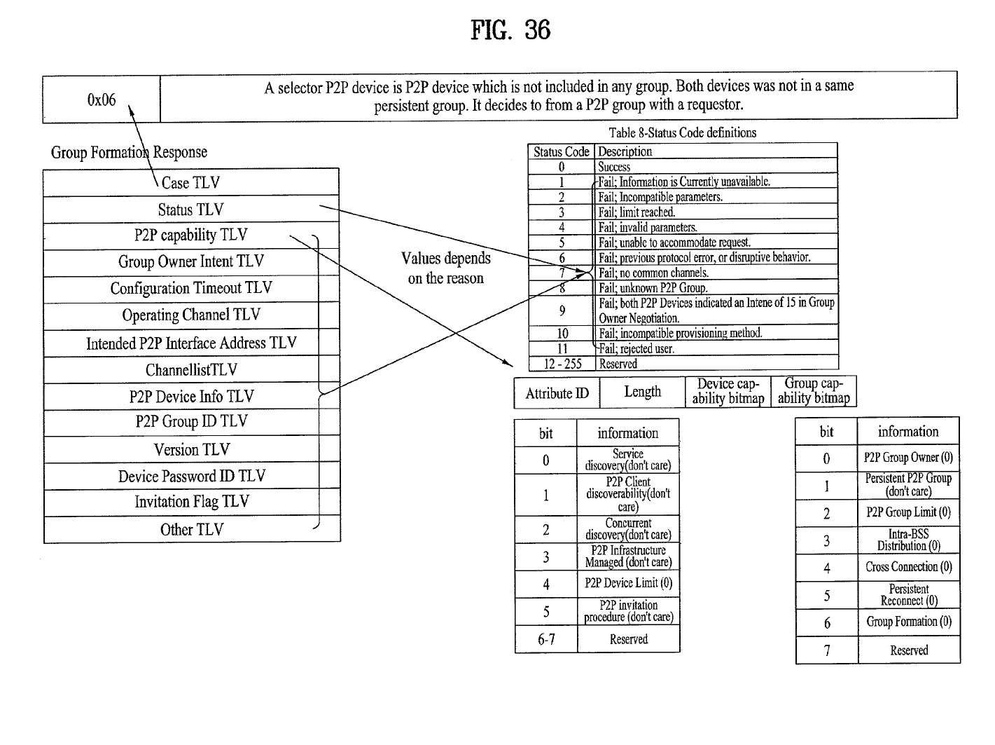

FIG. 35 and FIG. 36 are diagrams for one example of information included in a P2P Group Formation Request/Response message if a value of a P2P connection case field is set to 0x06 and one example of indicating whether the corresponding information is related to a case that the value of the P2P connection case field is set to 0x06. If the value of the P2P connection case field is set to 0x06, it indicates a case that a Selector P2P device is P2P device which is not included in any group, that both devices are not in a same persistent group, and that the Selector P2P device decides not to form a new P2P group with a Requestor.

Whether each TLV contained in the P2P Group Formation Request/Select message is related to a case that a value of the P2P connection case field is 0x06, not related thereto, or optional is illustrated in this drawing.

Hence, FIG. 36 is a diagram for one example of a TLV value of a P2P Group Formation Response message if a value of the P2P connection case field is set to 0x06.

For instance, Case TLV may include a value corresponding to the above-mentioned 0x06. Status TLV may include a status information of a Group Formation response message. In this case, as shown in the drawing, a Selector P2P device decides not to form a new P2P group with a Requestor, it is set to one of FAILS.

And, P2P Capability TLV may be set to information in accordance with a Group Formation response.

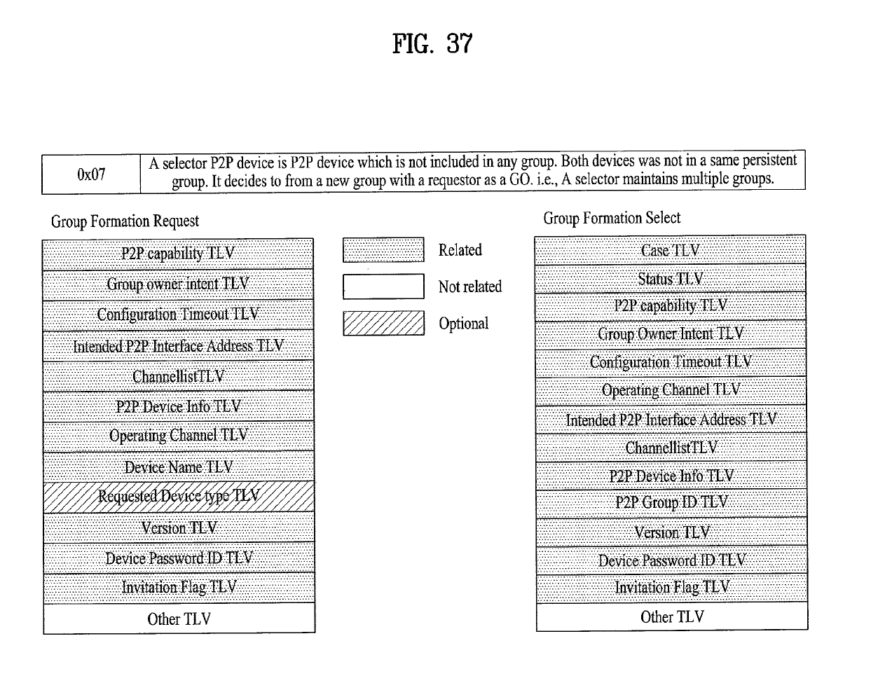

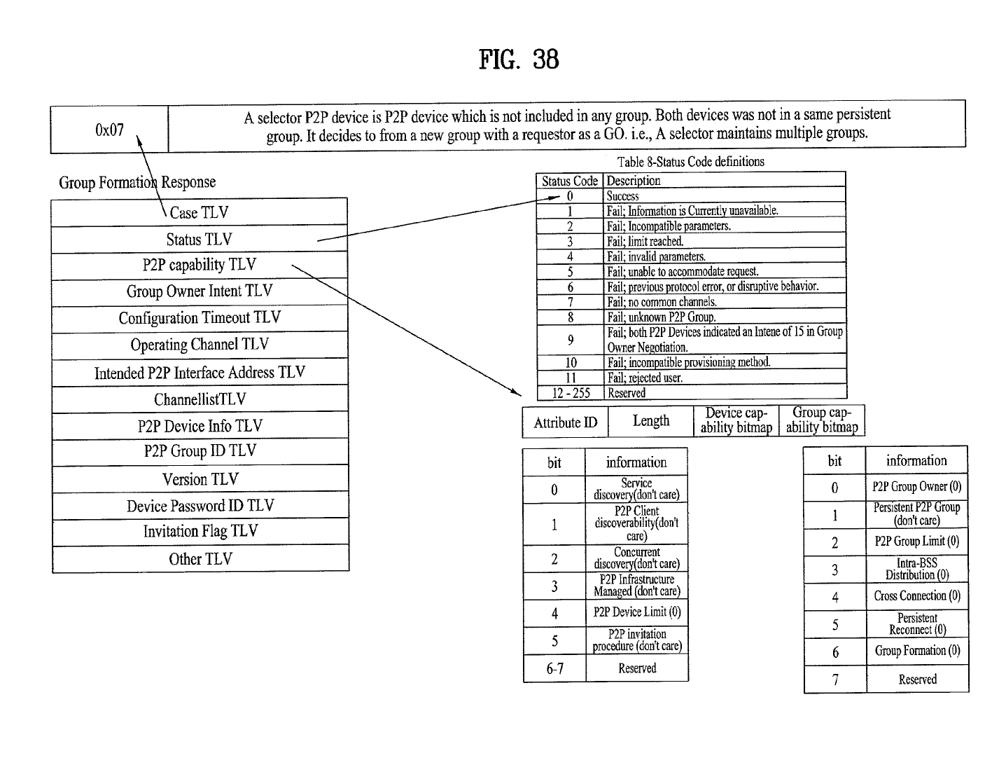

FIG. 37 and FIG. 38 are diagrams for one example of information included in a P2P Group Formation Request/Response message if a value of a P2P connection case field is set to 0x07 and one example of indicating whether the corresponding information is related to a case that the value of the P2P connection case field is set to 0x07. If the value of the P2P connection case field is set to 0x07, it indicates a case that a Selector P2P device is P2P a client in another group, that both devices are not in a same persistent group, and that the Selector P2P device decides to form a new group with a Requestor as a Group Owner. In particular, this case describes a case that the Selector maintains multiple groups.

Whether each TLV contained in the P2P Group Formation Request/Select message is related to a case that a value of the P2P connection case field is 0x07, not related thereto, or optional is illustrated in this drawing.

FIG. 37 is a diagram for one example of a TLV value of a P2P Group Formation Response message if a value of the P2P connection case field is set to 0x07.

For instance, Case TLV may include a value corresponding to the above-mentioned 0x07.

Status TLV may include a state indicating SUCCESS as a status information of a Group Formation response message. And, P2P Capability TLV may include an appropriate P2P Capability information in accordance with the value 0x07 of the P2P connection case field.

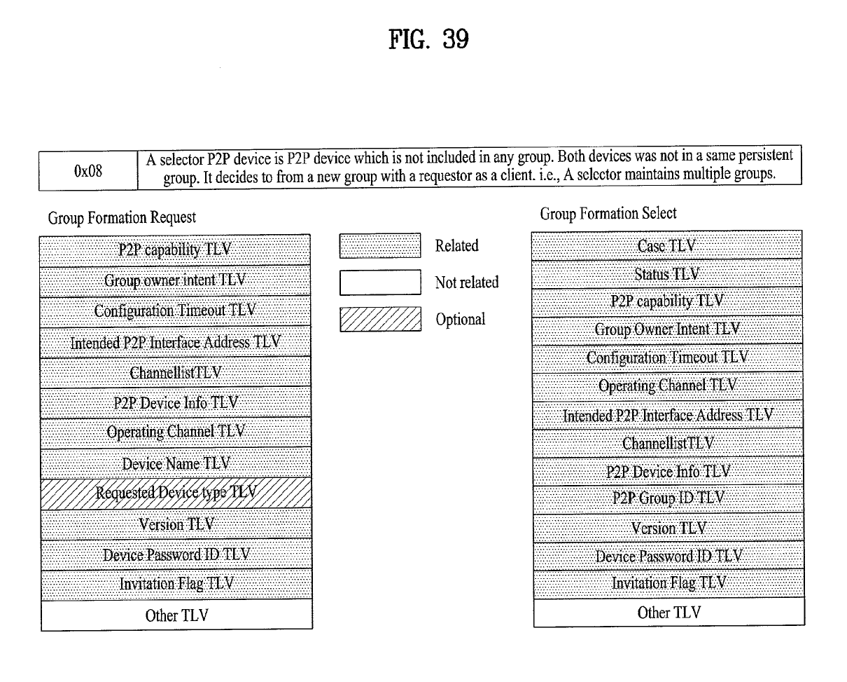

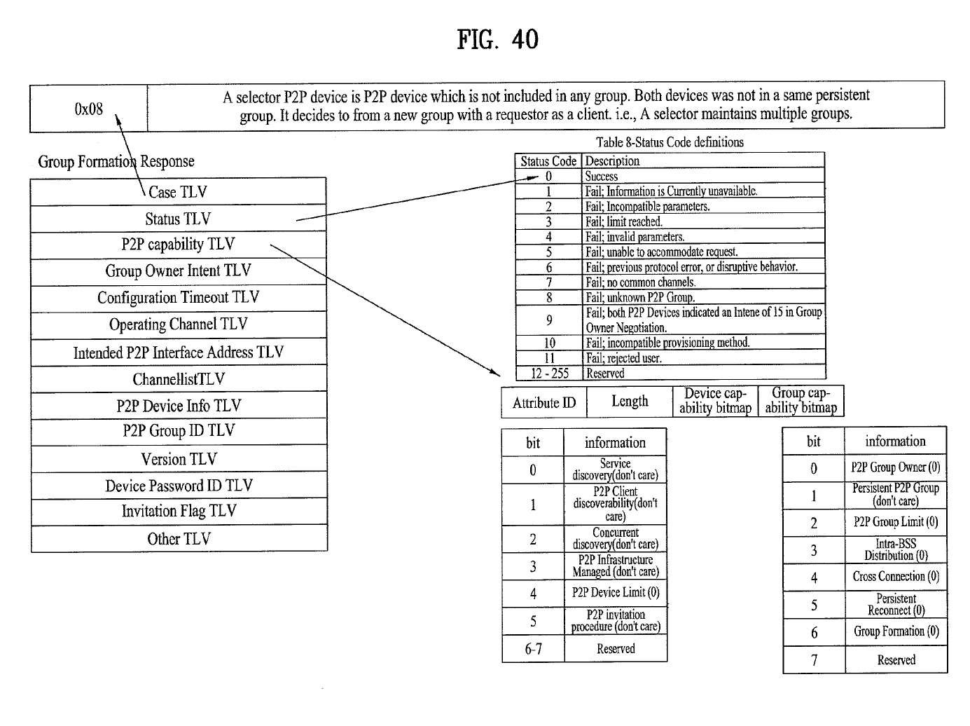

FIG. 39 and FIG. 40 are diagrams for one example of information included in a P2P Group Formation Request/Response message if a value of a P2P connection case field is set to 0x08 and one example of indicating whether the corresponding information is related to a case that the value of the P2P connection case field is set to 0x08. If the value of the P2P connection case field is set to 0x08, it indicates a case that a Selector P2P device is P2P a client in another group, that both devices are not in a same persistent group, and that the Selector P2P device decides to form a new group with a Requestor as a client. In particular, this case describes a case that the Selector maintains multiple groups.

In FIG. 39, whether each TLV contained in the P2P Group Formation Request/Select message is related to a case that a value of the P2P connection case field is 0x08, not related thereto, or optional is illustrated.

FIG. 40 is a diagram for one example of a TLV value of a P2P Group Formation Response message if a value of the P2P connection case field is set to 0x08.

For instance, Case TLV may include a value corresponding to the above-mentioned 0x08.

Status TLV may include a state indicating SUCCESS as a status information of a Group Formation response message. And, P2P Capability TLV may include information corresponding to SUCCESS. And, the P2P Capability TLV may include an appropriate P2P Capability information in accordance with the value 0x08 of the P2P connection case field.

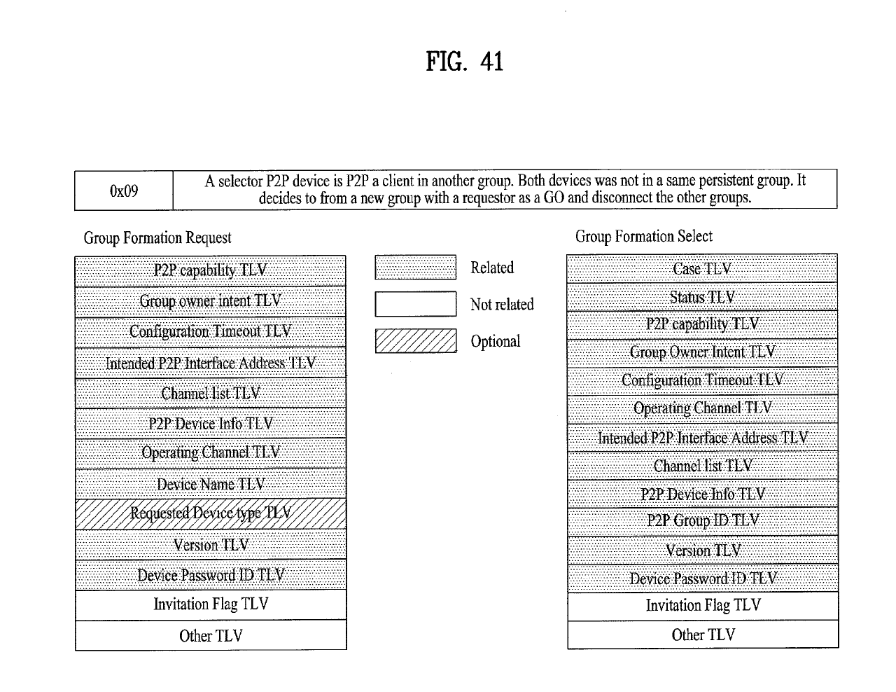

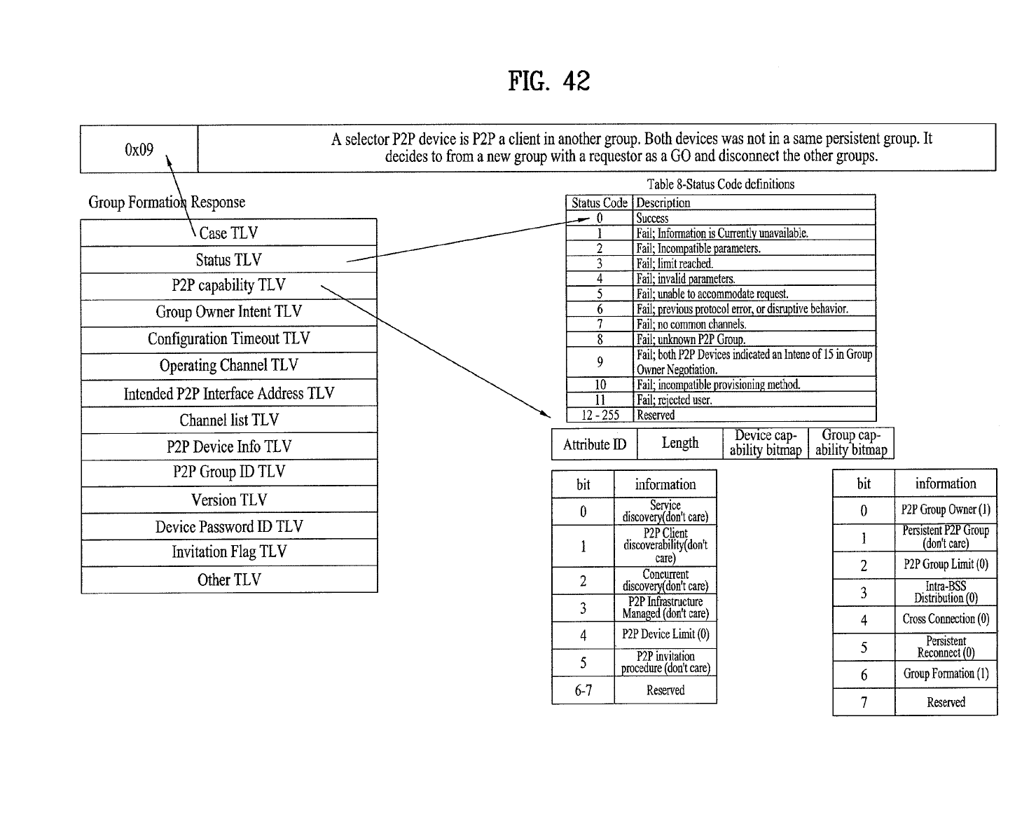

FIG. 41 and FIG. 42 are diagrams for one example of information included in a P2P Group Formation Request/Response message if a value of a P2P connection case field is set to 0x09 and one example of indicating whether the corresponding information is related to a case that the value of the P2P connection case field is set to 0x09. If the value of the P2P connection case field is set to 0x09, it indicates a case that a Selector P2P device is P2P a client in another group, that both devices are not in a same persistent group, and that the Selector P2P device decides to form a new group with a Requestor as a Group Owner and disconnects other groups.

In FIG. 41, whether each TLV contained in the P2P Group Formation Request/Select message is related to a case that a value of the P2P connection case field is 0x09, not related thereto, or optional is illustrated.

FIG. 42 is a diagram for one example of a TLV value of a P2P Group Formation Response message if a value of the P2P connection case field is set to 0x09. For instance, Case TLV may include a value corresponding to the above-mentioned 0x09. Status TLV is as a status information of a Group Formation response message and may include information corresponding to SUCCESS. And, the P2P Capability TLV may include an appropriate P2P Capability information in accordance with the value 0x09 of the P2P connection case field.

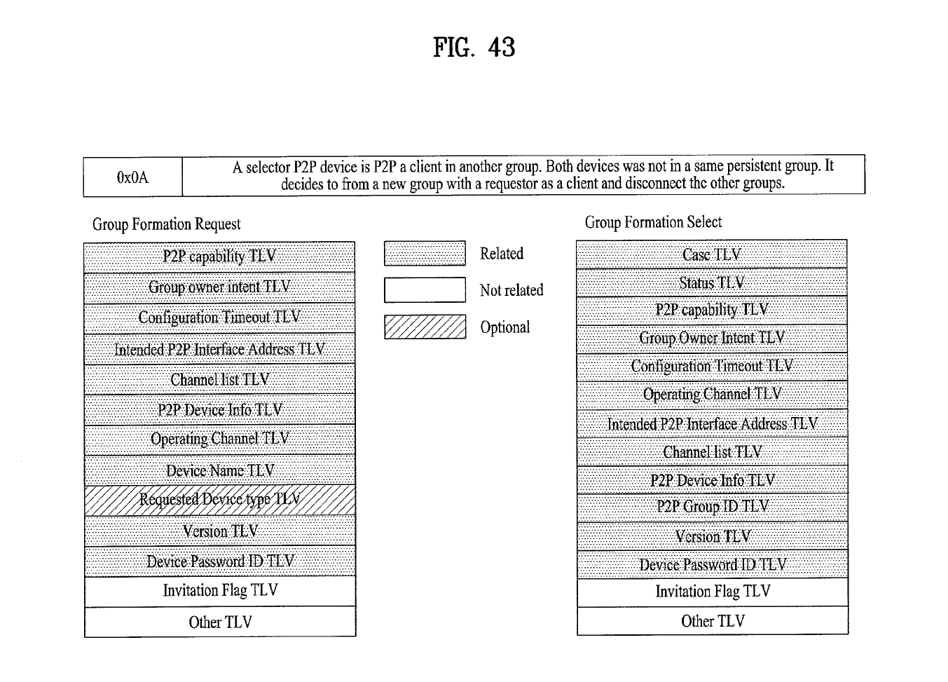

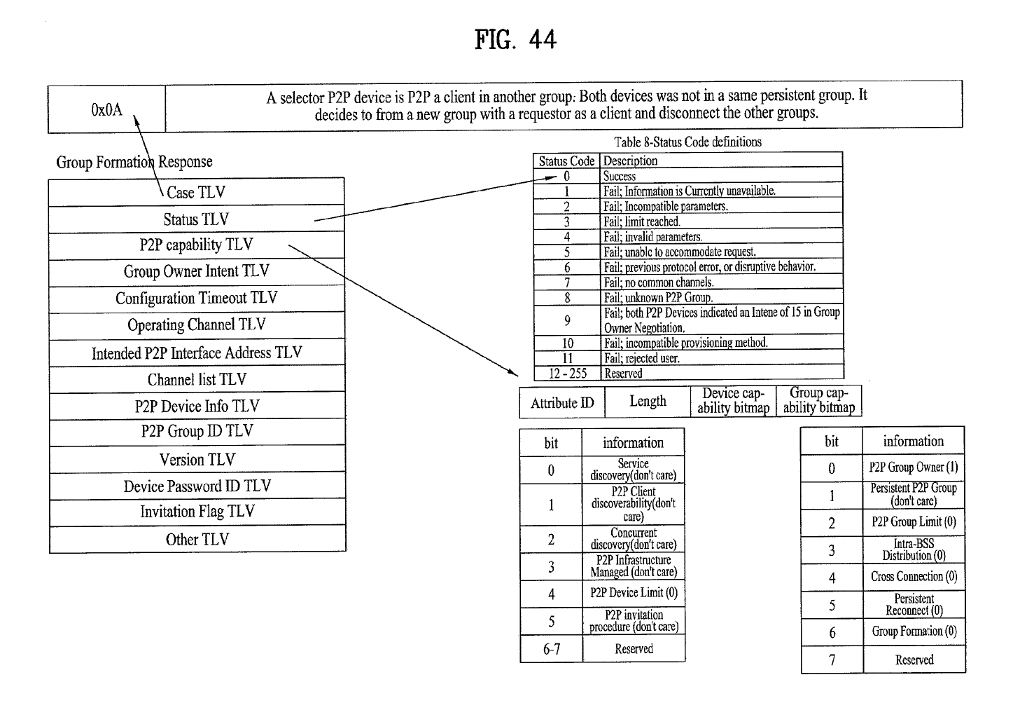

FIG. 43 and FIG. 44 are diagrams for one example of information included in a P2P Group Formation Request/Response message if a value of a P2P connection case field is set to 0x0A and one example of indicating whether the corresponding information is related to a case that the value of the P2P connection case field is set to 0x0A. If the value of the P2P connection case field is set to 0x0A, it indicates a case that a Selector P2P device is P2P a client in another group, that both devices are not in a same persistent group, and that the Selector P2P device decides to form a new group with a Requestor as a client and disconnects other groups.

Whether each TLV contained in the P2P Group Formation Request/Select message is related to a case that a value of the P2P connection case field is 0x0A, not related thereto, or optional is illustrated in this drawing.

FIG. 44 is a diagram for one example of a TLV value of a P2P Group Formation Response message if a value of the P2P connection case field is set to 0x0A. For instance, Case TLV may include a value corresponding to the above-mentioned 0x0A. Status TLV is as a status information of a Group Formation response message and may include a value indicating SUCCESS. And, P2P Capability TLV may include an appropriate P2P Capability information in accordance with the value 0x0A of the P2P connection case field.

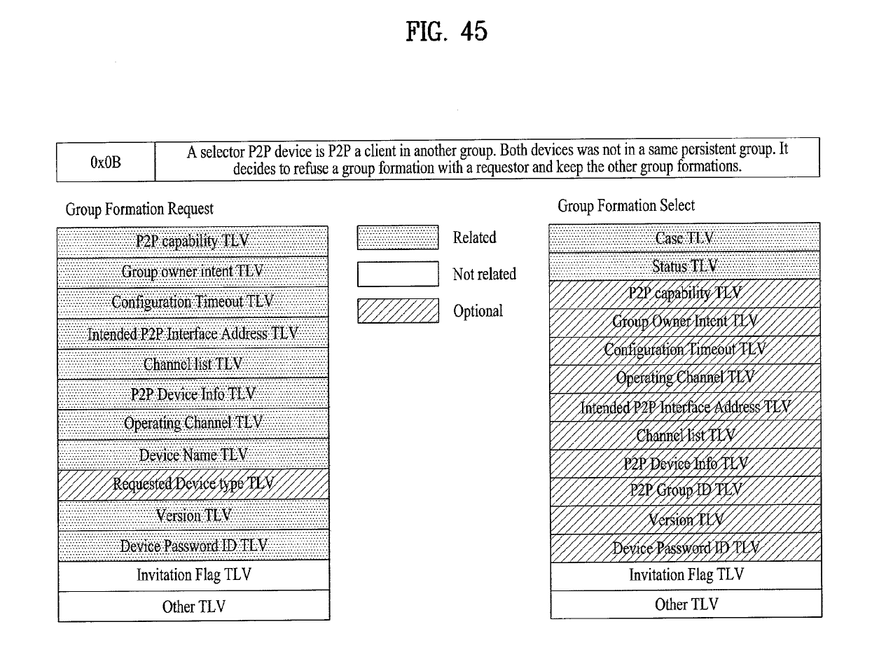

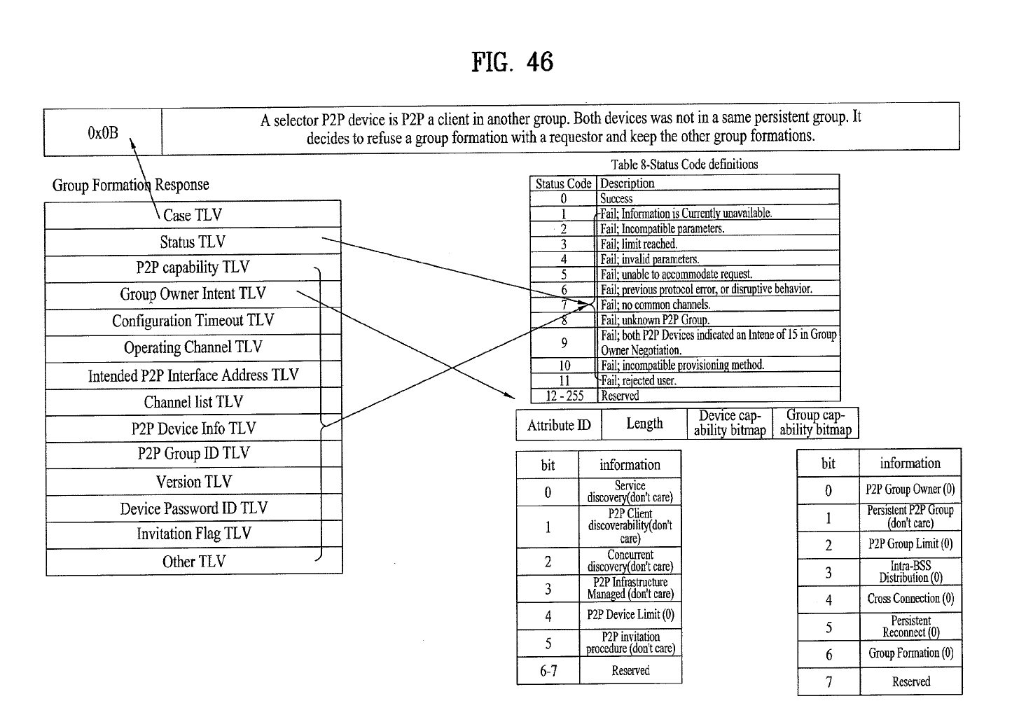

FIG. 45 and FIG. 46 are diagrams for one example of information included in a P2P Group Formation Request/Response message if a value of a P2P connection case field is set to 0x0B and one example of indicating whether the corresponding information is related to a case that the value of the P2P connection case field is set to 0x0B. If the value of the P2P connection case field is set to 0x0B, it indicates a case that a Selector P2P device is P2P a client in another group, that both devices are not in a same persistent group, and that the Selector P2P device decides to refuse a group formation with a Requestor and keeps other group formations.

In FIG. 45, whether each TLV contained in the P2P Group Formation Request/Select (Response) message is related to a value of the P2P connection case field, not related thereto, or optional is illustrated in this drawing.

For instance, in a P2P Group Formation Select (Response) message, Case TLV and Status TLV may include informations related to this case. And, P2P Capability TLV, Group Owner Intent TLV, Configuration Timeout TLV, Operating Channel TLV, Intended P2P Interface Address TLV, Channel List TLV, P2P Device Info TLV, P2P Group ID TLV, Version TLV and Device Password ID TLV may include related informations optionally.

FIG. 46 is a diagram for one example of TLV value of a P2P Group Formation Response message if a value of the P2P connection case field is set to 0x0B.

Case TLV may include a value corresponding to the above-mentioned 0x0B.

Status TLV may include a state information of a Group Formation response message. And, since a Selector P2P device refuses group formation with a requestor, P2P Capability TLV can include information on a specific status among FAIL statuses.

As mentioned in the foregoing description, P2P Capability information may include Attribute ID field, length field, Device Capability bitmap field, and Group Capability bitmap field and may have a prescribed one of the exemplary values in accordance with the above case.

And, each of the rest of Group Owner Intent TLV, Configuration Timeout TLV, Operating Channel TLV, Intended P2P Interface Address TLV, Channel List TLV, P2P Device Info TLV, P2P Group ID TLV, Version TLV, Device Password ID TLV, Invitation Flags TLV and the like may include information have the P2P connection case field value fit for 0x0B.

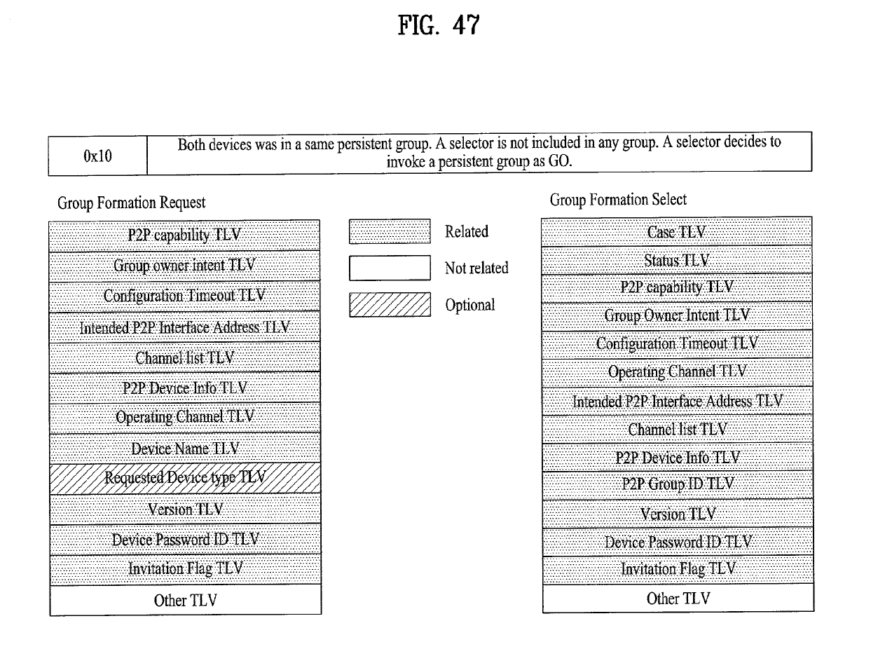

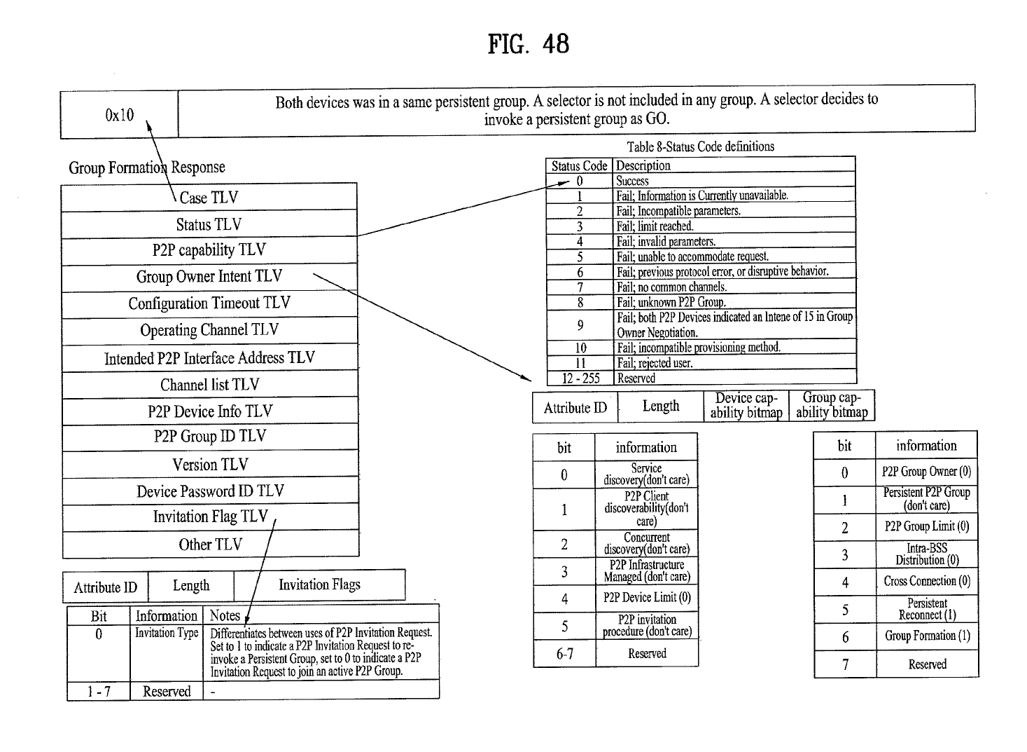

FIG. 47 and FIG. 48 are diagrams for one example of information included in a P2P Group Formation Request/Response message if a value of a P2P connection case field is set to 0x10 and one example of indicating whether the corresponding information is related to a case that the value of the P2P connection case field is set to 0x10. If the value of the P2P connection case field is set to 0x10, it indicates a case that both devices are in a same persistent group, that a Selector is not included in any group, and that the Selector decides to invoke a persistent group as a Group Owner.

In FIG. 47, whether each TLV contained in the P2P Group Formation Request/Response message is related to a case that a value of the P2P connection case field is 0x10, not related thereto, or optional is illustrated in this drawing.

FIG. 48 is a diagram for one example of TLV value of a P2P Group Formation Response message if a value of the P2P connection case field is set to 0x10.

Case TLV may include a value corresponding to the above-mentioned 0x10.

Status TLV may include a status information of a Group Formation response message. Since a selector decides to invoke a persistent group as a Group Owner, P2P Capability TLV may include information indicating a status of SUCCESS.

As mentioned in the above example, P2P Capability information may include Attribute ID field, length field, Device Capability bitmap field and Group Capability bitmap field. And, the P2P Capability information may have a prescribed one of values exemplarily provided if a value of the P2P connection case field is 0x10.

Meanwhile, Invitation Flags TLV may include an attribute ID field for identifying the corresponding information, a length field indicating a length of a following field, and an Invitation Type field. In this case, the Invitation Type field may include Invitation Type information fit for a case of 0x10. If a value of the P2P connection case field is set to 0x10, the Invitation Type information may indicate a difference of a use of a P2P Invitation Request. For instance, if a value of the Invitation Type information is set to 1, it may indicate that the P2P Invitation Request invokes a Persistent Group. If a value of the Invitation Type information is set to 0, it may indicate that the P2P Invitation Request joins an active P2P group.

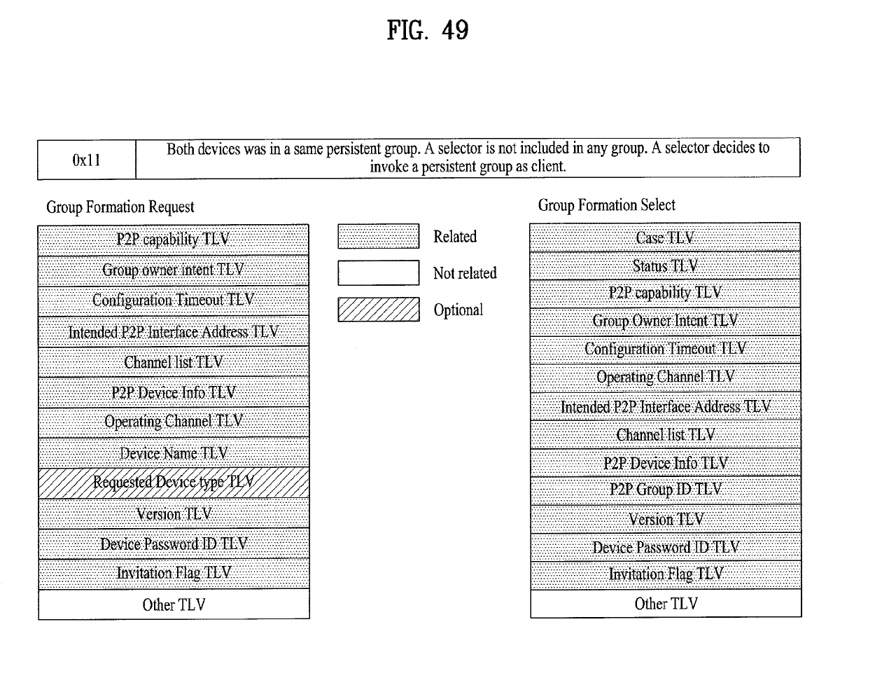

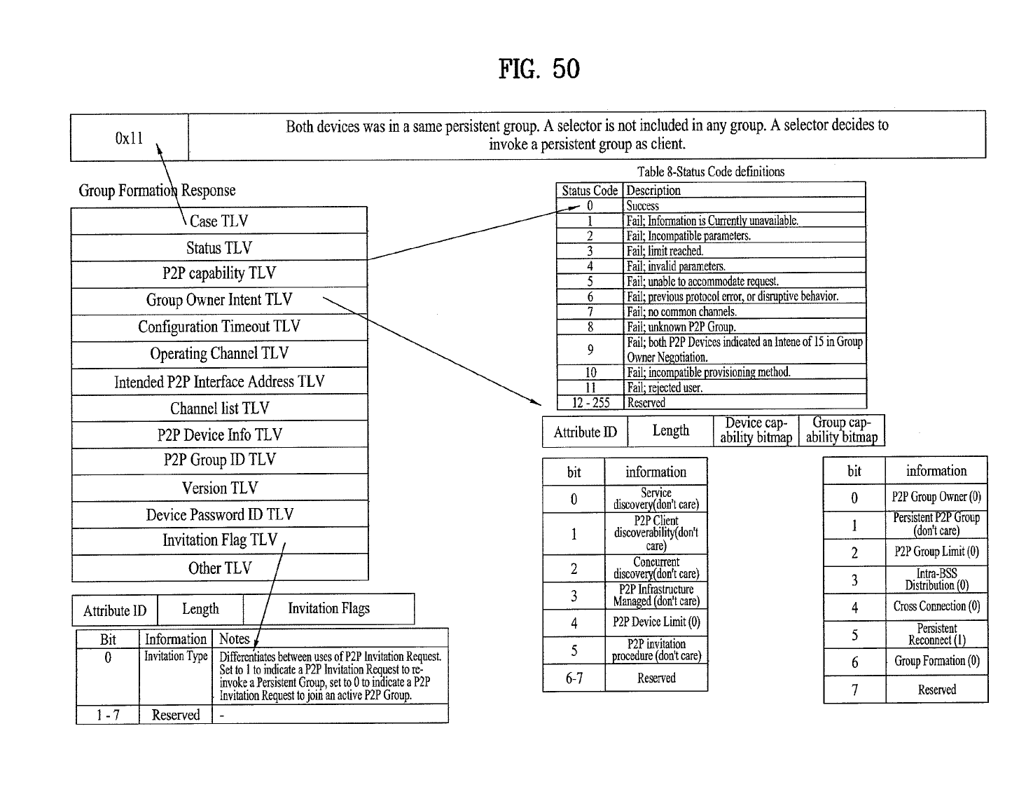

FIG. 49 and FIG. 50 are diagrams for one example of information included in a P2P Group Formation Request/Response message if a value of a P2P connection case field is set to 0x11 and one example of indicating whether the corresponding information is related to a case that the value of the P2P connection case field is set to 0x11. If the value of the P2P connection case field is set to 0x11, it indicates a case that both devices are in a same persistent group, that a Selector is not included in any group, and that the Selector decides to invoke a persistent group as a client.

In FIG. 49, whether each TLV contained in the P2P Group Formation Request/Response message is related to a case that a value of the P2P connection case field is 0x11, not related thereto, or optional is illustrated.

FIG. 50 is a diagram for one example of TLV value of a P2P Group Formation Response message if a value of the P2P connection case field is set to 0x11.

Case TLV may include a value corresponding to the above-mentioned 0x11.

Status TLV may include a status information of a Group Formation response message. Since a selector decides to invoke a persistent group as a client, the Status TLV may have information corresponding to SUCCESS.

And, P2P Capability information may have a prescribed one of values exemplarily provided in accordance with a value of the P2P connection case field.

Meanwhile, Invitation Flags TLV may include an attribute ID field for identifying the corresponding information, a length field indicating a length of a following field, and an Invitation Type field. In this case, the Invitation Type field may include Invitation Type information fit for a case of 0x11. If a value of the P2P connection case field is set to 0x11, the Invitation Type information may indicate a difference of a use of a P2P Invitation Request. For instance, if a value of the Invitation Type information is set to 1, it may indicate that the P2P Invitation Request invokes a Persistent Group. If a value of the Invitation Type information is set to 0, it may indicate that the P2P Invitation Request joins an active P2P group.

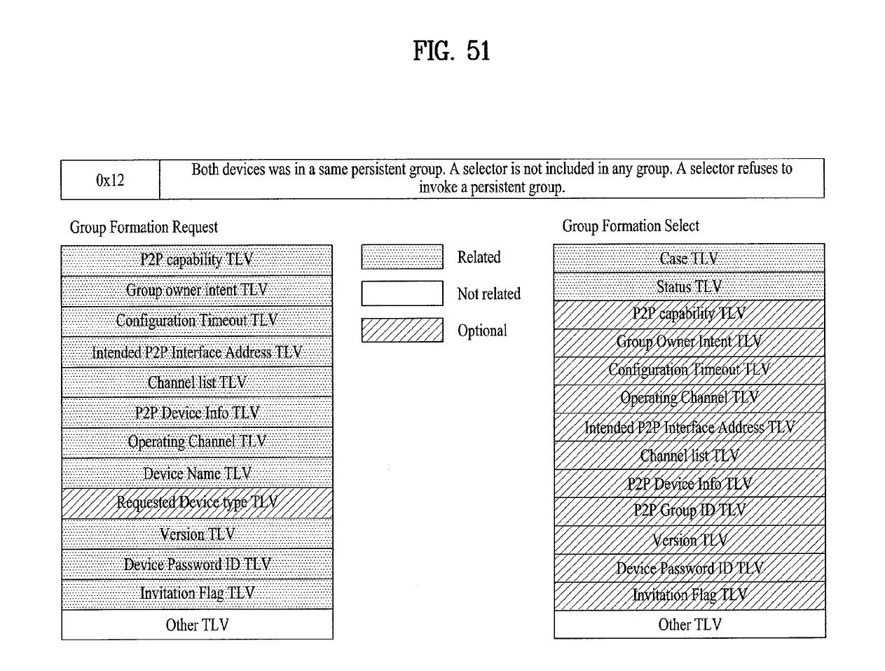

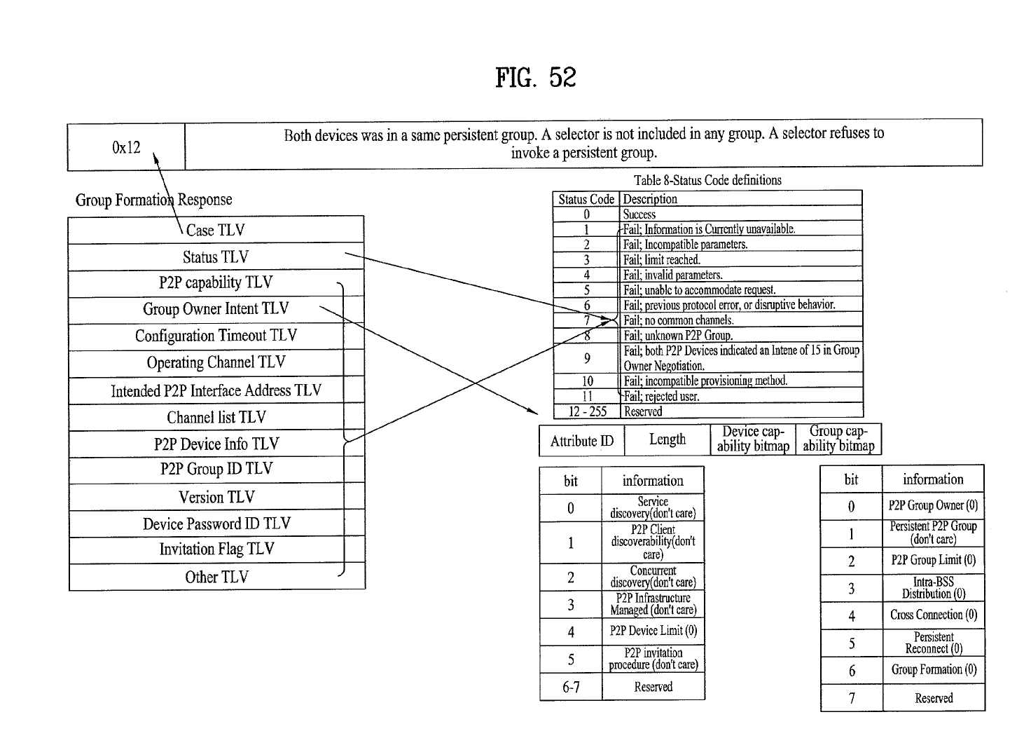

FIG. 51 and FIG. 52 are diagrams for one example of information included in a P2P Group Formation Request/Response message if a value of a P2P connection case field is set to 0x12 and one example of indicating whether the corresponding information is related to a case that the value of the P2P connection case field is set to 0x12. If the value of the P2P connection case field is set to 0x12, it indicates a case that both devices are in a same persistent group, that a Selector is not included in any group, and that the Selector refuses to invoke a persistent group.

In FIG. 51, whether each TLV contained in the P2P Group Formation Request/Response message is related to a case that a value of the P2P connection case field is 0x12, not related thereto, or optional is illustrated.

FIG. 52 is a diagram for one example of TLV value of a P2P Group Formation Response message if a value of the P2P connection case field is set to 0x12.

Case TLV may include a value corresponding to the above-mentioned 0x12.

Status TLV may include a status information of a Group Formation response message. Since a selector refuses to invoke a persistent group as a client, P2P Capability TLV may have information on a specific one of FAIL statuses.

And, the rest of the exemplarily provided TLV values from the P2P Capability TLV may include information in accordance with a value of the P2P connection case field.

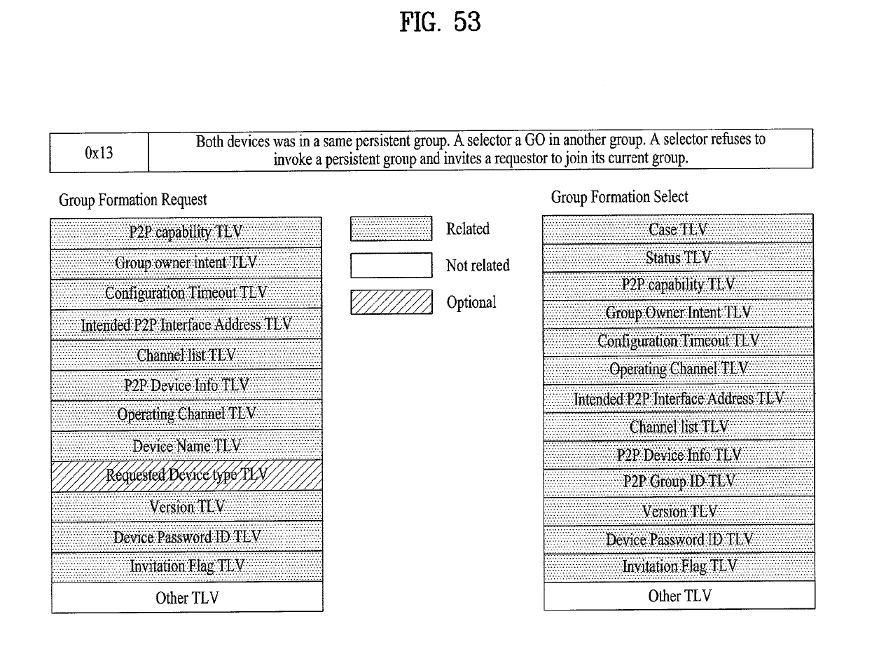

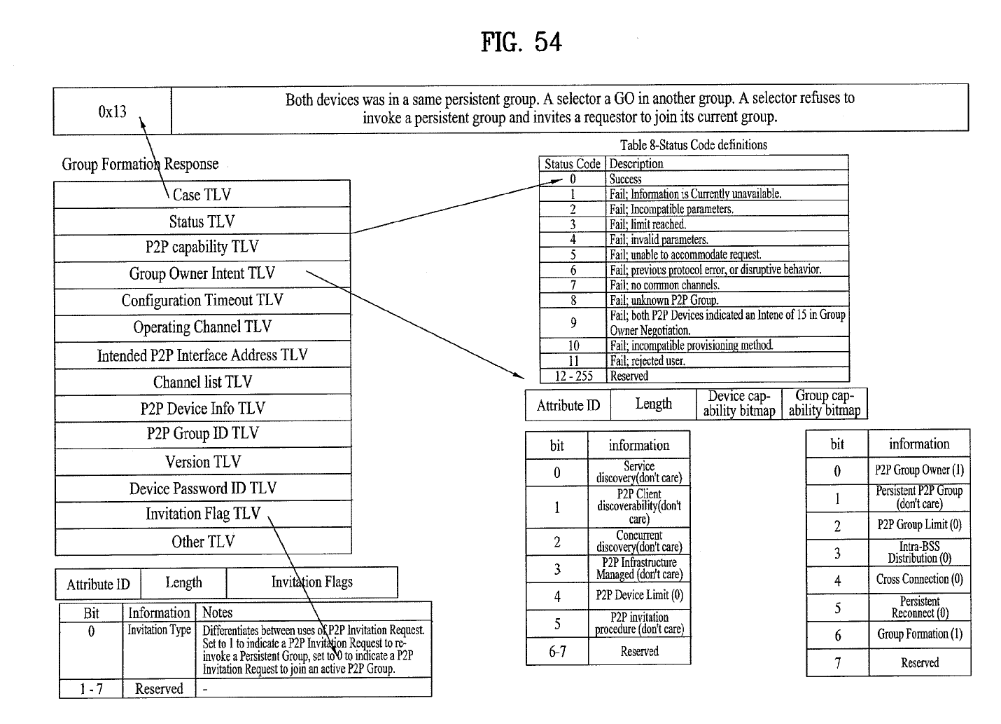

FIG. 53 and FIG. 54 are diagrams for one example of information included in a P2P Group Formation Request/Response message if a value of a P2P connection case field is set to 0x13 and one example of indicating whether the corresponding information is related to a case that the value of the P2P connection case field is set to 0x13. If the value of the P2P connection case field is set to 0x13, it indicates a case that both devices are in a same persistent group, that a Selector is a Group Owner in another group, and that the Selector refuses to invoke a persistent group and invites a Requestor to join its current group.

In FIG. 53, whether each TLV contained in the P2P Group Formation Request/Select (Response) message is related to a value of the P2P connection case field, not related thereto, or optional is illustrated.

FIG. 54 is a diagram for one example of TLV value of a P2P Group Formation Response message if a value of the P2P connection case field is set to 0x13.

Case TLV may include a value corresponding to the above-mentioned 0x13.

Status TLV may include a status information of a Group Formation response message. Since a selector refuses to invoke a persistent group as a client, the Status TLV may include information on a specific one of FAIL statuses.

As mentioned in the description of the above example, P2P Capability information may include an Attribute ID field, a length field, a Device Capability bitmap field and a Group Capability bitmap field and may have a prescribed one of values exemplarily provided in accordance with a case that a value of the P2P connection case field is 0x13.

Invitation Flags TLV may include an attribute ID field for identifying the corresponding information, a length field indicating a length of a following field, and an Invitation Type field. In this case, the Invitation Type field may include Invitation Type information fit for a case of 0x13. For instance, if a value of the Invitation Type information is set to 1, it may indicate that the P2P Invitation Request invokes a Persistent Group. If a value of the Invitation Type information is set to 0, it may indicate that the P2P Invitation Request joins an active P2P group.

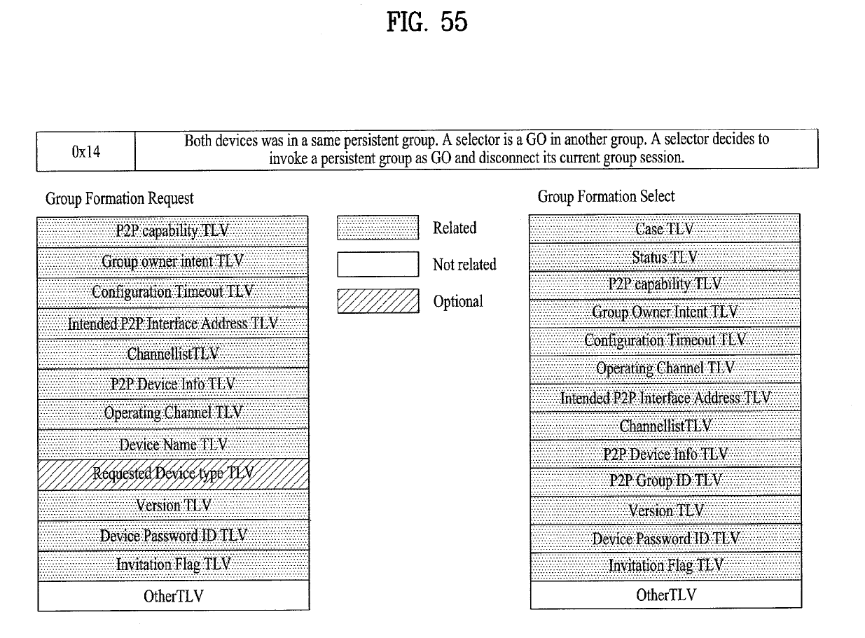

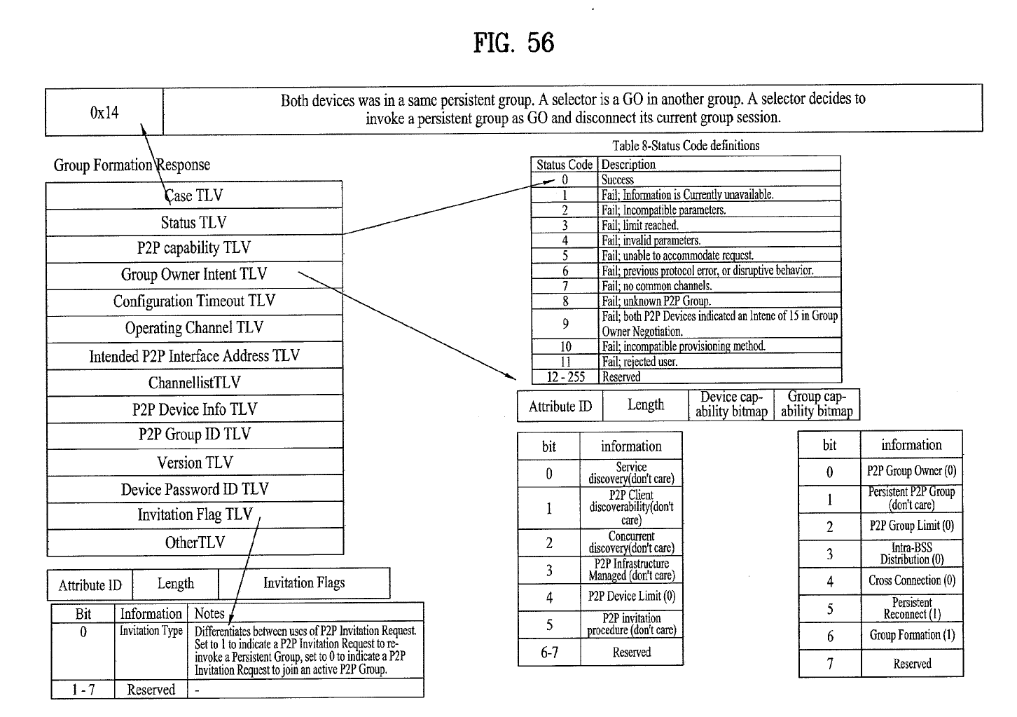

FIG. 55 and FIG. 56 are diagrams for one example of information included in a P2P Group Formation Request/Response message if a value of a P2P connection case field is set to 0x14 and one example of indicating whether the corresponding information is related to a case that the value of the P2P connection case field is set to 0x14. If the value of the P2P connection case field is set to 0x14, it indicates a case that both devices are in a same persistent group, that a Selector is a client in another group, and that the Selector refuses to invoke a persistent group and invites a Requestor to join its current group.

In FIG. 55, whether each TLV contained in the P2P Group Formation Request/Response message is related to a case that a value of the P2P connection case field is 0x14, not related thereto, or optional is illustrated.

FIG. 56 is a diagram for one example of TLV value of a P2P Group Formation Response message if a value of the P2P connection case field is set to 0x14.

Case TLV may include a value corresponding to the above-mentioned 0x14.

As shown in the example, Status TLV, P2P Capability TLV and Invitation Flags TLV can have values fit for a case that a value of the P2P connection case field is 0x14.

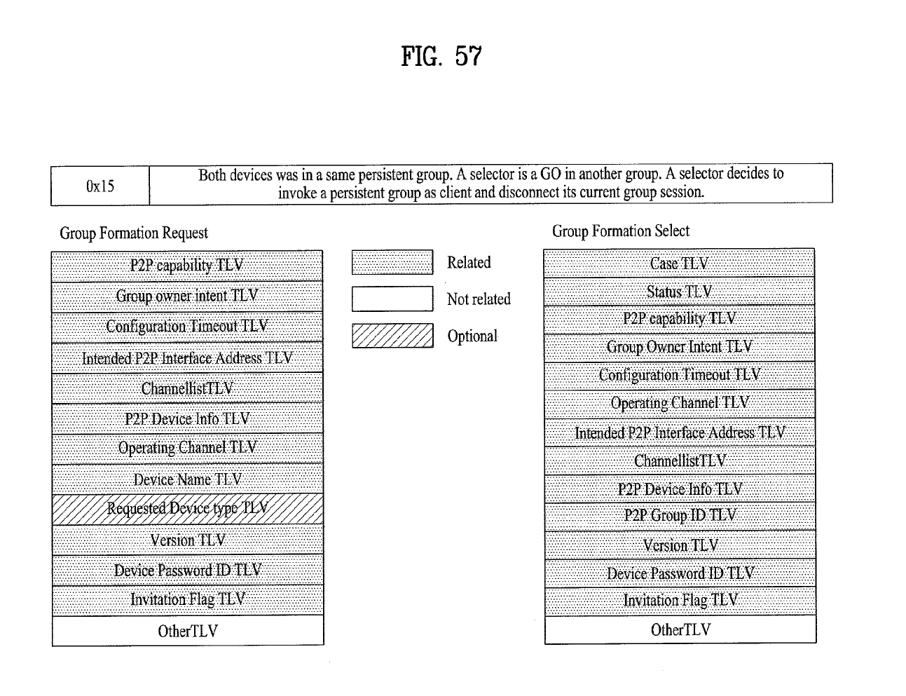

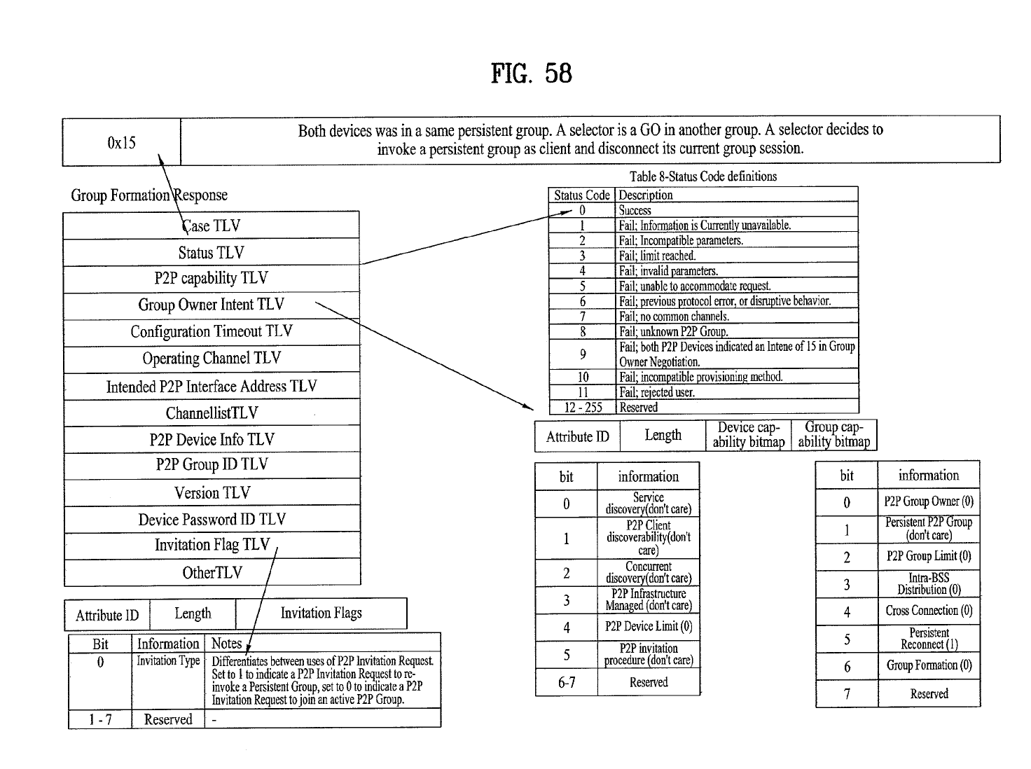

FIG. 57 and FIG. 58 are diagrams for one example of information included in a P2P Group Formation Request/Response message if a value of a P2P connection case field is set to 0x15 and one example of indicating whether the corresponding information is related to a case that the value of the P2P connection case field is set to 0x15. If the value of the P2P connection case field is set to 0x15, it indicates a case that both devices are in a same persistent group, that a Selector is a Group Owner in another group, and that the Selector decides to invoke a persistent group and disconnects its current group session.

In FIG. 57, whether each TLV contained in the P2P Group Formation Request/Response message is related to a case that a value of the P2P connection case field is 0x15, not related thereto, or optional is illustrated.

FIG. 58 is a diagram for one example of TLV value of a P2P Group Formation Response message if a value of the P2P connection case field is set to 0x15.

Case TLV may include a value corresponding to the above-mentioned 0x15. Similarly, as mentioned in the foregoing description, Status TLV, P2P Capability TLV and Invitation Flags TLV can have values fit for a case that a value of the P2P connection case field is 0x15.

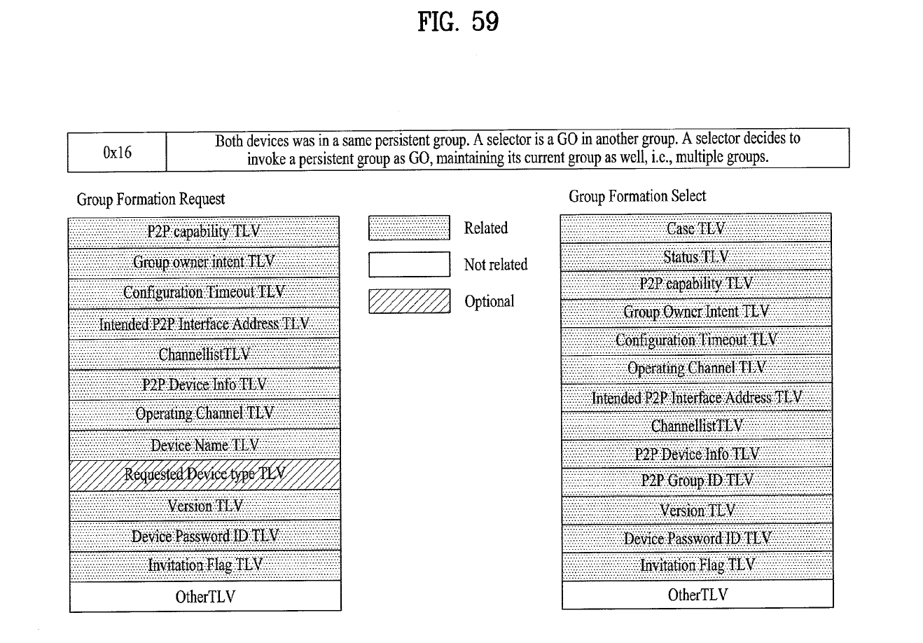

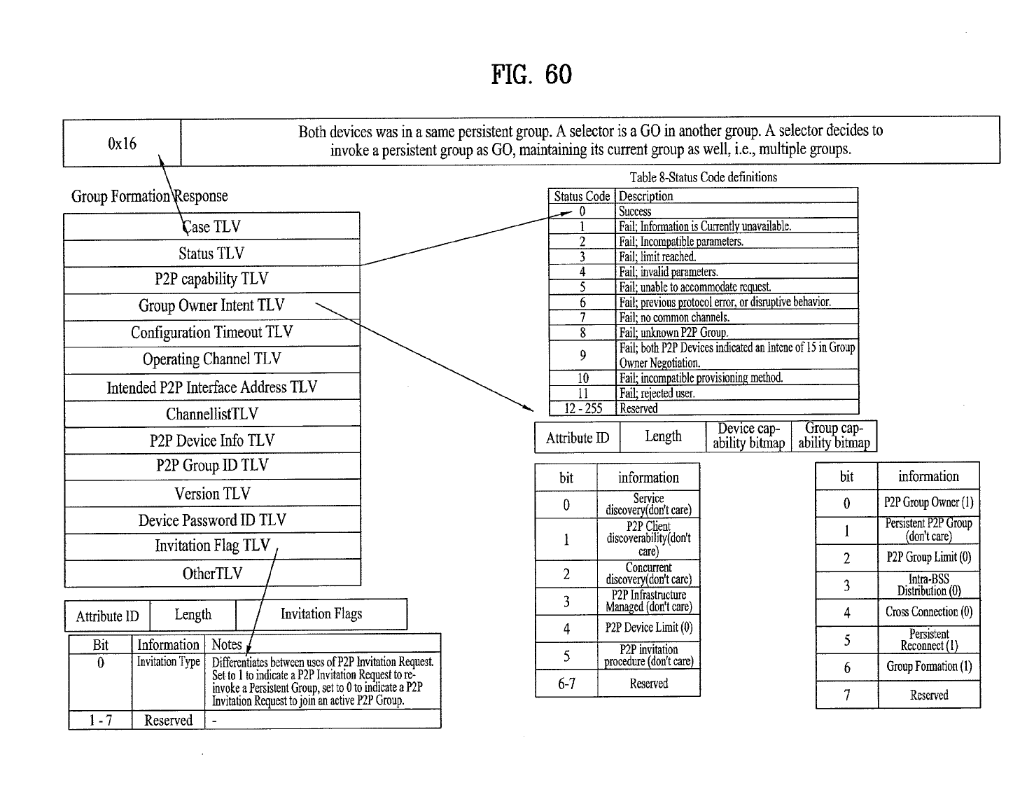

FIG. 59 and FIG. 60 are diagrams for one example of information included in a P2P Group Formation Request/Response message if a value of a P2P connection case field is set to 0x16 and one example of indicating whether the corresponding information is related to a case that the value of the P2P connection case field is set to 0x16. If the value of the P2P connection case field is set to 0x16, it indicates a case that both devices are in a same persistent group, that a Selector is a client in another group, and that the Selector decides to invoke a persistent group and disconnects its current group session.

In FIG. 59, whether each TLV contained in the P2P Group Formation Request/Response message is related to a case that a value of the P2P connection case field is 0x16, not related thereto, or optional is illustrated.

FIG. 60 is a diagram for one example of TLV value of a P2P Group Formation Response message if a value of the P2P connection case field is set to 0x16. Case TLV may include a value corresponding to the above-mentioned 0x16. Similarly, as mentioned in the foregoing description, Status TLV, P2P Capability TLV and Invitation Flags TLV can have values fit for a case that a value of the P2P connection case field is 0x16.

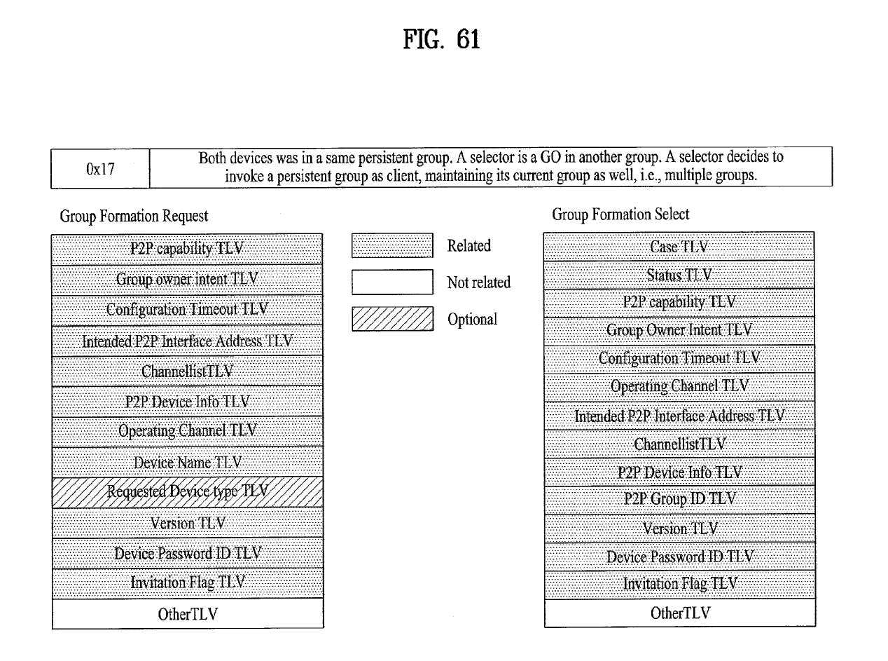

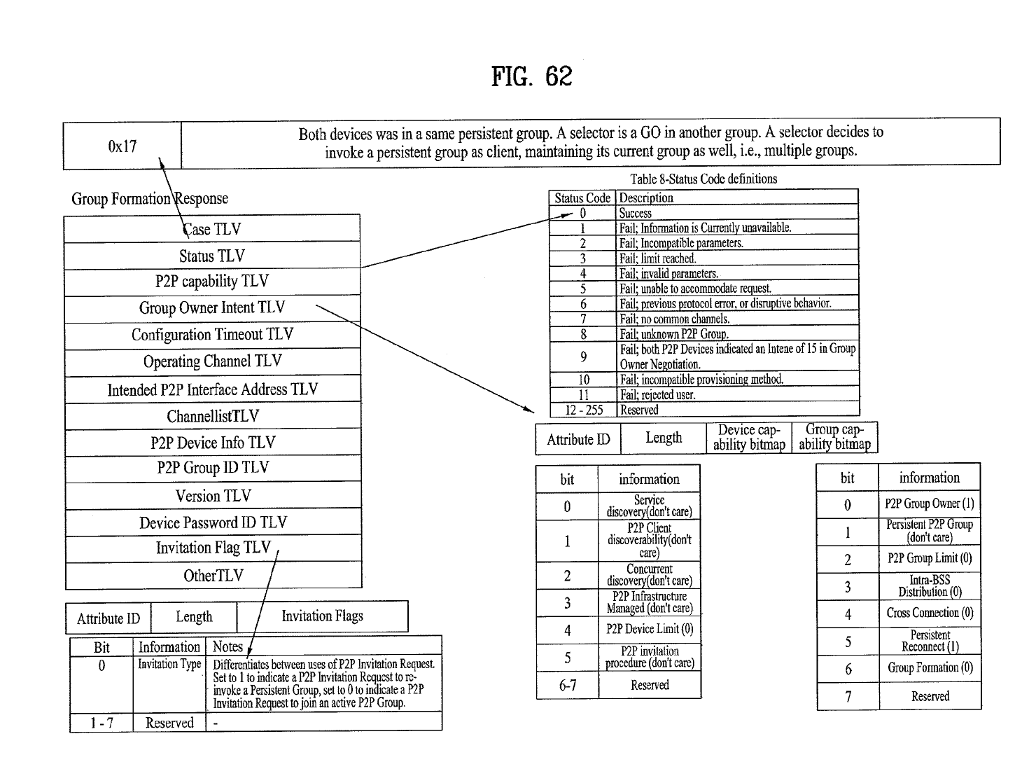

FIG. 61 and FIG. 62 are diagrams for one example of information included in a P2P Group Formation Request/Response message if a value of a P2P connection case field is set to 0x17 and one example of indicating whether the corresponding information is related to a case that the value of the P2P connection case field is set to 0x17. If the value of the P2P connection case field is set to 0x17, it indicates a case that both devices are in a same persistent group, that a Selector is a Group Owner in another group, and that the Selector decides to invoke a persistent group while maintaining its current group as well.

In FIG. 61, whether each TLV contained in the P2P Group Formation Request/Response message is related to a case that a value of the P2P connection case field is 0x17, not related thereto, or optional is illustrated.

FIG. 62 is a diagram for one example of TLV value of a P2P Group Formation Response message if a value of the P2P connection case field is set to 0x17.

For instance, Case TLV may include a value corresponding to the above-mentioned 0x17. Similarly, as mentioned in the foregoing description, Status TLV, P2P Capability TLV and Invitation Flags TLV can have values fit for a case that a value of the P2P connection case field is 0x17.

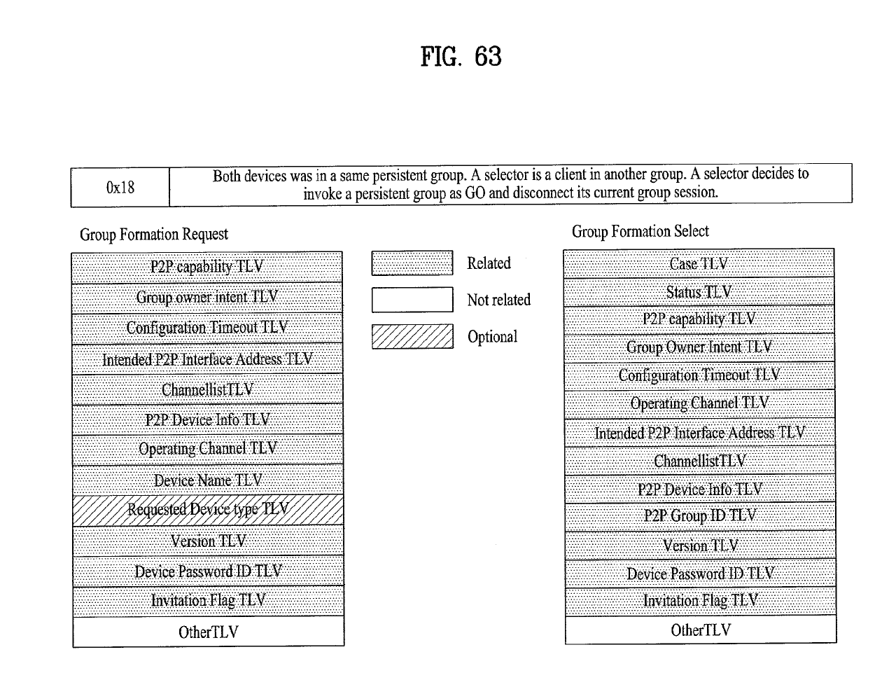

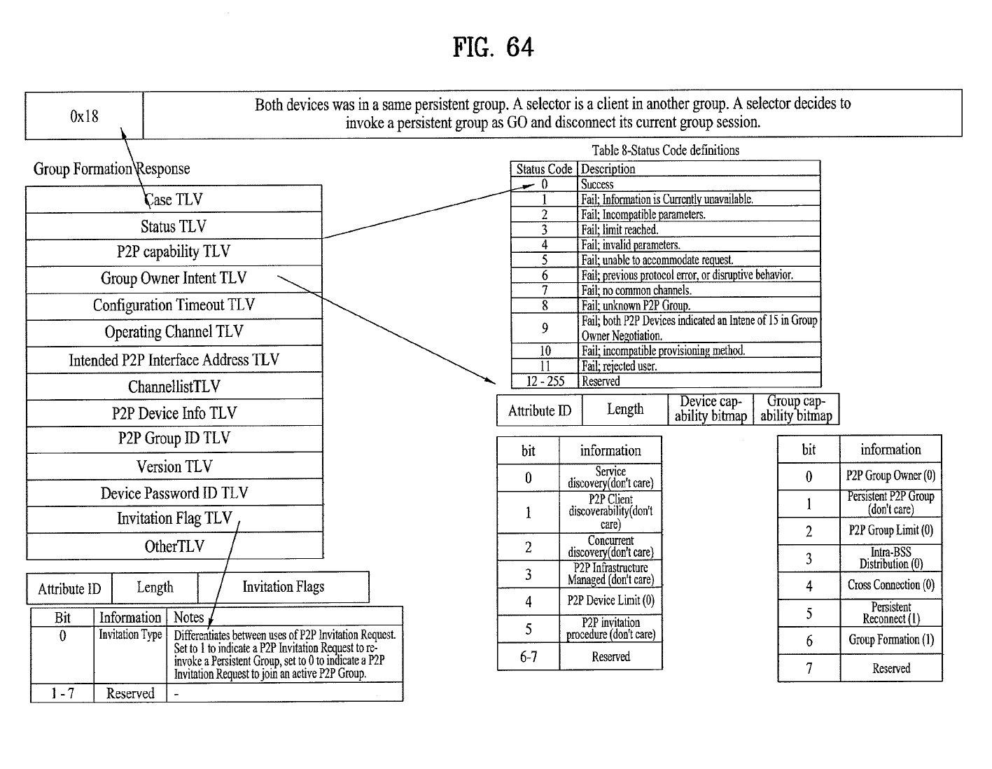

FIG. 63 and FIG. 64 are diagrams for one example of information included in a P2P Group Formation Request/Response message if a value of a P2P connection case field is set to 0x18 and one example of indicating whether the corresponding information is related to a case that the value of the P2P connection case field is set to 0x18. If the value of the P2P connection case field is set to 0x18, it indicates a case that both devices are in a same persistent group, that a Selector is a client in another group, and that the Selector decides to invoke a persistent group while maintaining its current group as well.

In FIG. 63, whether each TLV contained in the P2P Group Formation Request/Select (Response) message is related to a value of the P2P connection case field, not related thereto, or optional is illustrated.

FIG. 64 is a diagram for one example of TLV value of a P2P Group Formation Response message if a value of the P2P connection case field is set to 0x18.

For instance, Case TLV may include a value corresponding to the above-mentioned 0x18. Similarly, as mentioned in the foregoing description, Status TLV, P2P Capability TLV and Invitation Flags TLV can have values fit for a case that a value of the P2P connection case field is 0x18.

For instance, Invitation Flags TLV may include an attribute ID field for identifying the corresponding information, a length field indicating a length of a following field, and an Invitation Type field. In this case, the Invitation Type field may include Invitation Type information fit for a case that a value of the P2P connection field is 0x18. For instance, if a value of the Invitation Type field is set to 1, it may indicate that the P2P Invitation Request invokes a Persistent Group. If a value of the Invitation Type information is set to 0, it may indicate that the P2P Invitation Request joins an active P2P group.

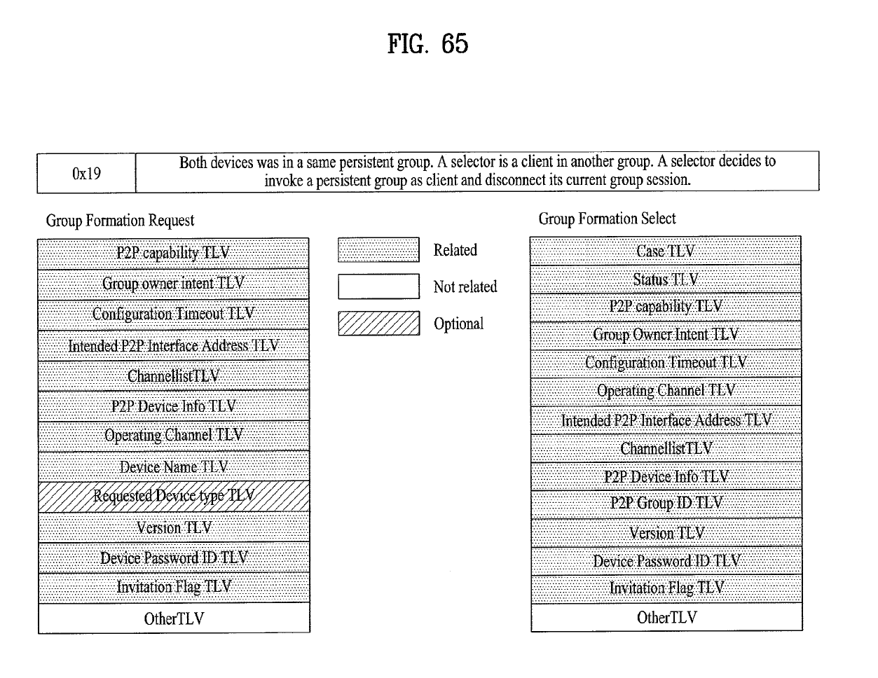

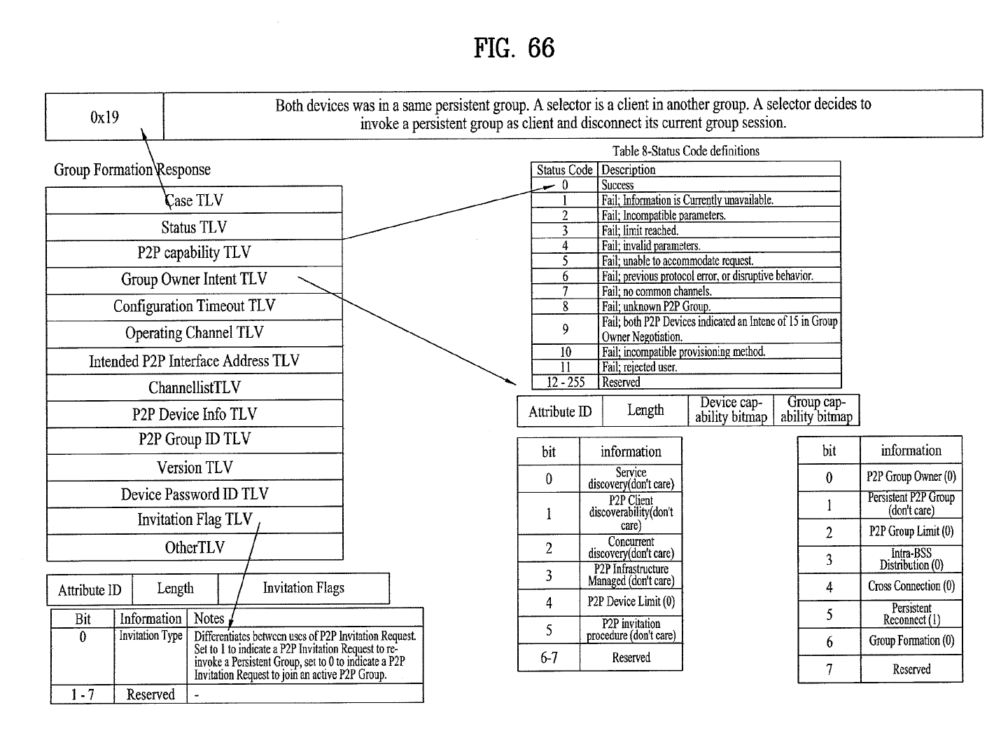

FIG. 65 and FIG. 66 are diagrams for one example of information included in a P2P Group Formation Request/Response message if a value of a P2P connection case field is set to 0x19 and one example of indicating whether the corresponding information is related to a case that the value of the P2P connection case field is set to 0x19. If the value of the P2P connection case field is set to 0x19, it indicates a case that both devices are in a same persistent group, that a Selector is a Group Owner in another group, and that the Selector decides to invoke a persistent group and disconnects its current group session.

In FIG. 65, whether each TLV contained in the P2P Group Formation Request/Select (Response) message is related to a value of the P2P connection case field, not related thereto, or optional is illustrated.

FIG. 66 is a diagram for one example of TLV value of a P2P Group Formation Response message if a value of the P2P connection case field is set to 0x19.

For instance, Case TLV may include a value corresponding to the above-mentioned 0x18. Similarly, as mentioned in the foregoing description, Status TLV, P2P Capability TLV and Invitation Flags TLV can have values fit for a case that a value of the P2P connection case field is 0x19.

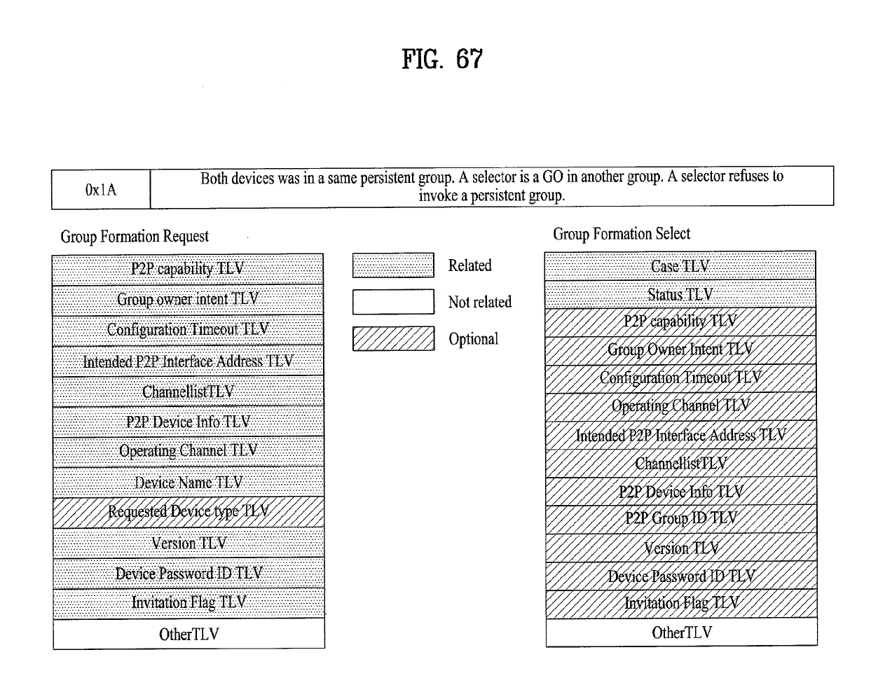

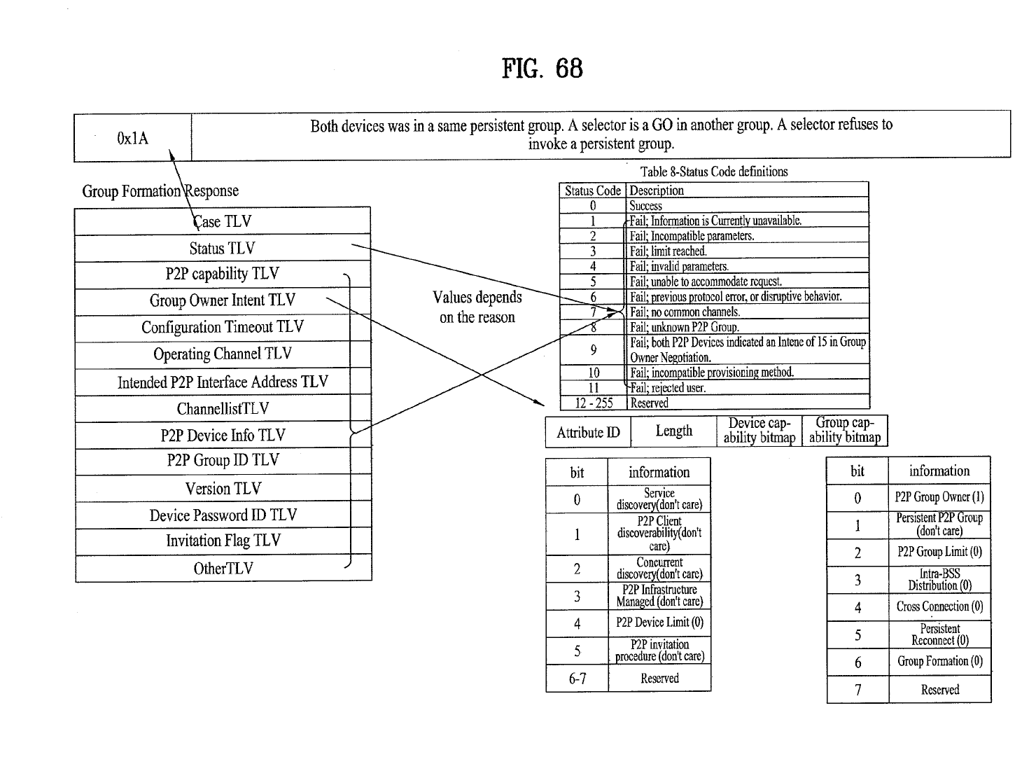

FIG. 67 and FIG. 68 are diagrams for one example of information included in a P2P Group Formation Request/Response message if a value of a P2P connection case field is set to 0x1A and one example of indicating whether the corresponding information is related to a case that the value of the P2P connection case field is set to 0x1A. If the value of the P2P connection case field is set to 0x1A, it indicates a case that both devices are in a same persistent group, that a Selector is a client in another group, and that the Selector decides to invoke a persistent group and disconnects its current group session.

In FIG. 67, whether each TLV contained in the P2P Group Formation Request/Response message is related to a case that a value of the P2P connection case field is set to 0x1A, not related thereto, or optional is illustrated.

FIG. 68 is a diagram for one example of TLV value of a P2P Group Formation Response message if a value of the P2P connection case field is set to 0x1A.

For instance, Case TLV may include a value corresponding to the above-mentioned 0x1A. Similarly, as mentioned in the foregoing description, Status TLV, P2P Capability TLV and Invitation Flags TLV can have values fit for a case that a value of the P2P connection case field is 0x1A.

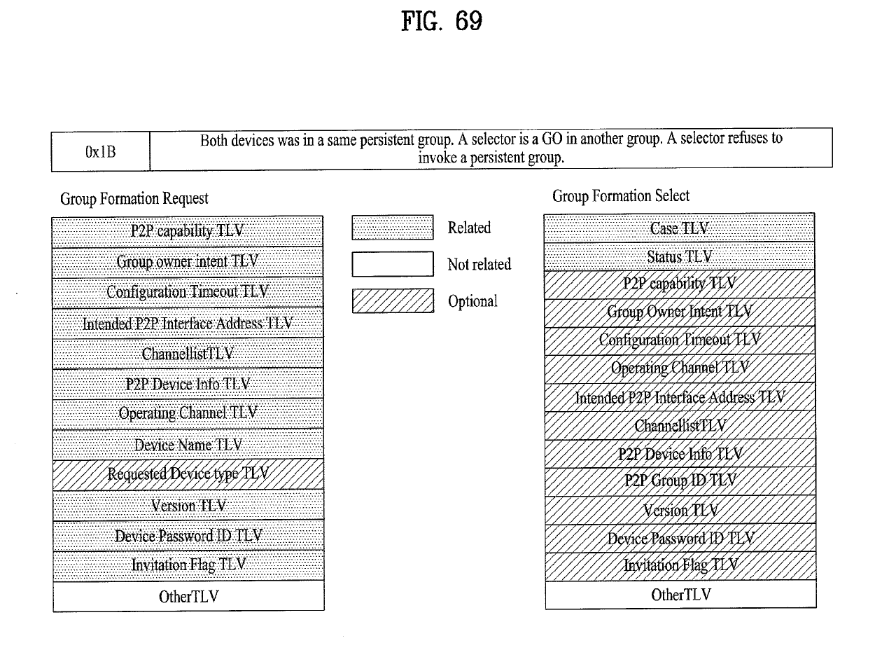

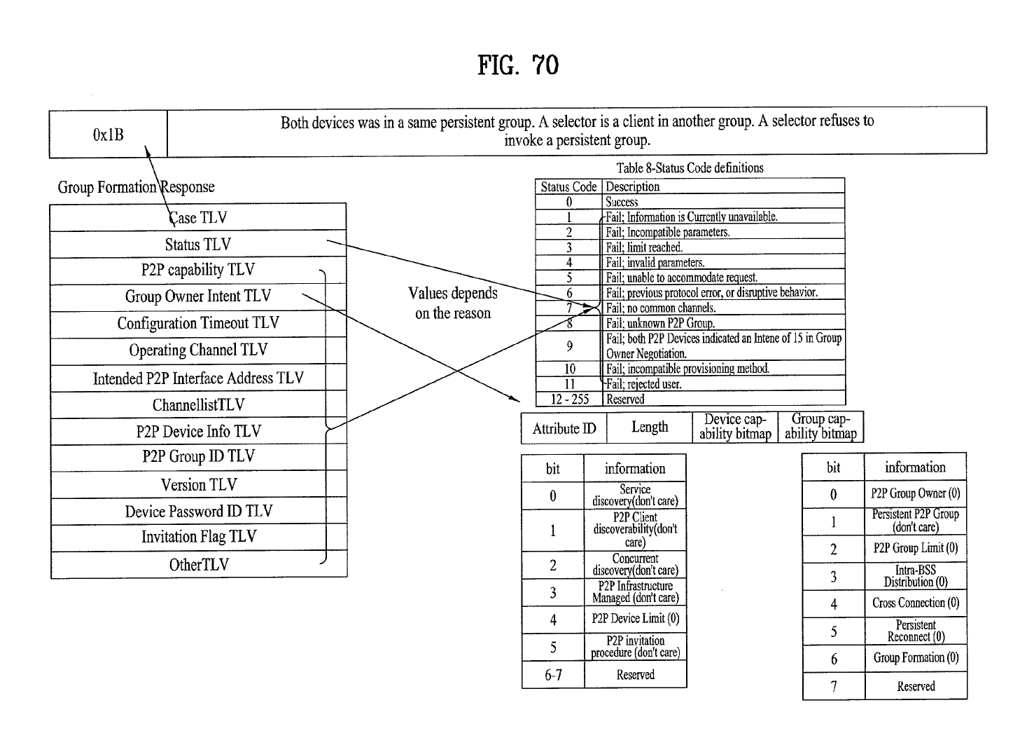

FIG. 69 and FIG. 70 are diagrams for one example of information included in a P2P Group Formation Request/Response message if a value of a P2P connection case field is set to 0x1B and one example of indicating whether the corresponding information is related to a case that the value of the P2P connection case field is set to 0x1B.

In FIG. 69, whether each TLV contained in the P2P Group Formation Request/Select (Response) message is related to a value of the P2P connection case field, not related thereto, or optional is illustrated.

FIG. 70 is a diagram for one example of TLV value of a P2P Group Formation Response message if a value of the P2P connection case field is set to 0x1B.

For instance, Case TLV may include a value corresponding to the above-mentioned 0x18. Similarly, as mentioned in the foregoing description, Status TLV, P2P Capability TLV and Invitation Flags TLV can have values fit for a case that a value of the P2P connection case field is 0x1B.

As mentioned in the foregoing description, illustrated are examples of P2P connection attributes contained in P2P Group Request/Response (Select) message changing in accordance with a value of a P2P connection case field in P2P Group Case Attribute contained in P2P Group Request/Response message. In this case, if an MSB value of the P2P connection case field corresponds to 0x00˜0x0B or 0x1A˜0x1B, it may indicate whether devices intending to form a P2P Group belong to the same Persistent Group.

As mentioned in the foregoing description, an embodiment of the present invention can use a handover of NFC for Wi-Fi P2P connection.

In accordance with NFC (near field communication) system, a 1^{st} wireless data communication device makes a request for a request message including information required for Wi-Fi peer-to-peer (wireless fidelity P2P) connection to a 2^{nd} wireless data communication device and is then able to receive a select message according to the NFC (near field communication) system from the 2^{nd} wireless data communication device in response to the request message.

The 1^{st} wireless data communication device is connected by Wi-Fi P2P to the 2^{nd} wireless data communication device by transceiving information for the Wi-Fi P2P connection with the 2^{nd} wireless data communication device in accordance with the Wi-Fi P2P connection attribute information.

On the other hand, In accordance with the NFC (near field communication) system, the 2^{nd} wireless data communication device receives the request message including the information required for the Wi-Fi peer-to-peer (wireless fidelity P2P) connection from the 1^{st} wireless data communication device and then sends the select message including the Wi-Fi P2P connection attribute information according to the NFC (near field communication) system to the 1^{st} wireless data communication device in response to the request message.

And, the 2^{nd} wireless data communication device can transceive the information for the Wi-Fi P2P connection with the 1^{st} wireless data communication device in accordance with the Wi-Fi P2P connection attribute information.

The embodiment for the 1^{st} and 2^{nd} wireless data communication devices may follow the example shown in FIG. 1 and may include an NFC communication module and a Wi-Fi communication module.

For the Wi-Fi P2P connection, the request message may include probe request information attributes and Invitation Request attributes and may further include Provisioning attributes optionally.

For the Wi-Fi P2P connection, the select message may include probe response information attributes and Invitation Request attributes and may further include Provisioning attributes optionally.

Each of the request message and the select message may include attribute values in accordance with the P2P connection case attribute and each case attribute for the P2P connection case.

The Wi-Fi P2P connection attribute information may include an identifier of each attribute and information for identifying the P2P connection case. The identifier of each attribute and an attribute value in accordance with each case attribute are shown in FIG. 21 and FIGS. 23 to 70 for example.

According to an embodiment of the present invention, Wi-Fi Direct connection setup can be performed over NFC in wireless data communication devices (e.g., a device capable of using Wi-Fi Direct (P2P) and NFC) capable of two communication connections.

In the foregoing description, P2P Group Request/Response (Select) Message on NFC link for Wi-Fi Direct connection setup using NFC is defined.

Therefore, according to an embodiment of the present invention, a connection setup of devices performing contents and screen sharing through Wi-Fi P2P connection is performed by NFC system. Accordingly, the present invention shortens a time taken for the connection setup and enables device communications efficiently.

What is claimed is:

1. A method for wireless data communication, comprising the steps of:
receiving metadata on a 1^{st} content from a wireless data communication device using NFC (near field communication) system;
displaying the received metadata; and
when information included in the metadata is selected, connecting the wireless data communication device using Wi-Fi peer-to-peer (wireless fidelity P2P) connection system and receiving a content or the 1^{st} content in accordance with the selected information from the wireless data communication device.

2. The method of claim 1, wherein the metadata includes information on a presence or non-presence of a screen mirroring of the content.

3. An apparatus for wireless data communication, comprising:
a 1^{st} communication module receiving metadata on a 1^{st} content from a wireless data communication device using NFC (near field communication) system;
a display unit displaying the received metadata; and
a 2^{nd} communication module, when information included in the metadata is selected, connecting the wireless data communication device using Wi-Fi peer-to-peer (wireless fidelity P2P) connection system, the 2^{nd} communication module receiving a content or the 1^{st} content in accordance with the selected information from the wireless data communication device.

4. The apparatus of claim 3, wherein the metadata includes at least one selected from the group consisting of a title of the content, casting information of the content, and a broadcast time of the content.

5. A method for wireless data communication, comprising the steps of:
receiving a request for metadata on a 1^{st} content from a wireless data communication device using NFC (near field communication) system;
transmitting the metadata using the NFC (near field communication) system; and
transmitting the 1^{st} content or a 2^{nd} content related to the metadata to the wireless data communication device using Wi-Fi peer-to-peer (wireless fidelity P2P) connection system.

6. The apparatus of claim 5, wherein the metadata includes at least one selected from the group consisting of a title of the content, casting information of the content, and a broadcast time of the content.

7. An apparatus for wireless data communication, comprising:
a 1^{st} communication module receiving a request for metadata on a 1^{st} content from a wireless data communication device using NFC (near field communication) system, the 1^{st} communication module transmitting the metadata using the NFC (near field communication) system; and
a 2^{nd} communication module transmitting the 1^{st} content or a 2^{nd} content related to the metadata to the wireless data communication device using Wi-Fi peer-to-peer (wireless fidelity P2P) connection system.

8. The apparatus of claim 7, wherein the metadata includes at least one selected from the group consisting of a title of the content, casting information of the content, and a broadcast time of the content.

9. An apparatus for wireless data communication, comprising:
a 1^{st} communication module requesting a request message including information required for Wi-Fi peer-to-peer (wireless fidelity P2P) connection from a 1^{st} wireless data communication device in accordance with NFC (near field communication) system, the 1^{st} communication module receiving a select message according to the NFC (near field communication) system from the 1^{st} wireless data communication device in response to the request message; and
a 2^{nd} communication module transceiving the information for the Wi-Fi P2P connection with the 1^{st} wireless data communication device in accordance with Wi-Fi P2P connection attribute information included in the select message.

10. The apparatus of claim 9, wherein the Wi-Fi P2P connection attribute information includes an identifier of the attribute and a connection case attribute information for the Wi-Fi P2P connection.

11. A method for wireless data communication, comprising the steps of:
requesting a request message including information required for Wi-Fi peer-to-peer (wireless fidelity P2P) connection from a 1^{st} wireless data communication device in accordance with NFC (near field communication) system;
receiving a select message according to the NFC (near field communication) system from the 1^{st} wireless data communication device in response to the request message; and
transceiving information for the Wi-Fi P2P connection with the 1^{st} wireless data communication device in accordance with the Wi-Fi P2P connection attribute information included in the select message.

12. The method of claim 11, wherein the Wi-Fi P2P connection attribute information includes an identifier of the attribute and a connection case attribute information for the Wi-Fi P2P connection.

13. A method for wireless data communication, comprising the steps of:
receiving request message including information for Wi-Fi peer-to-peer (wireless fidelity P2P) connection from a 1^{st} wireless data communication device in accordance with NFC (near field communication) system;
sending a select message including Wi-Fi P2P connection attribute information according to the NFC (near field communication) system to the 1^{st} wireless data communication device in response to the request message; and
transceiving the information for the Wi-Fi P2P connection with the 1^{st} wireless data communication device in accordance with the Wi-Fi P2P connection attribute information.

14. The method of claim 13, wherein the Wi-Fi P2P connection attribute information includes an identifier of the attribute and a connection case attribute information for the Wi-Fi P2P connection.

15. An apparatus for wireless data communication, comprising:
a 1^{st} communication module receiving request message including information for Wi-Fi peer-to-peer (wireless fidelity P2P) connection from a 1^{st} wireless data communication device in accordance with NFC (near field communication) system, the 1^{st} communication module sending a select message including Wi-Fi P2P connection attribute information according to the NFC (near field communication) system to the 1^{st} wireless data communication device in response to the request message; and
a 2^{nd} communication module transceiving the information for the Wi-Fi P2P connection with the 1^{st} wireless data communication device in accordance with the Wi-Fi P2P connection attribute information.

16. The apparatus of claim 15, wherein the Wi-Fi P2P connection attribute information includes an identifier of the attribute and a connection case attribute information for the Wi-Fi P2P connection.
